(19) United States
(12) Patent Application Publication
(10) Pub. No.: US 2013/0093392 A1
(43) Pub. Date: Apr. 18, 2013

(54) NON-AQUEOUS ELECTROLYTE BATTERY, NON-AQUEOUS ELECTROLYTE, BATTERY PACK, ELECTRONIC APPARATUS, ELECTRIC VEHICLE, ELECTRICAL STORAGE APPARATUS, AND ELECTRICITY SYSTEM

(71) Applicant: Sony Corporation, Tokyo (JP)

(72) Inventors: Toru Odani, Fukushima (JP); Tadahiko Kubota, Kanagawa (JP)

(73) Assignee: SONY CORPORATION, Tokyo (JP)

(21) Appl. No.: 13/651,945

(22) Filed: Oct. 15, 2012

(30) Foreign Application Priority Data
Oct. 18, 2011 (JP) 2011-229204

(51) Int. Cl. H02J 7/00; H01M 2/02; B60L 1/00; H01M 10/056

(52) U.S. Cl. 320/109; 429/188; 429/206; 429/200; 429/163; 429/199; 307/10.1; 320/128

(57) ABSTRACT

A non-aqueous electrolyte battery includes: a cathode, an anode, and a non-aqueous electrolyte having a non-aqueous electrolyte solution. The non-aqueous electrolyte solution includes at least one kind of 1,3-dioxane derivative having a substituent group containing nitrogen or oxygen.

### CROSS REFERENCES TO RELATED APPLICATIONS

The present application claims priority to Japanese Priority Patent Application JP 2011-229204 filed in the Japan Patent Office on Oct. 18, 2011, the entire content of which is hereby incorporated by reference.

### BACKGROUND

The present application relates to a non-aqueous electrolyte battery, a non-aqueous electrolyte, a battery pack, an electronic apparatus, an electric vehicle, an electrical storage apparatus, and an electricity system. More particularly, the present disclosure relates to a non-aqueous electrolyte battery using non-aqueous electrolyte including non-aqueous solvent and electrolytic salt, and a battery pack that includes the non-aqueous electrolyte battery, an electronic apparatus, an electric vehicle, an electrical storage apparatus, and an electricity system.

In recent years, portable electronic apparatuses such as camera integrated VTRs (Video Tape Recorders), cellular phones, and laptop PCs (Personal Computers) have been popularized, and there is a strong demand for such apparatus to be smaller, lighter, and longer-lasting. Accordingly, as portable power sources for the electronic apparatus, development of batteries, specifically lightweight secondary batteries which are capable of producing high energy density, is being promoted. Among them, non-aqueous electrolyte batteries, such as lithium-ion secondary batteries, using electrolyte including non-aqueous solvent and electrolytic salt, have been widely commercialized because of their capability of producing high energy density.

As non-aqueous electrolyte batteries such as lithium-ion secondary batteries are frequently charged and discharged such that the decomposition of the electrolyte solution may occur and thereby tend to bring about the generation of gas continuously. Accordingly, with repeating charge and discharge, the discharge capacities of those batteries may decline and the swelling of battery may easily occur in such situations. In addition to this, in a case of non-aqueous electrolyte batteries, when under the high temperature atmosphere, the decomposition of the electrolyte solution and the gas generation could easily occur. For this matter, for example, Japanese Patent Application Laid-open No. 2006-12780 discloses that a non-aqueous electrolyte battery, including a cyclic ether compound having a spiro-structure being added to the electrolyte solution, is capable of inhibiting the gas generation and the decrease in discharge capacity during the continuous charging, the deterioration of cycle characteristics and the deterioration of high temperature storage characteristics.

### SUMMARY

As mentioned above, there is a need for non-aqueous electrolyte batteries to inhibit the gas generation in the case of storage at high temperatures.

In view of the above-mentioned circumstances, it is desirable to provide a non-aqueous electrolyte battery capable of inhibiting the gas generation in the case of storage at high temperatures, a non-aqueous electrolyte, a battery pack, an electronic apparatus, an electric vehicle, an electrical storage apparatus, and an electricity system.

According to an aspect of the present application, there is provided a non-aqueous electrolyte battery including a cathode, an anode, and a non-aqueous electrolyte having a non-aqueous electrolyte solution. The non-aqueous electrolyte solution includes at least one kind of 1,3-dioxane derivative represented by at least one of the following formulae (1) and (2).

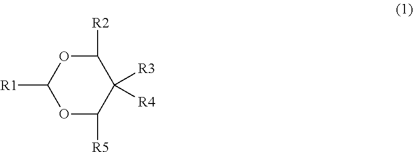

(In this formula (1), each of R1 to R5 independently represents a hydrogen group, a hydrocarbon group optionally having a substituent (excluding substituents containing nitrogen or oxygen), or a substituent group containing nitrogen or oxygen. Two or more groups selected from R1 to R5 may be bonded together. At least one of R1 to R5 represents a substituent group containing nitrogen or oxygen.)

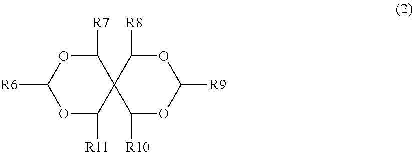

(In this formula (2), each of R6 to R11 independently represents a hydrogen group, a hydrocarbon group optionally having a substituent (excluding substituents containing nitrogen or oxygen), or a substituent group containing nitrogen or oxygen. At least one of R6 to R11 represents a substituent group containing nitrogen or oxygen.)

According to another aspect of the present application, there is provided a non-aqueous electrolyte including a non-aqueous electrolyte solution which includes at least one kind of 1,3-dioxane derivative represented by at least one of the above-mentioned formulae (1) and (2).

According to still another aspect of the present application, there is provided a battery pack, an electronic apparatus, an electric vehicle, an electrical storage apparatus, and an electricity system, being provided with the non-aqueous electrolyte battery as described above.

According to the present application, a coating, derived from at least one kind of the 1,3-dioxane derivative represented by the above-mentioned formula (1) or (2), forms on the electrodes (the cathode and the anode), whereby it becomes possible to inhibit the decomposition of the electrolyte solution and other effects resulting from high temperature storage. Therefore, it becomes possible to inhibit the gas generation brought about by the decomposition of the electrolyte solution and other effects resulting from high temperature storage.

According to the present application, it becomes possible to inhibit the gas generation resulting from high temperature storage.

Additional features and advantages are described herein, and will be apparent from the following Detailed Description and the figures.

### BRIEF DESCRIPTION OF THE FIGURES

FIG. 1 is a cross-sectional view showing a configuration example of a non-aqueous electrolyte battery according to an embodiment of the present application;

FIG. 2 is an enlarged cross-sectional view showing a part of the spirally wound electrode body shown in FIG. 1;

FIG. 3 is an exploded perspective view showing a configuration example of a non-aqueous electrolyte battery according to an embodiment of the present application;

FIG. 4 is a cross-sectional view showing the spirally wound electrode body shown in FIG. 3;

FIG. 5A is a perspective view showing external appearance of a non-aqueous electrolyte battery of an embodiment of the present application;

FIG. 5B is an exploded perspective view showing the configuration of the non-aqueous electrolyte battery;

FIG. 5C is a perspective view showing the configuration of the bottom side of the non-aqueous electrolyte battery shown in FIG. 5A;

FIG. 6A is a perspective view showing a configuration example of a cathode;

FIG. 6B is a perspective view showing a configuration example of a cathode;

FIG. 6C is a perspective view showing a configuration example of an anode;

FIG. 6D is a perspective view showing a configuration example of an anode;

FIG. 7A is a perspective view showing a configuration example of a laminated electrode body of an embodiment of the present application;

FIG. 7B is a cross-sectional view showing a configuration example of a laminated electrode body (a battery device) of an embodiment of the present application;

FIG. 8 is a cross-sectional view of the non-aqueous electrolyte battery of FIG. 5A, taken along line a-a′;

FIGS. 9A to 9E are processing diagrams showing a U-shape bending process of electrode tabs in the laminated electrode body of an embodiment of the present application;

FIGS. 10A to 10E are processing diagrams showing a cutting process of electrode tabs in the laminated electrode body of an embodiment of the present application;

FIGS. 11A to 11C are processing diagrams showing a process of connecting an electrode lead and the electrode tabs of the laminated electrode body in an embodiment of the present application;

FIGS. 12A to 12E are processing diagrams showing a process of bending the electrode lead connected with the laminated electrode body of an embodiment of the present application;

FIGS. 13A and 13B are perspective views showing a configuration of a battery unit using the non-aqueous electrolyte battery of an embodiment of the present application;

FIG. 14 is an exploded perspective view showing a configuration of a battery unit using the non-aqueous electrolyte battery of an embodiment of the present application;

FIG. 15 is a perspective view showing a configuration of a battery module using the non-aqueous electrolyte battery of an embodiment of the present application;

FIG. 16 is a perspective view showing a configuration of a battery module using the non-aqueous electrolyte battery of an embodiment of the present application;

FIG. 17A is a perspective view showing a configuration example of a parallel block;

FIG. 17B is a cross-sectional view showing a configuration example of the parallel block;

FIGS. 18A and 18B are schematic diagrams showing a configuration example of a module case;

FIG. 19 is a block diagram showing a configuration example of a battery pack according to an embodiment of the present application;

FIG. 20 is a schematic view showing an application example of power storage system for houses, using the non-aqueous electrolyte battery according to an embodiment of the present application; and

FIG. 21 is a diagram showing schematically an example of configuration of a hybrid vehicle employing series-hybrid system in which an embodiment of the present application is applied.

### DETAILED DESCRIPTION

Hereinafter, embodiments of the present application will be described with reference to the drawings. It should be noted that the descriptions will be made in the following order.

1. First embodiment (first example of non-aqueous electrolyte battery)

2. Second embodiment (second example of non-aqueous electrolyte battery)

3. Third embodiment (third example of non-aqueous electrolyte battery)

4. Fourth embodiment (fourth example of non-aqueous electrolyte battery)

5. Fifth embodiment (example of battery module etc.)

6. Sixth embodiment (example of battery pack using non-aqueous electrolyte battery)

7. Seventh embodiment (example of power storage system etc. using non-aqueous electrolyte battery)

8. Other embodiments (variations)

### 1. First Embodiment

### Configuration of Battery

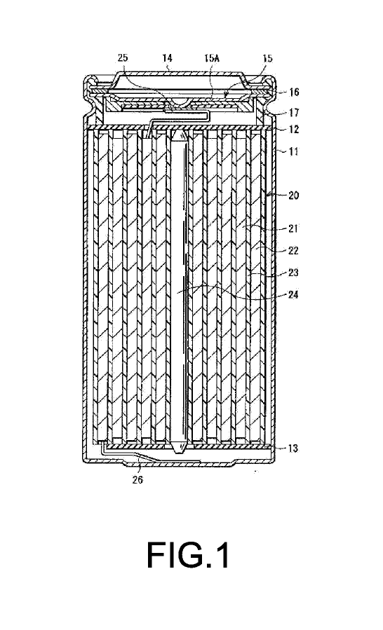

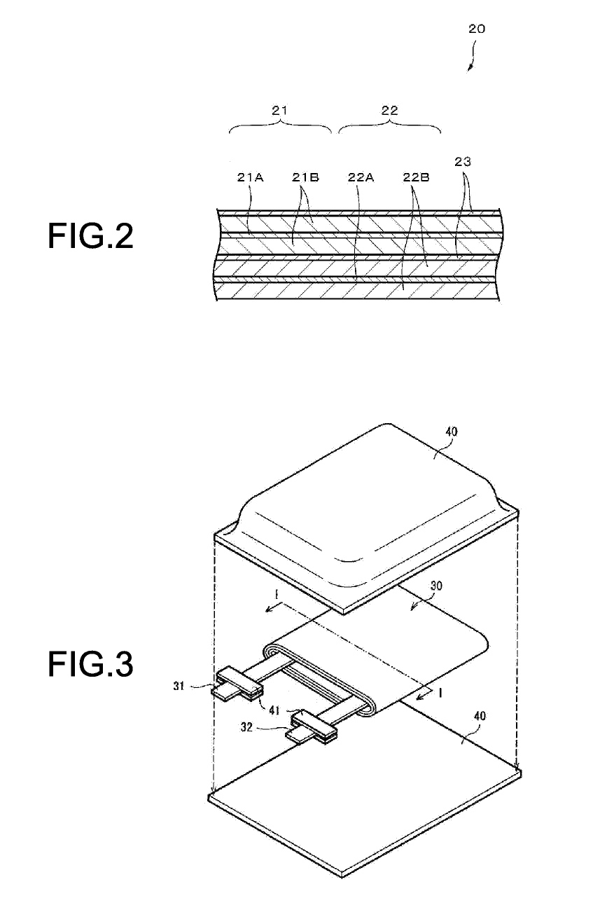

A non-aqueous electrolyte battery according to a first embodiment of the present application will be described with reference to FIGS. 1 and 2. FIG. 1 shows a cross-sectional configuration of the non-aqueous electrolyte battery according to the first embodiment of the present application. FIG. 2 shows by enlarging a part of the spirally wound electrode body 20 shown in FIG. 1. This non-aqueous electrolyte battery is, for example, a chargeable and dischargeable secondary battery. For example, it is a lithium-ion secondary battery in which the capacity of an anode 22 is represented by intercalating and deintercalating lithium as a reactive electrode material.

This non-aqueous electrolyte battery is mainly an item in which a substantially hollow cylinder shaped battery can 11 houses a spirally wound electrode body 20, having a cathode 21 and an anode 22 laminated and spirally wound with a separator 23 in between, and a pair of insulating plates 12 and 13 inside. A battery structure using this cylinder shaped battery can 11 is referred to as a cylinder type.

The battery can 11 is configured to have, for example, a hollow structure with its one end closed and other end open, made of material such as iron (Fe), aluminum (Al) and an alloy thereof. Further, if the battery can 11 is made of iron, the surface of the battery can 11 may be plated with material such as nickel (Ni), for example. The pair of insulating plates 12 and 13 is arranged in the positions sandwiching the spirally wound electrode body 20 from top and bottom. The pair of insulating plates 12 and 13 extends in a direction perpendicular to the winding peripheral surface of the spirally wound electrode body 20.

A battery cover 14, a safety valve mechanism 15 and a positive temperature coefficient device (PTC device) 16 are caulked via a gasket 17 at the open end of the battery can 11, and thereby the battery can 11 is sealed. The battery cover 14 is made, for example, of the same material as the battery can 11. The safety valve mechanism 15 and the PTC device 16 are provided on the inner side of the battery cover 14. The safety valve mechanism 15 is electrically connected with the battery cover 14 via the PTC device 16. With this safety valve mechanism 15, if the internal pressure reaches or exceeds a certain level due to internal short-circuit or heating from the outside or the like, a disc plate 15A would be inverted to cut off the electrical connection between the battery cover 14 and the spirally wound electrode body 20. The PTC device 16 is configured to increase electrical resistance (and restrict the amount of electric current) in response to an increase in temperature so as to prevent abnormal generation of heat due to the large current. A gasket 17 is made of material such as insulating material, and its surface is coated with asphalt, for example.

The spirally wound electrode body 20 has the cathode 21 and the anode 22 laminated and spirally wound with the separator 23 in between. This spirally wound electrode body 20 may have a center pin 24 inserted in the center. In the spirally wound electrode body 20, a cathode lead 25 made of material such as aluminum is connected to the cathode 21, and an anode lead 26 made of material such as nickel is connected to the anode 22. The cathode lead 25 is electrically connected with the battery cover 14 by such as being welded to the safety valve mechanism 15. The anode lead 26 is electrically connected to the battery can 11 by welding or the like.

[Cathode]

The cathode 21 is configured to include, for example, a cathode current collector 21A having a pair of surfaces, and cathode active material layer 21B provided on both of these surfaces. However, it may otherwise be configured to have the cathode active material layer 21B provided on only one side of the cathode current collector 21A.

The cathode current collector 21A is made of metallic material such as aluminum, nickel, and stainless steel, for example.

The cathode active material layer 21B may include as cathode active material, one or more kinds of cathode materials capable of intercalating and deintercalating lithium. The cathode active material layer 21B may further include other material such as binding agent, conducting agent, and the like, if necessary.

Materials suitable for the cathode material capable of intercalating and deintercalating lithium may include, for example, a lithium-containing compound such as lithium oxide, lithium phosphate, lithium sulfide, and lithium-containing intercalation compounds, and a mixture of two or more of these compounds may also be used. For achieving high energy density, the lithium-containing compound that contains lithium, transition metal element, and oxygen (O) is desirable. Examples of such lithium-containing compounds include lithium compound oxide having a layered rock salt-type structure represented by the following formula (1′) and lithium compound phosphate having an olivine-type structure represented by the following formula (2′), and the like. The lithium-containing compound that contains at least one kind of transition metal element selected from the group consisting of cobalt (Co), nickel (Ni), manganese (Mn) and iron (Fe) may be more desirable. Examples of such lithium-containing compounds include lithium compound oxide having a layered rock salt-type structure represented by at least one of the following formulae (3′), (4′) and (5′), lithium compound oxide having a spinel-type structure represented by the following formula (6′), and lithium compound phosphate having an olivine-type structure represented by the following formula (7′), and the like. Specifically, such examples include LiNi_{0.50}Co_{0.20}Mn_{0.30}O₂, LiₐCoO₂ (a≈1), Li_{b}NiO₂ (b≈1), Li_{c1}Ni_{c2}CO_{1-c2}O₂ (c1≈1, 0<c2<1), Li_{d}Mn₂O₄ (d≈1) and LiₑFePO₄ (e≈1).

LiₚNi_{(1-q-r)}Mn_{q}M1ᵣO_{(2-y)}X_{z} (1′)

(In this formula (1′), M1 indicates at least one kind of element selected from the elements of Groups 2-15 excluding nickel (Ni) and manganese (Mn). X indicates at least one kind of element selected from the elements of Groups 16 and 17 excluding oxygen (O). In the formula, p, q, r, y and z are values within the range defined as 0≦p≦1.5, 0≦q≦1.0, 0≦r≦1.0, −0.10≦y≦0.20 and 0≦z≦0.2.)

LiₐM2_{b}PO₄ (2′)

(In this formula (2′), M2 indicates at least one kind of element selected from the elements of Groups 2-15. In the formula, a and b are values within the range defined as 0≦a≦2.0 and 0.5≦b≦2.0.)

Li_{f}Mn_{(1-g-h)}Ni_{g}M3ₕO₍₂₋ⱼ₎Fₖ (3′)

(In this formula (3′), M3 indicates at least one kind of element selected from the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr) and tungsten (W). In the formula, f, g, h, j and k are values within the range defined as 0.8≦f≦1.2, 0<g<1.0, 0≦h≦0.5, g+h<1, −0.1≦j≦0.2 and 0≦k≦0.1. It should be noted that the composition of lithium varies depending on the charging and discharging state, and the value off indicates the value in the fully-discharged state.)

LiₘNi₍₁₋ₙ₎M4ₙO₍₂₋ₚ₎F_{q} (4′)

(In this formula (4′), M4 indicates at least one kind of element selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). In the formula, m, n, p and q are values within the range defined as 0.8≦m≦1.2, 0.005≦n≦0.5, −0.1≦p≦0.2 and 0≦q≦0.1. It should be noted that the composition of lithium varies depending on the charging and discharging state, and the value of m indicates the value in the fully-discharged state.)

LiᵣCo₍₁₋ₛ₎M5ₛO₍₂₋ₜ₎Fᵤ (5′)

(In this formula (5′), M5 indicates at least one kind of element selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). In the formula, r, s, t and u are values within the range defined as 0.8≦r≦1.2, 0≦s<0.5, −0.1≦t≦0.2 and 0≦u≦0.1. It should be noted that the composition of lithium varies depending on the charging and discharging state, and the value of r indicates the value in the fully-discharged state.)

LiᵥMn_{2-w}M6_{w}OₓF_{y} (6′)

(In this formula (6′), M6 indicates at least one kind of element selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). In the formula, v, w, x and y are values within the range defined as 0.9≦v≦1.1, 0≦w<0.6, 3.7≦x≦4.1 and 0≦y≦0.1. It should be noted that the composition of lithium varies depending on the charging and discharging state, and the value of v indicates the value in the fully-discharged state.)

Li_{z}M7PO₄ (7′)

(In this formula (7′), M7 indicates at least one kind of element selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W) and zirconium (Zr). In the formula, z is a value within the range defined as 0.9≦z≦1.1. It should be noted that the composition of lithium varies depending on the charging and discharging state, and the value of z indicates the value in the fully-discharged state.)

There are other examples of materials as the cathode material capable of intercalating and deintercalating lithium, and such other examples include inorganic compounds that do not contain lithium such as MnO₂, V₂O₅, V₆O₁₃, NiS and MoS.

The cathode material capable of intercalating and deintercalating lithium may be other than those above. Further, the cathode materials as listed above may also be mixed in any combination of two or more.

Examples of the binding agents include synthetic rubber such as styrene-butadiene rubber, fluorine-based rubber and ethylene-propylene-diene rubber, and polymeric materials such as polyvinylidene fluoride, and others. These can be used either alone or in mixture of at least two thereof.

Examples of the conducting agents include carbon materials such as graphite and carbon black, and others. These can be used either alone or in mixture of at least two thereof. In addition, the conducting agent may be material such as metallic material or conductive polymer material, as long as the material is conductive.

[Anode]

The anode 22 is configured to include, for example, an anode current collector 22A having a pair of surfaces, and anode active material layer 22B provided on both of these surfaces. However, it may otherwise be configured to have the anode active material layer 22B provided on only one side of the anode current collector 22A.

The anode current collector 22A is made of metallic material such as copper, nickel, and stainless steel, for example.

The anode active material layer 22B may include as anode active material, one or more kinds of anode materials capable of intercalating and deintercalating lithium. The anode active material layer 22B may further include other material such as binding agent, conducting agent, and the like, if necessary. In this anode active material layer 22B, for example, in order to prevent the unintentional deposition of lithium metal when charging and discharging, it is desirable that the charging capacity of the anode material be larger than the discharging capacity of the cathode 21. In addition, the binding agent and the conducting agent that can be used in the anode active material layer 22B are the same as those described in the description of the cathode.

Examples of materials capable of intercalating and deintercalating lithium include carbon materials. Examples of such carbon materials include non-graphitizable carbon, graphitizable carbon, artificial graphite such as MCMB (mesocarbon microbeads), natural graphite, pyrolytic carbons, cokes, graphites, glassy carbons, baked organic polymer compounds, carbon blacks, carbon fiber and activated carbon. Among such materials, the cokes may include pitch coke, needle coke and petroleum coke, for example. The baked organic polymer compounds are materials in which a polymeric material such as phenolic resin and furan resin is baked at appropriate temperatures and carbonized. Some of the baked organic polymer compounds can also be classified as non-graphitizable carbon, or graphitizable carbon.

Other than those carbon materials above, examples of the anode materials capable of intercalating and deintercalating lithium, include a material that is capable of intercalating and deintercalating lithium and also having at least one kind of metal element or semimetal element as a constituent element, because it provides a high energy density. Such anode material may be in any form of either or both of metal elements and semimetal elements, such as a single substance, an alloy and a compound, and a material that includes one or more of these forms at least in a portion thereof. It should be noted that “alloys” as referred to herein regarding the embodiments of the present application, include those containing two or more kinds of metal elements, and also those containing one or more kinds of metal elements and one or more kinds of semimetal elements. Further, the “alloys” may also contain non-metal elements. Structure of the alloys include a solid solution, an eutectic crystal (eutectic mixture), an intermetallic compound, and coexistence of two or more thereof.

Examples of the above-mentioned metal elements and the semimetal elements include a metal element or a semimetal element that is capable of forming an alloy with lithium, and the like. Specifically, such examples of the elements include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt). Among these elements, at least one of silicon and tin is desirable, and silicon would be further desirable. The reason is that such elements have high capability for intercalating and deintercalating lithium, and thereby a high energy density can be achieved.

Examples of anode materials having at least one of silicon and tin include silicon as single substances, alloys and compounds thereof, tin as single substances, alloys and compounds thereof, and materials that include one or more of these forms at least in a portion thereof.

Examples of alloys of silicon include an alloy containing, as its second constituent element other than silicon (Si), at least one kind of element selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of alloys of tin include an alloy containing, as its second constituent element other than tin (Sn), at least one kind of element selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr).

Examples of compounds of silicon or compounds of tin include a compound that contains either or both of oxygen (O) and carbon (C). Such compound may also contain, in addition to tin or silicon (Si), any of the second constituent elements described above.

In particular, it is desirable that the anode material having at least one of silicon (Si) and tin (Sn) contain, for example, tin (Sn) as its first constituent element, and second and third constituent elements in addition to tin (Sn). Needless to say, this anode material may be used in combination with any of the anode materials described above. The second constituent element is at least one kind of element selected from the group consisting of cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi) and silicon (Si). The third constituent element is at least one kind of element selected from the group consisting of boron (B), carbon (C), aluminum (Al) and phosphorus (P). By using such anode material containing the second and third constituent elements, cycle characteristics can be improved.

Among these materials, the SnCoC-containing material that contains tin (Sn), cobalt (Co) and carbon (C) as constituent elements, in which the content of carbon (C) is 9.9% by mass or more and 29.7% by mass or less and the proportion of cobalt (Co) of the sum of tin (Sn) and cobalt (Co) (Co/(Sn+Co)) is 30% by mass or more and 70% by mass or less, would be desirable. The reason is that in such composition range a high energy density and superior cycle characteristics can be achieved.

The SnCoC-containing material may further contain one or more other constituent elements if necessary. These other constituent elements desirably are, for example, silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), bismuth (Bi), and the like, and two or more thereof may also be contained. By using them, capacitance characteristics or cycle characteristics can be further improved.

In addition, it is desirable that the SnCoC-containing material have a phase containing tin (Sn), cobalt (Co) and carbon (C), in which the phase has a low crystallized or amorphous structure. Also, in the SnCoC-containing material, it is desirable that at least a part of carbon as the constituent element has been bonded to a metal element or a semimetal element as the other constituent element. The reason is that lowering of cycle characteristics is considered to have been due to aggregation or crystallization of tin (Sn) or the like, and with carbon atoms bonding to other elements, it would be possible to suppress such aggregation or crystallization.

Examples of a measurement method for examining the binding state of elements include X-ray photoelectron spectroscopy (XPS). In this XPS, so far as graphite is concerned, a peak of the 1s orbit of carbon (C1s) appears at 284.5 eV in an energy-calibrated apparatus such that a peak of the 4f orbit of a gold atom (Au4f) is obtained at 84.0 eV. Also, so far as surface-contaminated carbon is concerned, a peak of the 1s orbit of carbon (C1s) appears at 284.8 eV. For this, when a charge density of the carbon element is high, for example, when carbon is bonded to a metal element or a semimetal element, the peak of C1s appears in a lower region than 284.5 eV. That is, when a peak of a combined wave of C1s obtained on the SnCoC-containing material appears in a lower region than 284.5 eV, it means that at least a part of carbon (C) contained in the SnCoC-containing material is bonded to a metal element or a semimetal element as other constituent element.

Further, in the XPS measurement, for example, the peak of C1s is used for correcting the energy axis of a spectrum. In most cases, there is some surface-contaminated carbon present in the surface, so the peak of C1s of the surface-contaminated carbon can be fixed at 284.8 eV, and this peak can be used as an energy reference. In the XPS measurement, a waveform of the peak of C1s can be obtained as a form that includes both the peak of the surface-contaminated carbon and the peak of carbon from the SnCoC-containing material, so, for example, through an analysis using commercial software programs, the peak of the surface-contaminated carbon and the peak of the carbon from the SnCoC-containing material can be separated from each other. In the analysis of the waveform, the position of a main peak existing closer to the lowest binding energy is used as an energy reference (284.8 eV).

Also, examples of the anode materials capable of intercalating and deintercalating lithium include metal oxides and polymer compounds, each of which is capable of intercalating and deintercalating lithium. Examples of the metal oxides include lithium titanate (Li₄Ti₅O₁₂), iron oxide, ruthenium oxide and molybdenum oxide. Examples of the polymer compounds include polyacetylene, polyaniline and polypyrrole.

The anode material capable of intercalating and deintercalating lithium may be other than those above. Further, the anode materials mentioned above may also be mixed in any combination of two or more.

The anode active material layer 22B may be, for example, formed by any of a vapor phase method, a liquid phase method, a spraying method, a baking method or a coating method, or a combined method of two or more kinds of these methods. When the anode active material layer 22B is formed by using a vapor phase method, a liquid phase method, a spraying method, a baking method or a combined method of two or more kinds of these methods, it is desirable that the anode active material layer 22B and the anode current collector 22A would be alloyed on at least a part of an interface therebetween. Specifically, it is desirable that on the interface, constituent element of the anode current collector 22A would be diffused into the anode active material layer 22B, the constituent element of the anode active material layer 22B would be diffused into the anode current collector 22A, or these constituent elements would be diffused into each other. The reason is that the breakage due to expansion and shrinkage, following the charging and discharging, of the anode active material layer 22B can be suppressed, and also that electron conductivity between the anode active material layer 22B and the anode current collector 22A can be improved.

Examples of the vapor phase method include a physical deposition method and a chemical deposition method, specifically a vacuum vapor deposition method, a sputtering method, an ion plating method, a laser abrasion method, a thermal chemical vapor deposition (CVD) method and a plasma chemical vapor deposition method. As the liquid phase method, known techniques such as electrolytic plating and electroless plating can be used. The baking method as referred to herein is, for example, a method in which after a particulate anode active material is mixed with a binding agent and the like, the mixture is dispersed in a solvent and coated, and the coated material is then heated at a higher temperature than a melting point of the binding agent or the like. As to the baking method, known techniques can be also utilized, and examples thereof include an atmospheric baking method, a reaction baking method and a hot press baking method.

[Separator]

The separator 23 is configured to separate the cathode 21 and anode 22, preventing electric short-circuit and allowing the passage of lithium-ion. The separator 23 is configured to include, for example, a porous film made of synthetic resins such as polytetrafluoroethylene, polypropylene and polyethylene, or a porous film made of ceramic, or the like. The separator 23 may also include two or more of the above-mentioned porous films that has been laminated. This separator 23 is impregnated with an electrolyte solution, which is an electrolyte in the form of a liquid.

[Electrolyte Solution]

The electrolyte solution includes a solvent, an electrolytic salt, and at least one kind of 1,3-dioxane derivative represented by at least one of the following formulae (1) and (2). This electrolyte solution is an electrolyte in the form of a liquid, and for example it is a non-aqueous electrolyte in which the electrolytic salt is dissolved in a non-aqueous solvent.

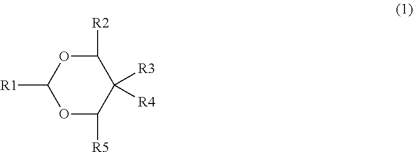

(In this formula (1), each of R1 to R5 independently represents a hydrogen group, a hydrocarbon group optionally having a substituent (excluding substituents containing nitrogen or oxygen), or a substituent group containing nitrogen or oxygen. Two or more groups selected from R1 to R5 may be bonded together. In the formula (1), at least one of R1 to R5 represents a substituent group containing nitrogen or oxygen.)

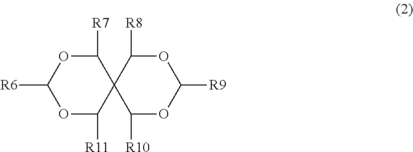

(In this formula (2), each of R6 to R11 independently represents a hydrogen group, a hydrocarbon group optionally having a substituent (excluding substituents containing nitrogen or oxygen), or a substituent group containing nitrogen or oxygen. In the formula (2), at least one of R6 to R11 represents a substituent group containing nitrogen or oxygen.)

The hydrocarbon group optionally having a substituent (excluding substituents containing nitrogen or oxygen) is, for example, one of the groups including an aliphatic hydrocarbon group such as an alkyl group and a hydrocarbon group such as an aromatic hydrocarbon group, or any of these groups in which one or more hydrogen groups have been replaced by a substituent (excluding substituents containing nitrogen or oxygen), and the like. The aliphatic hydrocarbon group may be linear, branched, or cyclic. Specifically, the substituent group containing nitrogen is, for example, one of the groups such as an amino group, an amide group, an imide group, a cyano group (nitrile group), an isonitrile group, an isoimide group, an isocyanate group, an imino group, a nitro group, a nitroso group, a pyridine group, a triazine group, a guanidine group, and an azo group, or a substituent group (such as a hydrocarbon group) having at least one of these groups. Here, the hydrocarbon group is, for example, an aliphatic hydrocarbon group such as an alkyl group, or an aromatic hydrocarbon group, or the like. The aliphatic hydrocarbon group may be linear, branched, or cyclic. It may also be tertiary, secondary or primary aliphatic hydrocarbon group. Carbon number of the substituent group containing nitrogen is not particularly limited, and it may desirably be, for example, zero or more and six or less. The substituent group containing oxygen is, for example, one of the groups such as a hydroxyl group, an ether group, an ester group, an aldehyde group, a peroxy group, and a carbonate group, or a substituent group (such as a hydrocarbon group) having at least one of these groups. Carbon number of the substituent group containing oxygen is not particularly limited, and it may desirably be, for example, zero or more and six or less. Here, the hydrocarbon group is, for example, an aliphatic hydrocarbon group such as an alkyl group, or an aromatic hydrocarbon group, or the like. The aliphatic hydrocarbon group may be linear, branched, or cyclic. It may also be tertiary, secondary or primary aliphatic hydrocarbon group. The hydrocarbon group optionally having a substituent (excluding substituents containing nitrogen or oxygen), or the substituent group containing nitrogen or oxygen is, for example, a univalent group. It should be noted that the same applies to the substituent group containing nitrogen and the substituent group containing oxygen that are mentioned in description of formula (2-1) below.

By including the 1,3-dioxane derivative represented by the formula (1) or (2) in the electrolyte solution, it becomes possible to inhibit the gas generation. As a result, battery characteristics such as cycle characteristics can be improved. This is considered to be an effect of that the 1,3-dioxane derivative represented by the formula (1) or (2) is a 1,3-dioxane derivative having a substituent group containing nitrogen or oxygen, in which the substituent group has an unshared electron pair. Therefore, it is considered to be an effect of that the 1,3-dioxane derivative represented by the formula (1) or (2) has an unshared electron pair in its substituent group, thereby being capable of coordinating on the surface of the cathode. Examples of substituent groups having at least one unshared electron pair include a substituent group containing any one or more kinds of atoms such as nitrogen, oxygen, phosphorus and sulfur. From a point of view of stability against oxidation, a substituent group containing nitrogen or oxygen, as the substituent groups included in formulae (1) and (2), is desirable, and a substituent group containing nitrogen is further desirable. On the other hand, if all the substituent groups at the positions 2, 4, 5 and 6 of ring in formula (1) are hydrogen groups and hydrocarbon groups instead of including one or more substituent groups containing nitrogen or oxygen, the effect would be small. Similarly, if all the substituent groups at the positions 1, 3, 5, 7, 9 and 11 of the spiro ring in formula (2) are hydrogen groups and hydrocarbon groups instead of including one or more substituent groups containing nitrogen or oxygen, the effect would be small. Further, if all the substituent groups at the positions 1, 3, 5, 7, 9 and 11 of spiro ring in formula (2) are hydrogen groups and hydrocarbon groups, there would be a tendency to have a negative influence on low-temperature cycle characteristics. This is assumed to be due to the coating that derives from the compounds of formula (2) in which all the substituent groups at the positions 1, 3, 5, 7, 9 and 11 of the spiro ring are hydrogen groups and hydrocarbon groups, because the lithium-ion permeability of this coating would be low. On the other hand, the addition of the 1,3-dioxane derivative represented by the formula (1) or (2) is not likely to negatively influence low-temperature cycle characteristics. This is assumed to be because the coating that derives from the 1,3-dioxane derivative represented by the formula (1) or (2) would not significantly lower its lithium-ion permeability.

Among the 1,3-dioxane derivatives represented by at least one of formulae (1) and (2), a 1,3-dioxane derivative represented by the formula (2) having a spiro-structure is desirable. The reason is that, it is considered that when such a compound has a spiro-structure, thereby a stronger coating can be formed after the coordinating of its substituent site on the surface of the cathode. Among the 1,3-dioxane derivatives represented by the formula (1), one in which has a substituent group containing nitrogen or oxygen at the position 2 is desirable. Among the 1,3-dioxane derivatives represented by the formula (2), one in which has a substituent group containing nitrogen or oxygen at at least one of the positions 3 and 9 is desirable. Among the 1,3-dioxane derivatives represented by the formula (2), one in which has a substituent group containing nitrogen or oxygen at both the positions 3 and 9 is further desirable, and an example of such 1,3-dioxane derivative includes 1,3-dioxane derivative represented by the following formula (2-1).

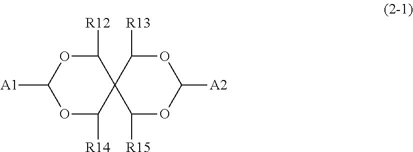

(In this formula (2-1), each of A1 and A2 independently represents a substituent group containing nitrogen or oxygen. Each of R12 to R15 independently represents a hydrogen group, a hydrocarbon group which may have a substituent (excluding substituents containing nitrogen or oxygen), or a substituent group containing nitrogen or oxygen.)

[Content]

The content of the 1,3-dioxane derivative represented by the above-mentioned formula (1) or (2) is, for example, 0.01% by mass or more and 50% by mass or less of the total mass of the non-aqueous electrolyte solution. The content desirably is 0.01% by mass or more and 30% by mass or less, and further desirably 0.01% by mass or more and 10% by mass or less so that its effectiveness would increase.

[Other Additives]

It is desirable that the electrolyte solution, including 1,3-dioxane derivative represented by the above-mentioned formula (1) or (2), further include at least one kind of compounds represented by at least one of the following formulae (3) to (6). Therefore, through charging and discharging, a coating derived from at least one kind of compounds represented by at least one of the following formulae (3) to (6) would form on the electrodes, and it will thereby become possible to improve battery characteristics.

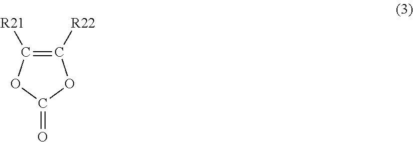

(In this formula (3), each of R21 and R22 independently represents a hydrogen group or an alkyl group.)

The compounds represented by the formula (3) are vinylene carbonate series of compounds. Examples of the vinylene carbonate series of compounds include vinylene carbonate (1,3-dioxol-2-one), methylvinylene carbonate (4-methyl-1,3-dioxol-2-one), ethylvinylene carbonate (4-ethyl-1,3-dioxol-2-one), 4,5-dimethyl-1,3-dioxol-2-one, and 4,5-diethyl-1,3-dioxol-2-one. These can be used either alone or in mixture of at least two thereof. Among them, vinylene carbonate would be desirable. The reason is that this compound is easily available and highly effective.

Typically, the content of the compounds represented by the formula (3) is, for example, 0.01% by mass or more and 10% by mass or less of the total mass of the non-aqueous electrolyte solution. The content desirably is 0.1% by mass or more and 5% by mass or less.

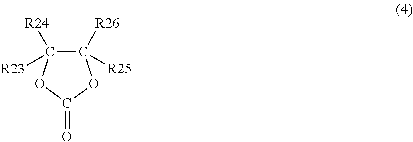

(In this formula (4), each of R23 to R26 independently represents a hydrogen group, a halogen group, an alkyl group or a halogenated alkyl group. In the formula (4), at least one of R23 to R26 represents a halogen group or a halogenated alkyl group.)

When at least one kind of compounds represented by the formula (4) is included in the electrolyte solution, a protective coat forms on the surfaces of electrodes and inhibits the decomposition of the electrolyte solution, so it would be a desirable configuration.

Examples of the compounds represented by the formula (4) include 4-fluoro-1,3-dioxolan-2-one, 4-chloro-1,3-dioxolan-2-one, 4,5-difluoro-1,3-dioxolan-2-one, tetrafluoro-1,3-dioxolan-2-one, 4-chloro-5-fluoro-1,3-dioxolan-2-one, 4,5-dichloro-1,3-dioxolan-2-one, tetrachloro-1,3-dioxolan-2-one, 4,5-bistrifluoromethyl-1,3-dioxolan-2-one, 4-trifluoromethyl-1,3-dioxolan-2-one, 4,5-difluoro-4,5-dimethyl-1,3-dioxolan-2-one, 4,4-difluoro-5-methyl-1,3-dioxolan-2-one, 4-ethyl-5,5-difluoro-1,3-dioxolan-2-one, 4-fluoro-5-trifluoromethyl-1,3-dioxolan-2-one, 4-methyl-5-trifluoromethyl-1,3-dioxolan-2-one, 4-fluoro-4,5-dimethyl-1,3-dioxolan-2-one, 5-(1,1-difluoro ethyl)-4,4-difluoro-1,3-dioxolan-2-one, 4,5-dichloro-4,5-dimethyl-1,3-dioxolan-2-one, 4-ethyl-5-fluoro-1,3-dioxolan-2-one, 4-ethyl-4,5-difluoro-1,3-dioxolan-2-one, 4-ethyl-4,5,5-trifluoro-1,3-dioxolan-2-one, and 4-fluoro-4-methyl-1,3-dioxolan-2-one. These can be used either alone or in mixture of at least two thereof.

Among them, 4-fluoro-1,3-dioxolan-2-one, and 4,5-difluoro-1,3-dioxolan-2-one are desirable. The reason is that these compounds are easily available and highly effective.

Typically, the content of the compounds represented by the formula (4) is, for example, 0.01% by mass or more and 50% by mass or less of the total mass of the non-aqueous electrolyte solution. The content desirably is 0.1% by mass or more and 5% by mass or less.

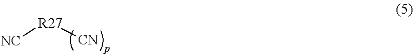

(In this formula (5), R27 represents an alkylene group of 1 to 18 carbon atoms optionally having a substituent, an alkenylene group of 2 to 18 carbon atoms optionally having a substituent, an alkynylene group of 2 to 18 carbon atoms optionally having a substituent, or a bridged-ring optionally having a substituent. In the formula (5), p represents an integer from 0 to an upper limit as determined depending on R27.)

When at least one kind of compounds represented by the formula (5) is included in the electrolyte solution, a coating derived from at least one kind of compound represented by the formula (5) forms on the surface of electrodes, and it will thereby become possible to improve battery characteristics. Examples of the compounds represented by the formula (5) include malononitrile, succinonitrile, glutaronitrile, adiponitrile, pimelonitrile, sebaconitrile, 1,2,3-propanetricarbonitrile, fumaronitrile, and 7,7,8,8-tetracyanoquinodimethane.

Typically, the content of the compounds represented by the formula (5) is, for example, 0.01% by mass or more and 10% by mass or less of the total mass of the non-aqueous electrolyte solution. The content desirably is 0.1% by mass or more and 5% by mass or less.

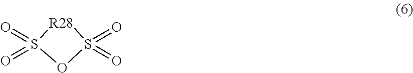

(In this formula (6), R28 represents CₘH₂ₘ₋ₙXₙ (provided that X is a halogen atom), m represents an integer from 2 to 4, and n represents an integer from 0 to 2m.)

When at least one kind of compounds represented by the formula (6) is included in the electrolyte solution, chemical stability of the electrolyte solution can be further improved. Examples of the compounds represented by the formula (6) include ethanedisulfonic anhydride and propanedisulfonic anhydride.

Typically, the content of the compounds represented by the formula (6) is, for example, 0.01% by mass or more and 10% by mass or less of the total mass of the non-aqueous electrolyte solution. The content desirably is 0.1% by mass or more and 5% by mass or less.

[Solvent]

Examples of the solvents include non-aqueous solvents such as ethylene carbonate, propylene carbonate, butylene carbonate, dimethyl carbonate, diethyl carbonate, ethyl methyl carbonate, methyl propyl carbonate, γ-butyrolactone, valerolactone, 1,2-dimethoxyethane, tetrahydrofuran, 2-methyltetrahydrofuran, tetrahydropyrane, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide.

The solvent described listed above can be used either as one kind thereof or in combination of two or more if necessary. Among these solvents, at least one kind of solvent selected from the group consisting of ethylene carbonate, propylene carbonate, dimethyl carbonate, diethyl carbonate and ethyl methyl carbonate would be desirable. In this case, a combination of, a thick solvent (with high permittivity, for example, with relative permittivity of ε≧30) such as ethylene carbonate and propylene carbonate; and a thin solvent (for example, with viscosity of 1 [mPa·s] or less) such as dimethyl carbonate, ethyl methyl carbonate and diethyl carbonate; would be further desirable. The reason is that electrolysis-ness of electrolytic salts and mobility of ions would be improved.

[Electrolytic Salt]

As the electrolytic salt, for example, any one or more kinds of light metal salts such as lithium salts can be used.

Examples of lithium salts include lithium hexafluorophosphate (LiPF₆), lithium tetrafluoroborate, lithium perchlorate, lithium hexafluoroarsenate, lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithiumhexafluorosilicate (Li₂SiF₆), lithium chloride (LiCl) and lithium bromide (LiBr). The electrolytic salt described listed above can be used either as one kind thereof or in combination of two or more if necessary.

[Manufacturing Method of Battery]

The non-aqueous electrolyte battery is, for example, manufactured by the following method.

[Manufacture of Cathode]

First of all, the cathode 21 is fabricated. First, a cathode material, a binding agent and a conducting agent are mixed to form a cathode mixture, which is then dispersed in an organic solvent to form cathode mixture slurry in a paste form. Subsequently, the cathode mixture slurry is uniformly coated on both surfaces of the cathode current collector 21A by a doctor blade or a bar coater or the like and then dried. Finally, the coating is subjected to compression molding by a roll press or the like, with heating if necessary, thereby forming the cathode active material layer 21B. In that case, the compression molding may be repeatedly carried out plural times.

[Manufacture of Anode]

Next, the anode 22 is fabricated. First, an anode material and a binding agent and optionally, a conductive agent are mixed to form an anode mixture, which is then dispersed in an organic solvent to form anode mixture slurry in a paste form. Subsequently, the anode mixture slurry is uniformly coated on both surfaces of the anode current collector 22A by a doctor blade or a bar coater or the like and then dried. Finally, the coating is subjected to compression molding by a roll press or the like, with heating if necessary, thereby forming the anode active material layer 22B.

It should be noted that the anode 22 may be manufactured also in the following way. First, the anode current collector 22A which include electrolytic copper foil or the like is prepared, and then by vapor phase method such as vapor deposition method, the anode material is deposited on both surfaces of the anode current collector 22A, thereby forming a plurality of anode active material particles. After this, if necessary, forming an oxide-containing coating by liquid phase method such as liquid phase deposition; forming a metallic substance by liquid phase method such as electrolytic plating; or forming both of the above, the anode active material layer 22B can be formed.

[Assembly of Battery]

The non-aqueous electrolyte battery is assembled in the following manner. First, the cathode lead 25 is installed in the cathode current collector 21A by welding or the like, and the anode lead 26 is installed in the anode current collector 22A by welding or the like. Then, the cathode 21 and the anode 22 are spirally wound via the separator 23 to form the spirally wound electrode body 20, and after this, a center pin 24 is inserted in the center of the winding. Subsequently, the spirally wound electrode body 20 is interposed between a pair of the insulating plates 12 and 13, as being housed in the inside the battery can 11, while a tip end of the cathode lead 25 is welded to the safety valve mechanism 15 and a tip end of the anode lead 26 is welded to the battery can 11.

Subsequently, the electrolyte solution mentioned above is injected into the inside of the battery can 11 and the separator 23 is impregnated with the electrolyte solution. Finally, the battery cover 14, the safety valve mechanism 15 and the PTC device 16 are cauked via the gasket 17 at the open end of the battery can 11, to be fixed. Thus, the non-aqueous electrolyte battery shown in FIGS. 1 and 2 is completed.

### 2. Second Embodiment

### Configuration of Battery

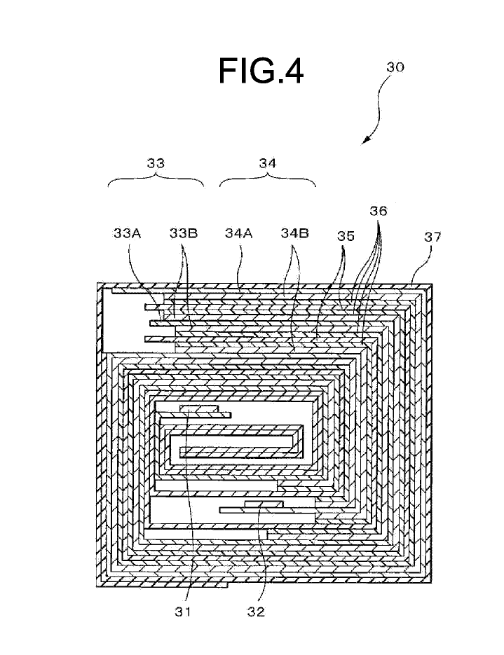

A non-aqueous electrolyte battery according to a second embodiment of the present application will be described. FIG. 3 is an exploded perspective view showing a configuration example of a non-aqueous electrolyte battery according to the second embodiment of the present application, and FIG. 4 shows an enlarged view of a cross-section along I-I line of a spirally wound electrode body 30 shown in FIG. 3.

This non-aqueous electrolyte battery is mainly an item in which the spirally wound electrode body 30 having a cathode lead 31 and a anode lead 32 installed therein is housed in the inside of a film-shaped exterior member 40. A battery structure using this film-shaped exterior member 40 is called a laminated film type.

The cathode lead 31 and the anode lead 32 are, for example, led out from the inside of the exterior member 40 toward the outside in the same direction. The cathode lead 31 is made of metallic material such as aluminum, for example. The anode lead 32 is made of metallic material such as copper, nickel, and stainless steel, for example. Such metallic material is in sheet-like form or net-like form, for example.

The exterior member 40, for example, such as for aluminum laminated films by lamination of nylon film, aluminum foil and polyethylene film in that order, has a configuration in which a resin layer is provided on both surfaces of a metal layer made from metallic foil. A typical configuration of the exterior member 40 includes, for example, a layered structure having outer resin layer, metal layer and inner resin layer. For example, the exterior member 40 has a structure such as, a structure in which respective outer edges of two rectangular aluminum laminated films are adhered to each other by fusion or use of an adhesive so that the inner resin layer faces the spirally wound electrode body 30. Each of these outer resin layer and inner resin layer may also be configured in multiple layers.

The metallic material to be used as a component of the metal layer may be any of, for example, aluminum (Al) foil, stainless steel (SUS) foil, nickel (Ni) foil, plated iron (Fe) foil, and the like, as long as the material may function as a barrier film resistant to moisture permeation. Among them, it is desirable that aluminum foil, which is thin, light, and easy to process, be used appropriately as such material. In particular, from the viewpoint of processability, for example, material such as annealed aluminum (JIS A8021P-O), (JIS A8079P-O) and (JIS A1N30-O) is desirable.

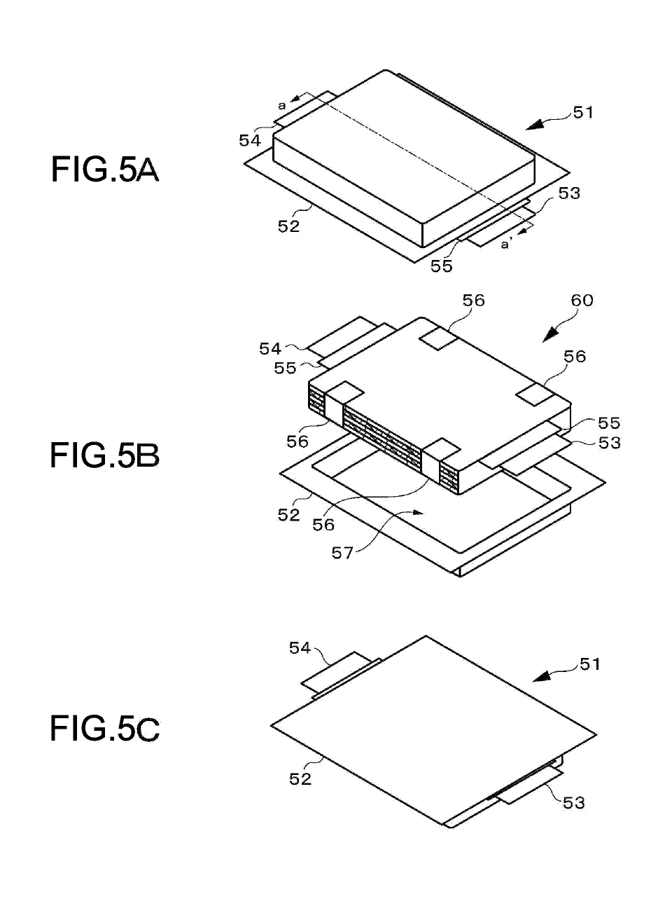

The thickness of metal layer is desirably 30 μm or more and 150 μm or less. If the thickness is less than 30 μm, the material strength may be weakened. If the thickness is exceeding 150 μm, it may lead to severe difficulty in processing, and also the laminated film (such as after-mentioned laminated film 52 of FIG. 5A, etc.) may be made thicker, in which case volumetric efficiency of the non-aqueous electrolyte battery may be lower.

The inner resin layer is a portion which melts with heat and fuses with one another, where material such as polyethylene (PE), cast polypropylene (CPP), polyethyleneterephtalate (PET), low density polyethylene (LDPE), high density polyethylene (HDPE) and linear low density polyethylene (LLDPE) may be used. Also, at least two kinds selected from these materials can be used.

For the outer resin layer, from advantages such as beautiful external appearance, toughness and flexibility, material such as polyolefin resins, polyamide resins, polyimide resins and polyester may be used. Specifically, there may be used nylon (Ny), polyethyleneterephtalate (PET), polyethylenenaphthalate (PEN), polybuthyleneterephtalate (PBT) or polybuthylenenaphthalate (PBN). Also, at least two kinds selected from these materials can be used.

Between the exterior member 40 and each of the cathode lead 31 and the anode lead 32, there is inserted an adhesive film 41 for preventing invasion of the outside air. This adhesive film 41 is made of material having adhesion to the cathode lead 31 and the anode lead 32. Examples of such materials include polyolefin resins such as polyethylene, polypropylene, modified polyethylene and modified polypropylene.

It should be noted that the exterior member 40 may also be configured to include instead of the aluminum laminated film having the layered structure described above, a laminated film having other layered structure or a polymer film such as polypropylene and metal film.

FIG. 4 shows a sectional configuration along I-I line of a spirally wound electrode body 30 shown in FIG. 3. This spirally wound electrode body 30 has a cathode 33 and an anode 34 laminated and spirally wound with a separator 35 and an electrolyte 36 in between. The outermost peripheral part of the spirally wound electrode body 30 is protected by a protective tape 37.

The cathode 33 is, for example, an item in which a cathode active material layer 33B is provided on both surfaces of a cathode current collector 33A. The anode 34 is, for example, an item in which an anode active material layer 34B is provided on both surfaces of an anode current collector 34A. The anode active material layer 34B and the cathode active material layer 33B are arranged facing each other. Configurations of the cathode current collector 33A, the cathode active material layer 33B, the anode current collector 34A, the anode active material layer 34B and the separator 35 are substantially the same as those of the cathode current collector 21A, the cathode active material layer 21B, the anode current collector 22A, the anode active material layer 22B and the separator 23 in the first embodiment, respectively.

The electrolyte 36 includes an electrolyte solution substantially the same as that in the first embodiment described above, and a polymer compound capable of holding the electrolyte solution. The electrolyte 36 is, for example, a so-called gelatinous electrolyte. Such gelatinous electrolyte would be desirable, because it can provide high ion conductivity (for example, 1 mS/cm or more at room temperature) and prevention of liquid leakage.

Examples of the polymer compounds include polyacrylonitrile, polyvinylidene fluoride, a copolymer of polyvinylidene fluoride and hexafluoropropylene, polytetrafluoroethylene, polyhexafluoropropylene, polyethylene oxide, polypropylene oxide, polyphosphazen, polysiloxane, polyvinyl acetate, polyvinyl alcohol, polymethyl methacrylate, polyacrylic acid, polymethacrylic acid, a styrene-butadiene rubber, a nitrile-butadiene rubber, polystyrene, polycarbonate and the like. These can be used either alone or in mixture of at least two thereof. Among them, polyacrylonitrile, polyvinylidene fluoride, polyhexafluoropropylene and polyethylene oxide are desirable. The reason is that these compounds are electrochemically stable.

[Manufacturing Method of Battery]

This non-aqueous electrolyte battery is, for example, manufactured by the following three kinds of manufacturing methods (first to third manufacturing methods).

[First Manufacturing Method]

In a first manufacturing method, first of all, for example, by procedures substantially the same as procedures for fabrication of the cathode 21 and the anode 22 in the first embodiment described above, the cathode active material layer 33B is formed on both surfaces of the cathode current collector 33A to fabricate the cathode 33. The anode active material layer 34B is formed on both surfaces of the anode current collector 34A to fabricate the anode 34.

Subsequently, a precursor solution, which contains the electrolyte solution substantially the same as that in the first embodiment; the polymer compound; and a solvent, is prepared and coated on each of the cathode 33 and the anode 34. The solvent is then volatilized, and thereby the electrolyte 36 in gelatinous form is formed. Subsequently, the cathode lead 31 is installed in the cathode current collector 33A, and the anode lead 32 is installed in the anode current collector 34A.

Subsequently, the cathode 33 and the anode 34, each having the electrolyte 36 formed thereon, are laminated with the separator 35 in between, then spirally wound in a longitudinal direction thereof, and on its outermost peripheral part, the protective tape 37 is adhered thereto, thereby fabricating the spirally wound electrode body 30. Finally, for example, the spirally wound electrode body 30 is interposed between the two film-shaped exterior members 40, then the outer edges of the exterior members 40 are adhered to each other by fusion or the like, thereby enclosing the spirally wound electrode body 30. At this time, the adhesive film 41 is inserted between each of the cathode lead 31 and the anode lead 32 and the exterior member 40. Thus, the non-aqueous electrolyte battery shown in FIGS. 3 and 4 is completed.

[Second Manufacturing Method]

In a second manufacturing method, first of all, the cathode lead 31 is installed in the cathode 33, and the anode lead 32 is installed in the anode 34. Subsequently, the cathode 33 and the anode 34 are laminated with the separator 35 in between, then spirally wound, and on its outermost peripheral part, the protective tape 37 is adhered thereto, thereby fabricating a spirally wound body which is a precursor of the spirally wound electrode body 30.

Subsequently, the spirally wound body is interposed between the two film-shaped exterior members 40, then the outer edges of each of the exterior members 40, excluding one side thereof respectively, are adhered to each other by fusion or the like, thereby housing the spirally wound body in the inside of the exterior member 40 formed in a pouch-shape. Subsequently, an electrolyte composite, which contains the electrolyte solution substantially the same as that in the first embodiment; monomer as a raw material of the polymer compound; a polymerization initiator; and optionally, other material such as a polymerization inhibitor, is prepared and injected into the inside of the pouch-shaped exterior member 40. Then, an opening of the exterior member 40 is sealed by fusion or the like. Finally, the monomer is heat-polymerized to provide a polymer compound, and thereby the electrolyte 36 in gelatinous form is formed. Thus, the non-aqueous electrolyte battery shown in FIGS. 3 and 4 is completed.

[Third Manufacturing Method]

In a third manufacturing method, first of all, the spirally wound body is formed and housed in the inside of the exterior member 40 substantially in the same manner as in the second manufacturing method described above, except that the separator 35 as used here would be one having a polymer compound coated on both surfaces thereof.

Examples of the polymer compound which is coated on this separator 35 include polymers that contain vinylidene fluoride, namely a homopolymer, a copolymer or a multi-component copolymer, or the like. Specifically, such examples include polyvinylidene fluoride, a binary copolymer that contains vinylidene fluoride and hexafluoropropylene, and a ternary copolymer that contains vinylidene fluoride, hexafluoropropylene and chlorotrifluoroethylene, and the like. The polymer compound, containing any of the polymers that contain vinylidene fluoride described above, may further contain one or more kinds of other polymer compounds.

The polymer compound on the separator 35 may be, for example, forming a porous polymer compound in the following manner. That is, first, a solution in which the polymer compound is dissolved in a first solvent having polar organic solvent such as N-methyl-2-pyrrolidone, γ-butyrolactone, N,N-dimethyl acetamide and N,N-dimethyl sulfoxide is prepared and coated on the separator 35. Next, the separator 35, coated with the solution described above, is immersed in a second solvent, such as water, ethyl alcohol and propyl alcohol which has a mutual solubility to the above-mentioned polar organic solvent and is a poor solvent for the above-mentioned polymer compound. At this time, solvent exchange takes place, and phase separation accompanied by spinodal decomposition arises, thereby making the polymer compound form a porous structure. After this, by drying, the porous polymer compound having porous structure can be obtained.

Subsequently, the electrolyte solution substantially the same as that in the first embodiment is prepared and injected into the inside of the exterior member 40, and then, an opening of the exterior member 40 is sealed by fusion or the like. Finally, the exterior member 40 is heated while being pressed, thereby adhering the separator 35 to each of the cathode 33 and the anode 34. Thus, the electrolyte solution immerses the polymer compound, then the polymer compound be gelled to form the electrolyte 36. Thus the non-aqueous electrolyte battery shown in FIGS. 3 and 4 can be completed.

### 3. Third Embodiment

A non-aqueous electrolyte battery according to a third embodiment of the present application will be described. Configurations of the non-aqueous electrolyte battery according to the third embodiment of the present application is substantially the same as those according to the second embodiment, except that instead of using the polymer compound holding the electrolyte solution (electrolyte 36), an electrolyte solution is used directly. Hereinafter, configurations which are different from those in the second embodiment will be described in details, arbitrarily omitting the description of the configurations which are substantially the same to those in the second embodiment, thereby avoiding repetition of description.

[Configuration of Battery]

In the non-aqueous electrolyte battery according to the third embodiment of the present application, an electrolytic solution is used instead of the electrolyte 36 in gelatinous form. Therefore, a spirally wound electrode body 30 has a configuration in which the electrolyte 36 is omitted, and a separator 35 is impregnated with an electrolyte solution substantially the same as that in the first embodiment.

[Manufacturing Method of Battery]

The non-aqueous electrolyte battery is, for example, manufactured in the following manner.

First of all, for example, a cathode active material, a binding agent and a conducting agent are mixed to be prepared in a cathode mixture, which is then dispersed in a solvent such as N-methyl-2-pyrrolidone to provide cathode mixture slurry. Next, this cathode mixture slurry is coated on both surfaces of a cathode current collector 33A, then dried, and then subjected to compression molding thereby forming a cathode active material layer 33B. Thus, a cathode 33 is fabricated. Subsequently, for example, a cathode lead 31 is connected to the cathode current collector 33A by, for example, ultrasonic welding, spot welding or the like.

Also, for example, an anode material and a binding agent are mixed to be prepared in an anode mixture, which is then dispersed in a solvent such as N-methyl-2-pyrrolidone to provide anode mixture slurry. Next, this anode mixture slurry is coated on both surfaces of an anode current collector 34A, then dried, and then subjected to compression molding thereby forming an anode active material layer 34B. Thus, an anode 34 is fabricated. Subsequently, for example, an anode lead 32 is connected to the anode current collector 33A by, for example, ultrasonic welding, spot welding or the like.

Subsequently, the cathode 33 and the anode 34 are spirally wound with the separator 35 in between, and then interposed in the inside of an exterior member 40. After this, the electrolyte solution substantially the same as that in the first embodiment is injected into the inside of the exterior member 40, and then, the exterior member 40 is sealed. Thus, the non-aqueous electrolyte battery can be obtained.

### 4. Fourth Embodiment

### Configuration of Battery

A configuration example of a non-aqueous electrolyte battery according to a fourth embodiment of the present application will be described. FIG. 5A is a perspective view showing external appearance of the non-aqueous electrolyte battery according to the fourth embodiment of the present application. FIG. 5B is an exploded perspective view showing the configuration of the non-aqueous electrolyte battery according to the fourth embodiment of the present application. FIG. 5C is a perspective view showing the configuration of the bottom side of the non-aqueous electrolyte battery shown in FIG. 5A. It should be noted that hereinafter, within a non-aqueous electrolyte battery 51, a part where a cathode lead 53 is led out from is referred to as a top part; a part on a side opposite to the top part and where an anode lead 54 is led out from is referred to as a bottom part; and two sides lying between the top part and the bottom part are both referred to as a side part. In addition, regarding electrodes, electrode leads and the like, a length in direction from the side part to another side part is referred to as width, in the following description.

As shown in FIGS. 5A to 5C, the non-aqueous electrolyte battery 51 of an embodiment of the present application is, for example, a chargeable and dischargeable secondary battery which is configured to have a laminated electrode body 60 encased by a laminated film 52, and the cathode lead 53 and the anode lead 54, which are connected to the laminated electrode body 60, are led out respectively from the parts where portions of the laminated film 52 are sealed together, towards the outside of the battery. The cathode lead 53 and the anode lead 54 are led out from the sides opposite to each other.

[Laminated Electrode Body]

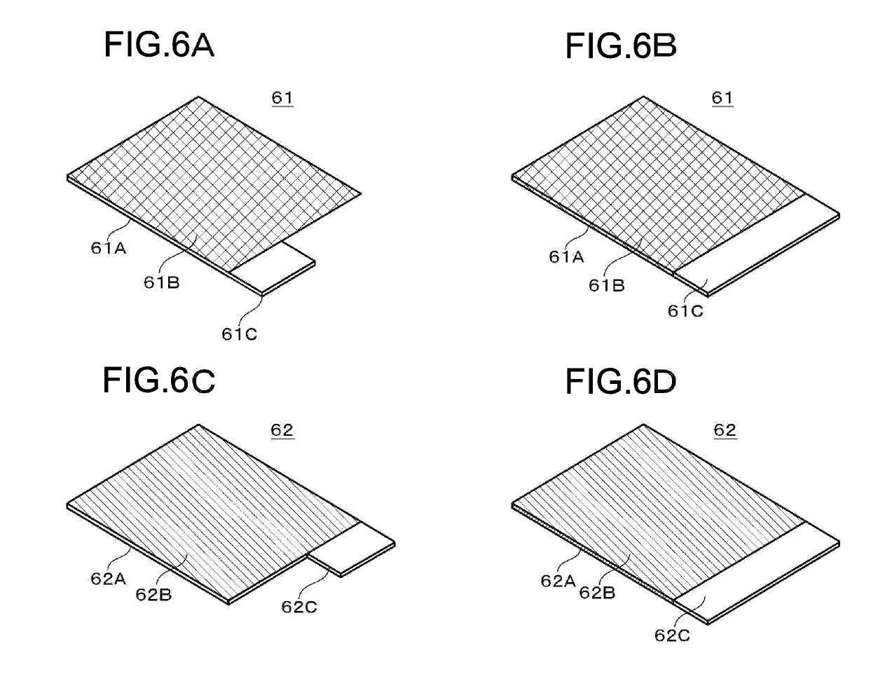

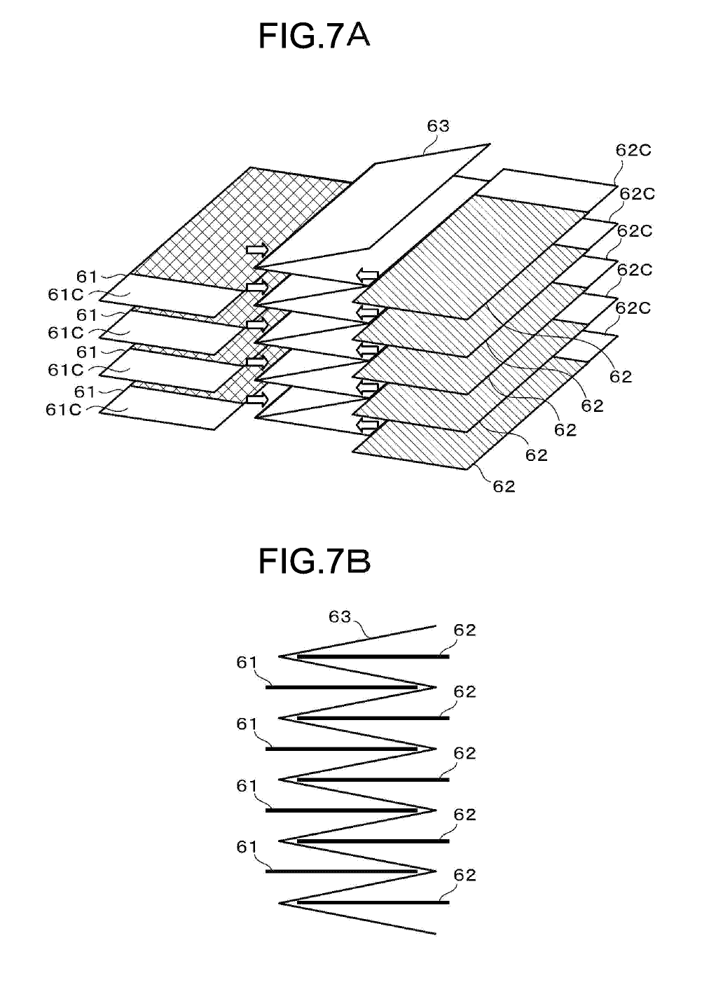

Each of FIGS. 6A and 6B shows a configuration example of a cathode which is included in a laminated electrode body. Each of FIGS. 6C and 6D shows a configuration example of an anode which is included in the laminated electrode body. Each of FIGS. 7A and 7B shows a configuration example of the laminated electrode body before being encased by a laminated film. A configuration of the laminated electrode body 60 includes rectangular-shaped cathode 61 as shown in FIG. 6A or 6B; and rectangular-shaped anode 62 as shown in FIG. 6C or 6D; laminated, with a separator 63 in between. An example of such configuration specifically includes, as shown in FIGS. 7A and 7B, the cathodes 61 and the anodes 62 laminated one after the other, with the separator 63 in zig-zag folded form interposed in between. Or, instead of the separator 63 in zig-zag folded form, a plurality of rectangular-shaped separators may also be used. In the fourth embodiment, in order for the outermost layer of the laminated electrode body 60 to be the separator 63, the laminated electrode body 60 which is laminated in the order of the separator 63, the anode 62, the separator 63, the cathode 61, . . . , the anode 62, the separator 63, is used. Here, the laminated electrode body 60 shown in FIGS. 7A and 7B is an example in which the cathode 61 shown in FIG. 6B and the anode 62 shown in FIG. 6D are used. Although not shown in the drawing, instead of the cathode 61 shown in FIG. 6B, the cathode 61 shown in FIG. 6A may be used. Also, instead of the anode 62 shown in FIG. 6D, the anode 62 shown in FIG. 6C may be used.

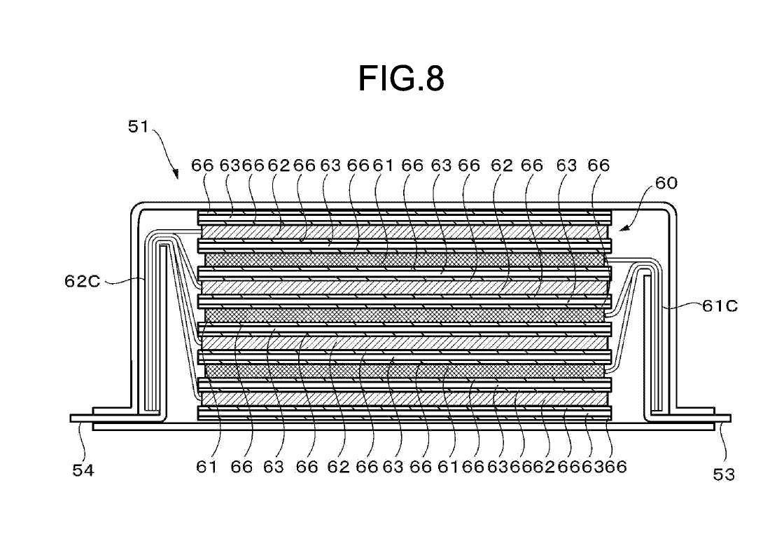

FIG. 8 is a cross-sectional view of the non-aqueous electrolyte battery of FIG. 5A, taken along line a-a′. As shown in FIG. 8, in the non-aqueous electrolyte battery 51, the separator 63 and each of the cathodes 61 are arranged with electrolyte 66 in between, where also the separator 63 and each of the anodes 62 are arranged with electrolyte 66 in between. The separator 63 and the cathodes 61 may be adhered to each other via electrolyte 66, where also the separator 63 and the anodes 62 may be adhered to each other via electrolyte 66.

From the laminated electrode body 60, cathode tabs 61C extending respectively from a plurality of cathodes 61 and anode tabs 62C extending respectively from a plurality of anodes 62 are lead out. Multiple stacked cathode tabs 61C are configured by being bent such that a bent portion thereof, with appropriate sag, has a substantially U-shaped cross-section. At a tip end of the multiple stacked cathode tabs 61C, the cathode lead 53 is connected thereto by means of ultrasonic welding, resistance welding or the like.

Also, substantially in the same manner as that in the cathode 61, anode tabs 62C, after multiple stacked, are configured by being bent in such a way that a bent portion thereof, with appropriate sag, has a substantially U-shaped cross-section. At a tip end of the multiple stacked anode tabs 62C, the anode lead 54 is connected thereto by means of ultrasonic welding, resistance welding or the like.

[Cathode Lead]

In the cathode lead 53 connecting with the cathode tabs 61C, for example, a metallic lead body made of material such as aluminum (Al) may be used. In the non-aqueous electrolyte battery 51 of the embodiment of the present application, in order to produce large current, the cathode lead 53 is configured to have relatively large width and thickness, as compared with those in usual manner.

The thickness of the cathode lead 53 desirably is 150 μm or more and 250 μm or less. If the thickness of the cathode lead 53 is less than 150 μm, the possible current production may be small. If the thickness of the cathode lead 53 is exceeding 250 μm, as it is excessively thick, the laminated film 52 may decrease its sealing performance of the side from which the electrode lead is led out, and that may easily cause the invasion of water.

A part of the cathode lead 53 is provided with a sealant 55 as adhesive film which serves to enhance adhesion between the laminated film 52 and the cathode lead 53. The sealant 55 is configured to include resin material having high adhesiveness to metallic material. For example, when the cathode lead 53 includes the metallic material described above, the sealant 55 desirably includes polyolefin resins such as polyethylene, polypropylene, modified polyethylene and modified polypropylene.

The thickness of the sealant 55 desirably is 70 μm or more and 130 μm or less. If it is less than 70 μm, the adhesion between the laminated film 52 and the cathode lead 53 may be weakened. If it is exceeding 130 μm, there may be a large flow of molten resin at the time of fusing, which may not be desirable in manufacturing procedures.

[Anode Lead]

In the anode lead 54 connecting with the anode tabs 62C, for example, a metallic lead body made of material such as nickel (Ni) may be used. In the non-aqueous electrolyte battery 51 of the embodiment of the present application, in order to produce large current, the anode lead 54 is configured to have relatively large width and thickness, as compared with those in usual manner. The thickness of the anode lead 54 desirably is approximately the same as that of the after-mentioned anode tab 62C.

While the width of the anode lead 54 may be arbitrarily-specified, since it makes possible the production of large current, the width wb of the anode lead 54 is desirably 50% or more and 100% or less of the width Wb of the anode 62.

Similarly as in the cathode lead 53, the thickness of the anode lead 54 desirably is 150 nm or more and 250 nm or less. If the thickness of the anode lead 54 is less than 150 nm, the possible current production may be small. If the thickness of the anode lead 54 is exceeding 250 nm, as it is excessively thick, the laminated film 52 may decrease its sealing performance of the side from which the electrode lead is led out, and that may easily cause the invasion of water.

Similarly as in the cathode lead 53, a part of the anode lead 54 is provided with a sealant 55 as adhesive film which serves to enhance adhesion between the laminated film 52 and the anode lead 54.

[Cathode]

As shown in FIGS. 6A and 6B, the cathode 61 is configured to have a cathode active material layer 61B containing cathode active material, formed on both surfaces of a cathode current collector 61A. As the cathode current collector 61A, for example, metallic foil such as aluminum (Al) foil, nickel (Ni) foil and stainless steel (SUS) foil may be used.

Each cathode tab 61C extends integrally from the cathode current collector 61A. The multiple stacked cathode tabs 61C are bent such that their cross-section is substantially U-shaped. The tip end of the multiple stacked cathode tabs 61C is connected to the cathode lead 53 by means of ultrasonic welding, resistance welding or the like.

The cathode active material layer 61B is formed on the rectangular-shaped main surface part of the cathode current collector 61A. An extending part, which is an exposed state of the cathode current collector 61A, serves as the cathode tab 61C to connect the cathode lead 53 thereto. The width of the cathode tab 61C can be arbitrarily-specified. In particular, however, when the cathode lead 53 and the anode lead 54 are both led out from the same side, the width of the cathode tab 61C should be less than 50% of the width of the cathode 61. Such a cathode 61 can be obtained by forming the cathode active material layer 61B on one side of the rectangular-shaped cathode current collector 61A, providing it with an exposed part of the cathode current collector, then cutting out unwanted parts.

The configuration of the cathode active material layer 61B is substantially the same as the cathode active material layer 21B of the first embodiment. That is, the cathode active material layer 61B includes, as cathode active material, one or more kinds of cathode materials capable of intercalating and deintercalating lithium, and other material such as binding agent and conducting agent may also be included if necessary. The cathode material, the binding agent and the conducting agent are substantially the same as those in the first embodiment.

[Anode]

As shown in FIGS. 6C and 6D, the anode 62 is configured to have an anode active material layer 62B containing anode active material, formed on both surfaces of an anode current collector 62A. The anode current collector 62A may include, for example, metallic foil such as copper (Cu) foil, nickel (Ni) foil and stainless steel (SUS) foil.

Each anode tab 62C extends integrally from the anode current collector 62A. The multiple stacked anode tabs 62C are bent such that their cross-section is substantially U-shaped. The tip end of the multiple stacked anode tabs 62C is connected to the anode lead 54 by means of ultrasonic welding, resistance welding or the like.

The anode active material layer 62B is formed on the rectangular-shaped main surface part of the anode current collector 62A. An extending part, which is an exposed state of the anode current collector 62A, serves as the anode tab 62C to connect the anode lead 54 thereto. The width of the anode tab 62C can be arbitrarily-specified. In particular, however, when the cathode lead 53 and the anode lead 54 are both led out from the same side, the width of the anode tab 62C should be less than 50% of the width of the anode 62. Such an anode 62 can be obtained by forming the anode active material layer 62B on one side of the rectangular-shaped anode current collector 62A, providing it with an exposed part of the anode current collector, then cutting out unwanted parts.

[Anode Active Material Layer]

The configuration of the anode active material layer 62B is substantially the same as the anode active material layer 22B of the first embodiment. That is, the anode active material layer 62B includes, as anode active material, one or more kinds of anode materials capable of intercalating and deintercalating lithium, and other material such as binding agent and conducting agent may also be included if necessary. The anode material, the binding agent and the conducting agent are substantially the same as those in the first embodiment.

The electrolyte 66, the separator 63 and the laminated film 52 are substantially the same as the electrolyte 36, the separator 35 and the exterior member 40, in the second embodiment.

The laminated electrode body 60 is encased in the above-mentioned laminated film 52. At this time, the cathode lead 53 connected to the cathode tabs 61C and the anode lead 54 connected to the anode tabs 62C are led out respectively from the parts where portions of the laminated film 52 are sealed together, towards the outside of the battery. As shown in FIG. 5B, a laminated electrode body storage unit 57, formed in advance by deep drawing, is provided in the laminated film 52. The laminated electrode body 60 is housed in the laminated electrode body storage unit 57.

In an embodiment of the present application, in heating a peripheral portion of the laminated electrode body 60 by a heater head, thermal fusion is made to seal between the portions of the laminated film 52 covering the laminated electrode body 60 from its both sides. In particular, at the side from which the electrode lead is led out, the laminated film 52 is desirably fused by a heater head provided with a cutout shape to round away from the cathode lead 53 and the anode lead 54. This is because it will be possible to fabricate a battery in such a manner that can reduce the load on the cathode lead 53 and the anode lead 54. With this method, possible electric short-circuit in manufacture of battery can be prevented.

[Manufacturing Method of Battery]

The above-mentioned non-aqueous electrolyte battery 51 is, for example, fabricated by the following process.

[Fabrication of Cathode]

A cathode active material, a binding agent and a conducting agent are mixed to be prepared in a cathode mixture, which is then dispersed in a solvent such as N-methyl-2-pyrrolidone to provide cathode mixture slurry. Subsequently, the cathode mixture slurry is coated on both surfaces of the belt-shaped cathode current collector 61A, then dried, and then subjected to compression molding by a roll press or the like, thereby forming the cathode active material layer 61B, to provide a cathode sheet. This cathode sheet is cut to a predetermined size, thereby fabricating the cathode 61. At this time, the cathode active material layer 61B is formed such that the cathode current collector 61A has a part exposed. The exposed part of the cathode current collector 61A may be defined as the cathode tab 61C. In addition, unwanted parts may be cut out from the exposed part of the cathode current collector, if necessary, to form the cathode tab 61C. Thus, the cathode 61 in which the cathode tab 61C is integrated can be obtained.

[Fabrication of Anode]

An anode material and a binding agent are mixed to be prepared in an anode mixture, which is then dispersed in a solvent such as N-methyl-2-pyrrolidone to provide anode mixture slurry. Subsequently, the anode mixture slurry is coated on both surfaces of the anode current collector 62A, then dried, and then subjected to compression molding by a roll press or the like, thereby forming the anode active material layer 62B, to provide an anode sheet. This anode sheet is cut to a predetermined size, thereby fabricating the anode 62. At this time, the anode active material layer 62B is formed such that the anode current collector 62A has a part exposed. The exposed part of the anode current collector 62A may be defined as the anode tab 62C. In addition, unwanted parts may be cut out from the exposed part of the anode current collector, if necessary, to form the anode tab 62C. Thus, the anode 62 in which the anode tab 62C is integrated can be obtained.

[Formation of Electrolyte 66]

A polymer compound is coated on one main surface or both surfaces of the separator 63. Examples of the polymer compound which is coated on this separator 63 include polymers that contain vinylidene fluoride, namely a homopolymer, a copolymer or a multi-component copolymer, or the like. Specifically, such examples include polyvinylidene fluoride, a binary copolymer that contains vinylidene fluoride and hexafluoropropylene, and a ternary copolymer that contains vinylidene fluoride, hexafluoropropylene and chlorotrifluoroethylene, and the like. The polymer compound, containing any of the polymers that contain vinylidene fluoride described above, may further contain one or more kinds of other polymer compounds.

The polymer compound coated on the separator 63 holds the electrolyte solution substantially the same as that in the first embodiment, thereby forming the electrolyte 66.

The polymer compound on the separator 63 may be, for example, forming a porous polymer compound in the following manner. That is, first, a solution in which the polymer compound is dissolved in a first solvent having polar organic solvent such as N-methyl-2-pyrrolidone, γ-butyrolactone, N,N-dimethyl acetamide and N,N-dimethyl sulfoxide is prepared and coated on the separator 63. Next, the separator 63, coated with the solution described above, is immersed in a second solvent, such as water, ethyl alcohol and propyl alcohol which has a mutual solubility to the above-mentioned polar organic solvent and is a poor solvent for the above-mentioned polymer compound. At this time, solvent exchange takes place, and phase separation accompanied by spinodal decomposition arises, thereby making the polymer compound form a porous structure. After this, by drying, the porous polymer compound having porous structure can be obtained.

[Laminating Process]

As shown in FIGS. 7A and 7B, the cathodes 61 and the anodes 62 are alternately inserted between the separator 63 in zig-zag folded form, such that a predetermined number of cathodes 61 and anodes 62 are laminated, for example, in the order of the separator 63, the anode 62, the separator 63, the cathode 61, the separator 63, the anode 62, . . . , the separator 63, the anode 62, the separator 63. Then, they are fixed under pressure so as to closely adhere the cathodes 61, the anodes 62 and the separator 63, thereby fabricating the laminated electrode body 60. For solidly fixing the laminated electrode body 60, for example, a fixing member 56 such as an adhesive tape can be used. When the fixing member 56 is used for fixing, for example, the fixing member 56 is provided on both side parts of the laminated electrode body 60.

Next, multiple cathode tabs 61C and multiple anode tabs 62C are bent so as to have cross-section of U-shape. For example, the electrode tabs are bent in the following manner.

[First U-Shape Bending Process of Tabs]

The multiple cathode tabs 61C drawn out from the laminated cathodes 61 and the multiple anode tabs 62C drawn out from the laminated anodes 62 are bent so as to have cross-section of substantially U-shape. First U-shape bending process is to provide the cathode tabs 61C and the anode tabs 62C with an optimal U-shaped bend in advance. By providing an optimal U-shaped bend in advance, it makes possible to reduce stress such as tensile stress within the cathode tabs 61C and the anode tabs 62C, in the subsequent process of bending to form bent portion in the cathode tabs 61C and the anode tabs 62C after connecting respectively to the cathode lead 53 and the anode lead 54.

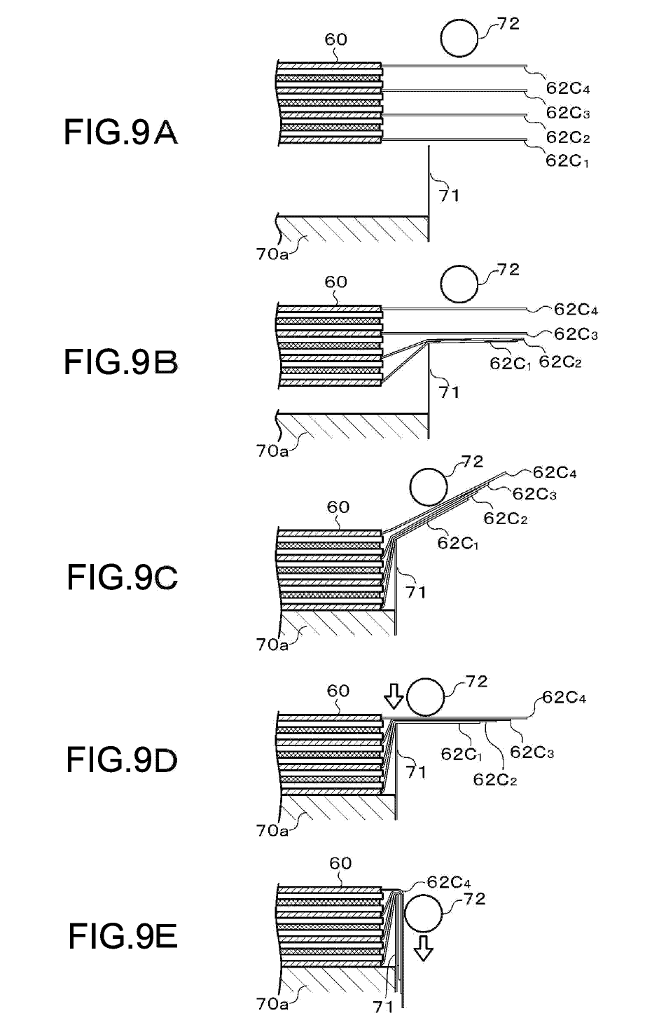

FIGS. 9A to 9E are side views illustrating a first U-shape bending process of the anode tabs 62C. In FIGS. 9A to 9E, each process performed with respect to the anode tab will be described. The first U-shape bending process is performed with respect to the cathode current collector 61A in a similar way.

First, as shown in FIG. 9A, a laminated electrode body is placed over a work setting stand 70a having a U-shape bending thin plate 71. The U-shape bending thin plate 71 is provided to protrude from the work setting stand 70a so that a protruding height is slightly smaller than the thickness of the laminated electrode body 60, specifically, at least made smaller than the total thickness of a plurality of the anode tabs 62C₁ to 62C₃. With this configuration, a bending peripheral side of the anode tab 62C₄ is positioned in a range of the thickness of the laminated electrode body 60, such that it is possible to prevent increase in thickness of the non-aqueous electrolyte battery 51 or occurrence of external appearance defects.

Subsequently, as shown in FIG. 9B, the laminated electrode body 60 is brought down, or, the work setting stand 70a is lifted up. At this time, the smaller a gap between the laminated electrode body 60 and the U-shape bending thin plate 71 is, the greater a space efficiency of the non-aqueous electrolyte battery 51 increases, so for example, a distance between the laminated electrode body 60 and the U-shape bending thin plate 71 is made to be gradually smaller.

As shown in FIG. 9C, the laminated electrode body 60 is loaded on the work setting stand 70a, a bent portion of the anode tab 62C is formed, and then as shown in FIGS. 9D and 9E, a roller 72 moves down and the anode tabs 62C are bent to have a U-shaped form.

The U-shape bending thin plate 71 has a thickness of 1 mm or less, for example desirably approximately 0.5 mm. As the U-shape bending thin plate 71, material having a strength necessary for forming a bent shape in the plurality of the cathode tabs 61C or the anode tabs 62C, even when in small thickness as described above, can be used. The necessary strength for the U-shape bending thin plate 71 varies depending on factors such as the number of laminated sheets of the cathode 61 and the anode 62, hardness of the material used for the cathode tab 61C and anode tab 62C. The thinner the U-shape bending thin plate 71 is, the smaller a curvature of the anode tab 62C₁ of the bending innermost periphery can be, which is desirable in that it can reduce the necessary space for the bending of the anode tabs 62C. Examples of the U-shape bending thin plate 71 which can be used include stainless steel (SUS), reinforced plastic materials, and plated steel materials, and the like.

[Cutting Process of Exposed Part of Current Collectors]

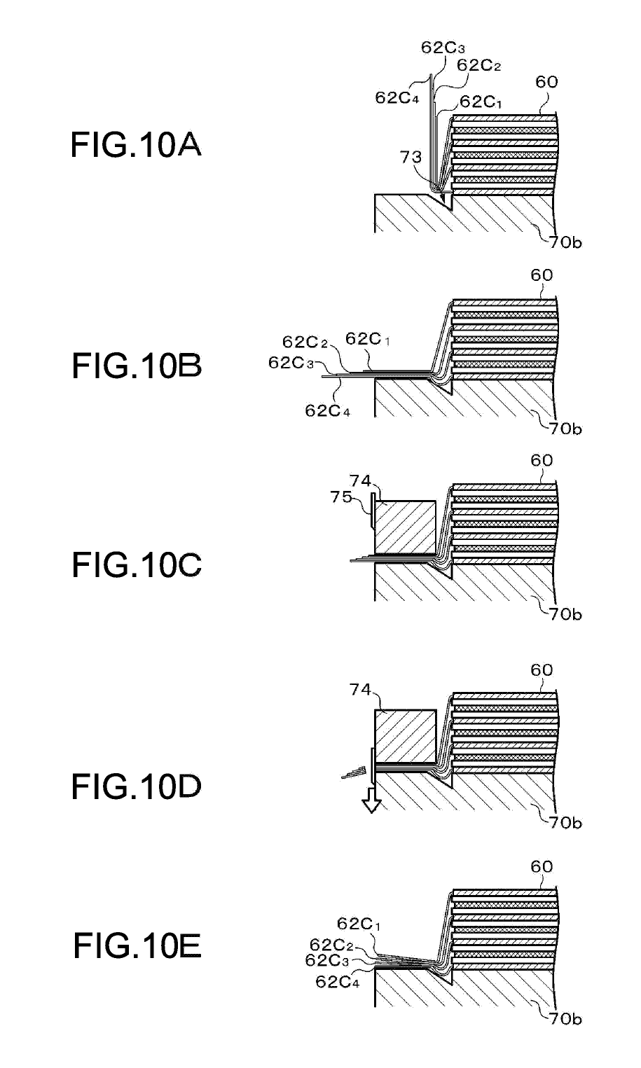

Next, the tip end of the anode tabs 62C which has formed a U-shaped bent portion is cut almost evenly. In a cutting process of exposed part of current collectors, the U-shaped bent portion in its optimal shape is formed in advance, and then a surplus of the cathode tabs 61C and the anode tabs 62C are cut in conformity to the U-shaped bent shape. FIGS. 10A to 10E are side views illustrating a cutting process of the anode tabs 62C. The cutting process of exposed part of current collectors is performed with respect to the cathode tabs 61C in a similar way.

As shown in FIG. 10A, the top surface and the bottom surface of the laminated electrode body 60 in which the U-shaped bent portion is formed in the first U-shape bending process are inverted, and the laminated electrode body 60 is secured to a work setting stand 70b provided with a recess 73 for current collector sagging.

Next, as shown in FIG. 10B, a front end portion, ranging from the U-shaped bent portion to the tip end, of the anode tabs 62C₁ to 62C₄ which has formed the U-shaped bent portion along is deformed in such a manner that the front end portion has a substantially L-shape in conformity to the work setting stand 70b. At this time, a shape necessary for re-forming the U-shaped bent portion is maintained, thereby a sagging made as large as the bending peripheral side of the anode tab 62C₄ is provided. With such a sagging escaping into the recess 73 for current collector sagging, thereby the anode tabs 62C₁ to 62C₄ may be deformed without stress. In addition, the anode tabs 62C₁ to 62C₄ may also be deformed with their front end portions being fixed.

Subsequently, as shown in FIG. 10C, the anode tabs 62C₁ to 62C₃ are pressed against the work setting stand 70b using a current collector presser 74, and as shown in FIGS. 10D and 10E, for example, the tip end of each of the anode tabs 62C₁ to 62C₄ is cut using a cutting knife 75 provided in conformity to the current collector presser 74 and is made to be even. A cutting place of the anode tabs 62C₁ to 62C₄ is determined such that the front end of the anode tabs 62C₁ to 62C₄ can be positioned within a thickness range of the laminated electrode body 60 when the U-shape bending is performed again in the subsequent process. Therefore, at least the surplus portion of the front end of the anode tabs 62C₁ to 62C₄ is to be cut.

[Connecting Process of Electrode Lead]

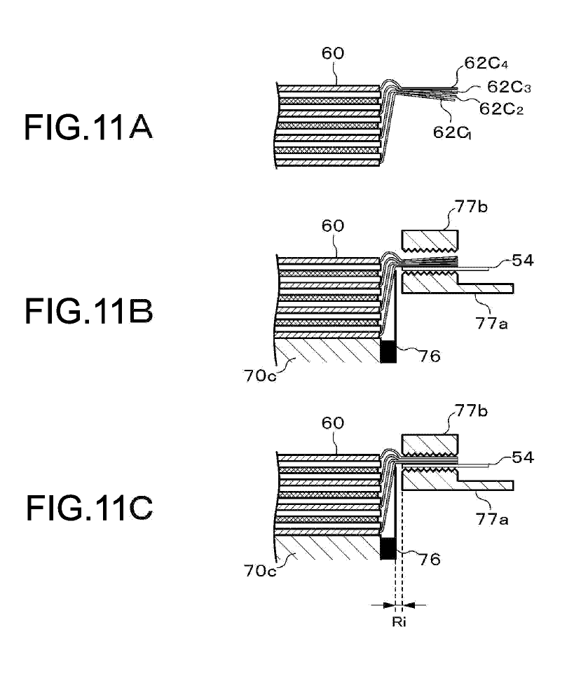

Subsequently, the anode tabs 62C₁ to 62C₄ are connected with the anode lead 54. In the process of connecting tabs, while maintaining the optimal U-shaped bend formed in the first U-shape bending process, the cathode tabs 61C and the anode tabs 62C are fixed respectively to the cathode lead 53 and the anode lead 54. Thus, the cathode tabs 61C and the cathode lead 53, and the anode tabs 62C and the anode lead 54 are electrically connected, respectively. FIGS. 11A to 11C are side views illustrating a process of connecting the anode lead 54 and the anode tabs 62C₁ to 62C₄. In addition, although not shown in the drawing, a sealant 55 is provided on the anode lead 54, in advance. The connecting process is performed with respect to the cathode tabs 61C and the cathode lead 53 in a similar way.

As shown in FIG. 11A, the top surface and the bottom surface of the laminated electrode body 60 in which the surplus portion of the anode tabs 62C₁ to 62C₄ is cut in the process of cutting electrode tip ends, are to be inverted again. Next, as shown in FIG. 11B, the laminated electrode body 60 is secured to a work setting stand 70c provided with a current collector shape maintaining plate 76. The front end of the current collector shape maintaining plate 76 is located at the bending inner periphery side of the anode tab 62C₁, such that the bent shape of the anode tabs 62C₁ to 62C₄ is maintained, and also able to prevent influence caused by external factors such as ultrasonic vibration generating from a fixing device, for example.

Subsequently, as shown in FIG. 11C, the anode tabs 62C₁ to 62C₄ and the anode lead 54 are fixed by, for example, an ultrasonic welding. In the ultrasonic welding, for example, an anvil 77a provided below the anode tabs 62C₁ to 62C₄ and a horn 77b provided above the anode tabs 62C₁ to 62C₄ are used. The anode tabs 62C₁ to 62C₄ are set in advance on the anvil 77a, then the horn 77b descends, and thereby the anode tabs 62C₁ to 62C₄ and the anode lead 54 are clamped between the anvil 77a and the horn 77b. Ultrasonic vibration is applied to the anode tabs 62C₁ to 62C₄ and the anode lead 54 by the anvil 77a and the horn 77b. In this manner, the anode tabs 62C₁ to 62C₄ and the anode lead 54 are fixed to each other. In addition, in the tab connection process, it may be desirable to connect the anode lead 54 to the anode tabs 62C in such a manner that an inner periphery side bending margin R1 is formed, as with reference to FIG. 11C. The thickness of the inner periphery side bending margin R1 is equal to or larger than the cathode lead 53 and the anode lead 54.

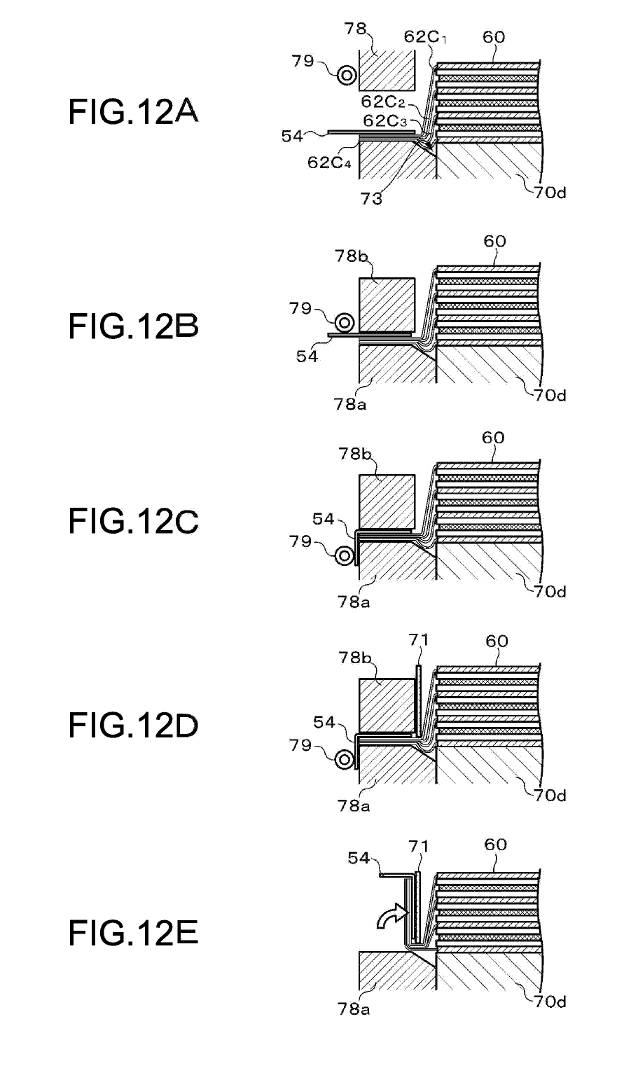

Next, the anode lead 54 that is fixed together with the anode tabs 62C₁ to 62C₄ is bent to have a predetermined shape. FIGS. 12A to 12E are side views illustrating a tab bending process to bend the electrode lead 54. The tab bending process and electrode lead connecting process is performed with respect to the cathode tabs 61C and the cathode lead 53 in a similar way.

As shown in FIG. 12A, the top surface and the bottom surface of the laminated electrode body 60 in which the anode tabs 62C₁ to 62C₄ and the anode lead 54 are fixed to each other in the connecting process are inverted again, and then the laminated electrode body 60 is secured to a work setting stand 70d having a recess 73 for current collector sagging. A connection portion between the anode tabs 62C₁ to 62C₄ and the anode lead 54 is placed on a tab bending stand 78a.

Subsequently, as shown in FIG. 12B, the connection portion between the anode tabs 62C₁ to 62C₄ and the anode lead 54 is pressed by a block 78b, and then as shown in FIG. 12C, a roller 79 moves down and the anode lead 54 protruded from the tab bending stand 78a and the block 78b is bent.

[Second U-Shape Bending Process of Tabs]

Subsequently, as shown in FIG. 12D, the U-shape bending thin plate 71 is provided to be interposed between the laminated electrode body 60 and the block 78b pressing the anode tabs 62C₁ to 62C₄. Subsequently, as shown in FIG. 12E, the anode tabs 62C₁ to 62C₄ are bent at an angle of approximately 90 degrees, in conformity to the U-shaped bend formed by the first U-shape bending process shown in FIGS. 9A to 9E, so as to prepare the laminated electrode body 60. At this time, as mentioned above, the anode lead 54 is connected to the anode tabs 62C in such a manner that an inner periphery side bending margin R1 is formed as in FIG. 11C. Thus, in the second U-shape bending process, the anode tab 62C can be bent in a direction substantially perpendicular to electrode surface, while inhibiting the contact of the anode lead 54 with the laminated cathodes 61 and anodes 62.

At this time, it is desirable that the anode lead 54 be bent with the sealant 55 which is provided in advance by heat welding. In such a manner, the bent portion of the anode lead 54 would be covered by the sealant 55, thereby making it possible to obtain a structure in which the anode lead 54 and the laminated film 52 are not likely to be in direct contact. In this structure, the risks of scraping between the resin layer inside the laminated film 52 and the anode lead 54, damage to the laminated film 52, and short-circuit between the metal layer of the laminated film 52 and the anode lead 54 which are caused by long-term vibration, an impact, or the like, may be significantly decreased. In such a manner, the laminated electrode body 60 is prepared.

[Encasing Process]

After this, the prepared laminated electrode body 60 is encased by the laminated film 52. One of the side parts of the laminated film 52, the top part and the bottom part are fused by being heated with a heater head. The top part and the bottom part from which the cathode lead 53 and the anode lead 54 are led out is, for example, fused by a heater head having a cutout shape to round away from the cathode lead 53 and the anode lead 54.

Subsequently, from the other opening of the laminated film 52 which is not fused, an electrolyte solution substantially the same as that in the first embodiment is injected. Finally, by fusing the laminated film 52 at the side part where the injection was made, the laminated electrode body 60 is sealed in the laminated film 52. After this, from the outside of the laminated film 52, heat pressing is performed to make the laminated electrode body 60 be pressed and heated, and the electrolyte solution thus immerses the polymer compound, then the polymer compound be gelled to form the electrolyte 66 in which the polymer compound holding the electrolyte solution. In addition, if the polymer compound is a porous polymer compound, it may be swelled with the electrolyte solution of the electrolyte 66 at the time of heat pressing, the hole structure of the porous polymer compound is not likely to break, such that the holes thereof is maintained. Thus, the non-aqueous electrolyte battery is completed.

### 5. Fifth Embodiment

### Example of Battery Module

A fifth embodiment of the present application will be described. In the fifth embodiment, a battery unit using a non-aqueous battery described in embodiments above and a battery module in which the battery unit is assembled will be described. The description of the fifth embodiment will describe a case of using a non-aqueous electrolyte battery of the fourth embodiment, in which the cathode lead and the anode lead are led out from the different sides.

[Battery Unit]

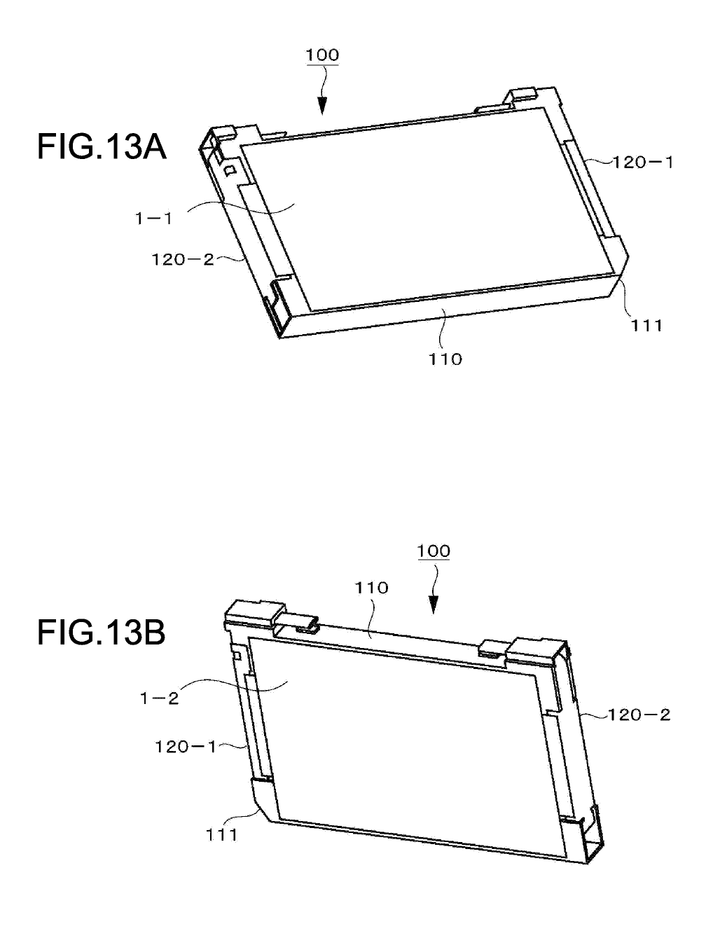

FIGS. 13A and 13B are perspective views showing a configuration of a battery unit using the non-aqueous electrolyte battery of an embodiment of the present application. FIGS. 13A and 13B show a battery unit 100 viewed from different directions. A side that is mainly shown in FIG. 13A is set as a front side of the battery unit 100, and a side that is mainly shown in FIG. 13B is set as a rear side of the battery unit 100. As shown in FIGS. 13A and 13B, the battery unit 100 includes non-aqueous electrolyte batteries 1-1 and 1-2, a bracket 110, and bus bars 120-1 and 120-2. The non-aqueous electrolyte batteries 1-1 and 1-2 are, for example, non-aqueous electrolyte batteries according to the fourth embodiment.

The bracket 110 is a support tool for securing strength of the non-aqueous electrolyte batteries 1-1 and 1-2. The non-aqueous electrolyte battery 1-1 is mounted at the front side of the bracket 110 and the non-aqueous electrolyte battery 1-2 is mounted at the rear side of the bracket 110. In addition, the bracket 110 has substantially the same shape seen from the front side and the rear side, but a chamfered portion 111 is formed at one corner portion of a lower side. A side where the chamfered portion 111 is seen to be located at a right-lower side is set as the front side, and a side where the chamfered portion 111 is seen to be located at a left-lower side is set as the rear side.

The bus bars 120-1 and 120-2 are metallic members in substantially L-shaped form, and are mounted on both side of the bracket 110, respectively, in such a manner that a connection portion connected to a tab of the non-aqueous electrolyte batteries 1-1 and 1-2 is disposed at a side surface side of the bracket 110, and a terminal connected to the outside of the battery unit 100 is disposed on a top surface of the bracket 110.

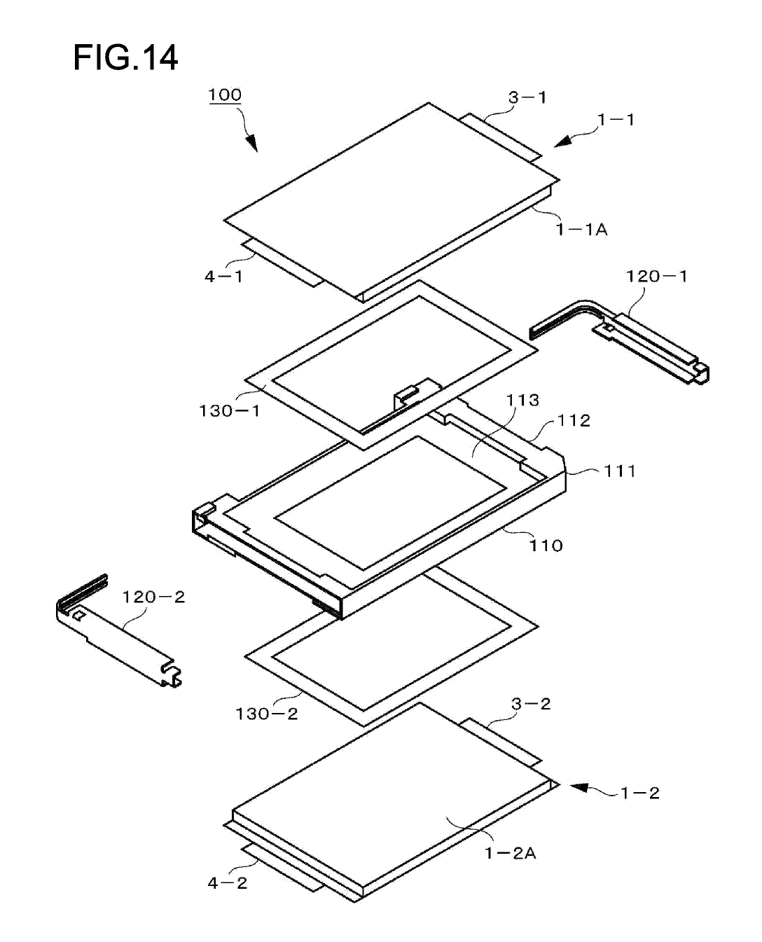

FIG. 14 shows an exploded perspective view illustrating the battery unit 100. An upper side of FIG. 14 is set as a front side of the battery unit 100, and a lower side of FIG. 14 is set as a rear side of the battery unit 100. Hereinafter, regarding the non-aqueous electrolyte battery 1-1, a raised portion in which a laminated electrode body is housed is referred to as a battery main body 1-1A. Similarly, in regard to the non-aqueous electrolyte battery 1-2, a raised portion in which a laminated electrode body is housed is referred to as a battery main body 1-2A.

The non-aqueous electrolyte batteries 1-1 and 1-2 are mounted in the bracket 110 in a state where the sides of the main bodies 1-1A and 1-2A having raised portions face each other. That is, the non-aqueous electrolyte battery 1-1 is mounted in the bracket 110 in such a manner that a surface which is provided with a cathode lead 3-1 and an anode lead 4-1 faces the front, and the non-aqueous electrolyte battery 1-2 is mounted in the bracket 110 in such a manner that a surface which is provided with cathode lead 3-2 and an anode lead 4-2 faces rearward.

The bracket 110 includes an outer peripheral wall 112 and a rib portion 113. The outer peripheral wall 112 is formed to be slightly broader than an outer periphery of the battery main bodies 1-1A and 1-2A of the non-aqueous electrolyte batteries 1-1 and 1-2, that is, to surround the battery main bodies 1-1A and 1-2A in a state where the non-aqueous electrolyte batteries 1-1 and 1-2 are mounted. The rib portion 113 is provided at an inner side surface of the outer peripheral wall 112 so as to extend from a center portion of the outer peripheral wall 112 in a thickness direction toward the inner side.

In a configuration example of FIG. 14, the non-aqueous electrolyte batteries 1-1 and 1-2 are inserted into the outer peripheral wall 112 from the front side and the rear side of the bracket 110, and are adhered to both surfaces of the rib portion 113 of the bracket 110 by double-sided adhesive tapes 130-1 and 130-2 having adhesiveness at both surfaces. The double-sided adhesive tapes 130-1 and 130-2 have a substantially square-shape having a predetermined width along an outer peripheral edge of the non-aqueous electrolyte batteries 1-1 and 1-2, and the rib portion 113 of the bracket 110 may be provided by an area where the double-sided adhesive tapes 130-1 and 130-2 are bonded.

In this way, the rib portion 113 is formed to extend from an inner side surface of the outer peripheral wall 112 toward the inner side by a predetermined width along the outer peripheral edge of the non-aqueous electrolyte batteries 1-1 and 1-2, and at an inner side in relation to the rib portion 113, an opening is formed. Therefore, between the non-aqueous electrolyte battery 1-1 that is adhered to the rib portion 113 by the double-sided tape 130-1 from the front side of the bracket 110, and the non-aqueous electrolyte battery 1-2 that is adhered to the rib portion 113 by the double-sided tape 130-2 from the rear side of the bracket 110, a clearance due to the opening is formed.

That is, with such an opening formed at the central portion of the bracket 110, the non-aqueous electrolyte batteries 1-1 and 1-2 are to be mounted in the bracket 110 with a clearance having a total dimension of a thickness of the rib portion 113 and a thickness of the double-sided adhesive tapes 130-1 and 130-2. For example, a swelling may occur in the non-aqueous electrolyte batteries 1-1 and 1-2 due to a charge and discharge, a generation of gas, or the like, but this clearance, which is formed by the opening, may serve as a space for allowing this swelling of the non-aqueous electrolyte batteries 1-1 and 1-2 to be housed. Therefore, it is possible to exclude an effect such as an increase in the total thickness of the battery unit 100, which is caused by the swelling of the non-aqueous electrolyte batteries 1-1 and 1-2.

In addition, when the non-aqueous electrolyte batteries 1-1 and 1-2 are bonded to the rib portion 113, in a case where a bonding area is broad, a significant pressure is necessary, but by restricting the bonding surface of the rib portion 113 to the outer peripheral edge, the bonding may be easily performed by an efficient application of pressure. Therefore, it is possible to decrease stress applied to the non-aqueous electrolyte batteries 1-1 and 1-2 while these are manufactured.

As shown in FIG. 14, by mounting two non-aqueous electrolyte batteries 1-1 and 1-2 in one bracket 110, it is possible to reduce the thickness and space of the bracket 110 compared to a case where one non-aqueous electrolyte battery is mounted in one bracket. Therefore, it is possible to increase an energy density.

In addition, the rigidity of the battery unit 100 in a thickness direction can be obtained by a synergistic effect obtained when two sheets of non-aqueous electrolyte batteries 1-1 and 1-2 are adhered, such that it is possible to make the rib portion 113 of the bracket 110 thin. That is, for example, even though the thickness of the rib portion 113 is set to 1 mm or less (a thickness around the limit of resin molding), when the non-aqueous electrolyte batteries 1-1 and 1-2 are adhered to each other from both sides of the rib portion 113, it is possible to obtain an overall sufficient rigidity of the battery unit 100. In addition, when the thickness of the rib portion 113 is made to be thin, the thickness of the battery unit 100 becomes thin and a volume is decreased, such that it is possible to improve an energy density of the battery unit 100.

In addition, to increase an external stress resistance, the battery unit 100 is configured in such a manner that an outer peripheral surface (both side surfaces and front and bottom surfaces) of the non-aqueous electrolyte batteries 1-1 and 1-2 does not come into contact with an inner peripheral surface of the outer peripheral wall 112 of the bracket 110, and the wide surface of the non-aqueous electrolyte batteries 1-1 and 1-2 is adhered to the rib portion 113.

According to this configuration, it is possible to realize a battery unit 100 that has a high energy density and is strong against an external stress.

[Battery Module]

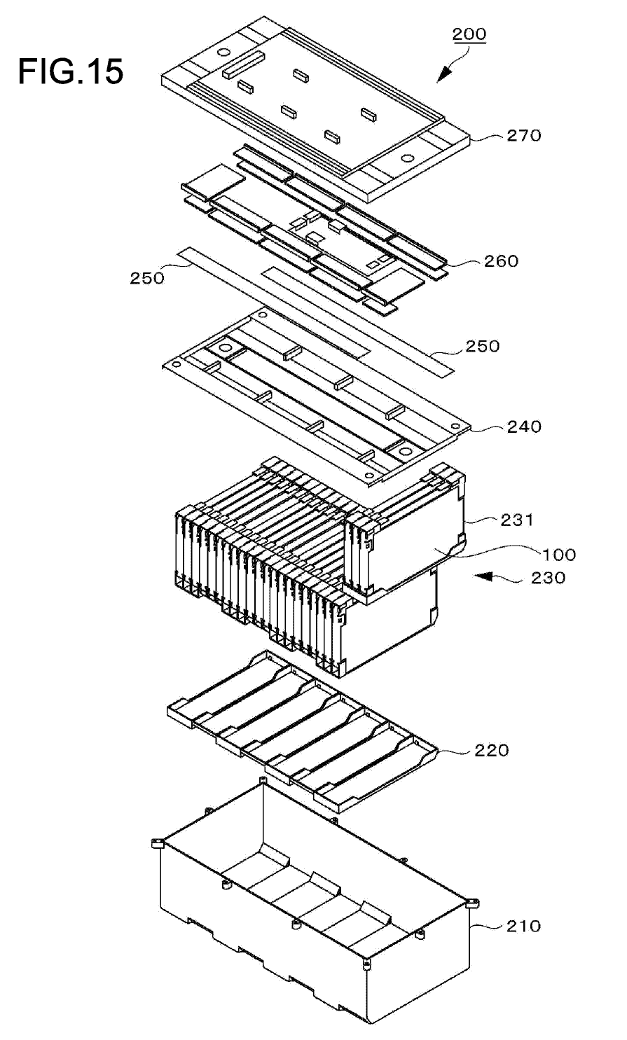

Next, a configuration example of the battery module 200 in which the battery unit 100 is assembled will be described with reference to FIGS. 15 to 18.

FIG. 15 is an exploded perspective view showing a configuration example of a battery module. As shown in FIG. 15, the battery module 200 includes a module case 210, a rubber seat portion 220, a battery portion 230, a battery cover 240, a fixing sheet portion 250, an electric part portion 260, and a box cover 270.

The module case 210 is a case that houses the battery unit 100 and mounts it in an apparatus for use, and has a size capable of housing 24 battery units 100 in a configuration example shown in FIG. 15.

The rubber seat portion 220 is a seat that is laid on the bottom surface of the battery unit 100 and relieves an impact. In the rubber seat portion 220, one sheet of a rubber seat is provided for three battery units 100, and eight sheets of rubber seats are provided to cope with 24 battery units 100.

In the configuration example shown in FIG. 15, the battery portion 230 includes 24 battery units 100 that are assembled. In addition, in the battery portion 230, three battery units 100 are connected in parallel with each other and thereby a parallel block 231 is configured, and eight parallel blocks 231 are connected in series.

The battery cover 240 is a cover that fixes the battery portion 230, and has an opening corresponding to the bus bar 120 of the non-aqueous electrolyte battery 1.

The fixing sheet portion 250 is a sheet that is disposed on the top surface of the battery cover 240, brought into closely contact with the battery cover 240 and the box cover 270 to make them fixed, when the box cover 270 is fixed to the module case 210.

The electric part portion 260 includes an electric part such as a charge and discharge circuit that controls a charge and discharge of the battery unit 100. The charge and discharge circuit is disposed at, for example, a space between the two parallel bus bars 120 in the battery portion 230.

The box cover 270 is a cover that closes the module case 210 after each portion is housed in the module case 210.

Here, in the battery module 200, the parallel blocks 231 including three battery units 100 connected in parallel are connected in series and thereby the battery portion 230 is configured. This series connection is performed using a metallic plate member included in the electric part portion 260. Therefore, in the battery portion 230, the parallel blocks 231 are disposed, respectively, in such a manner that a direction of a terminal for each block is made to be alternate for each parallel block 231, that is, a positive terminal and a negative terminal of adjacent parallel blocks 231 are aligned to each other. Therefore, in the battery module 200, it is necessary to avoid a circumstance where homopolar terminals in adjacent parallel blocks 231 be placed next to each other.

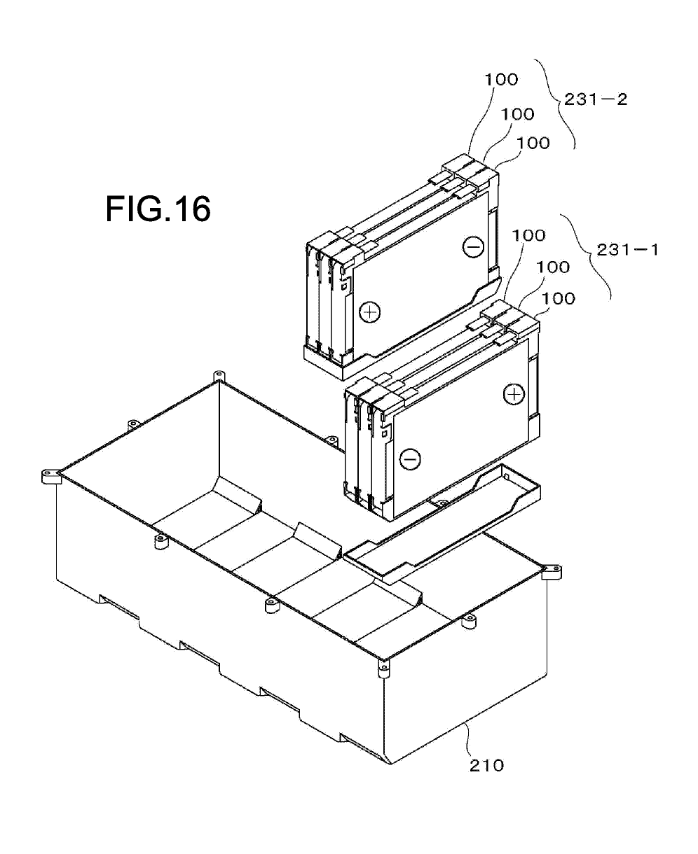

For example, as shown in FIG. 16, a parallel block 231-1 including three battery units 100 and a parallel block 231-2 including three battery units 100 are housed in the module case 210 with a displacement where a positive terminal and a negative terminal are adjacent to each other. To regulate such a displacement, a chamfered portion 111 formed at one corner portion of a lower side of the bracket 110 of the battery unit 100 is used.

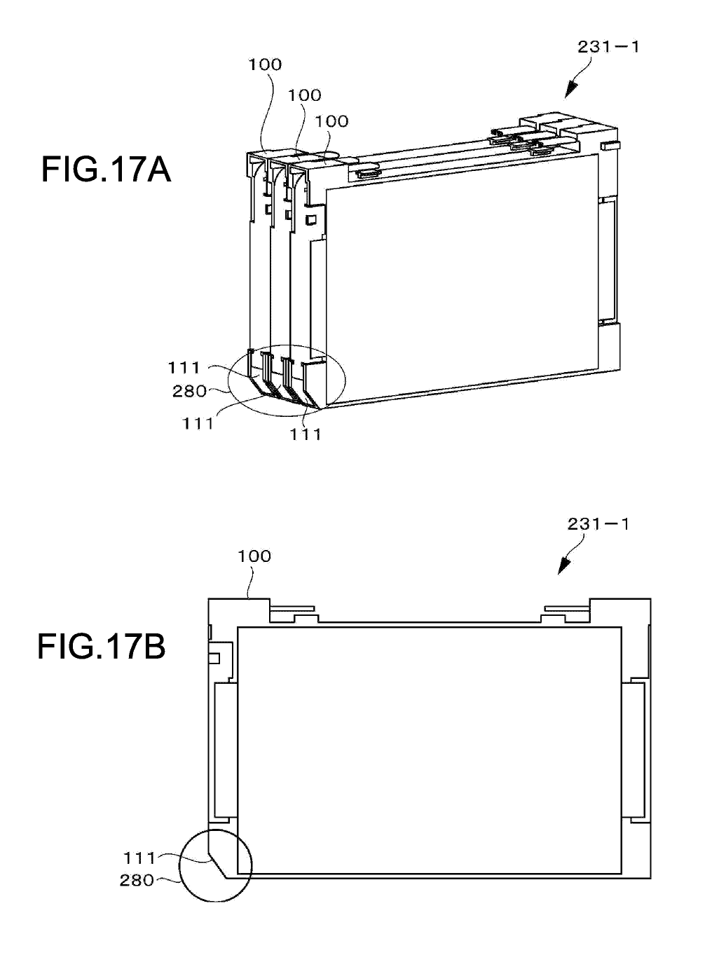

FIG. 17A is a perspective view showing a configuration example of a parallel block. FIG. 17B is a cross-sectional view showing a configuration example of the parallel block. As shown in FIGS. 17A and 17B, in the parallel block 231-1, the battery units 100 are assembled in such a manner that respective chamfered portions 111 face the same direction, forming a chamfered region 280. In addition, although not shown in the drawing, the parallel block 231-2 is configured in a way similar to the parallel block 231-1.

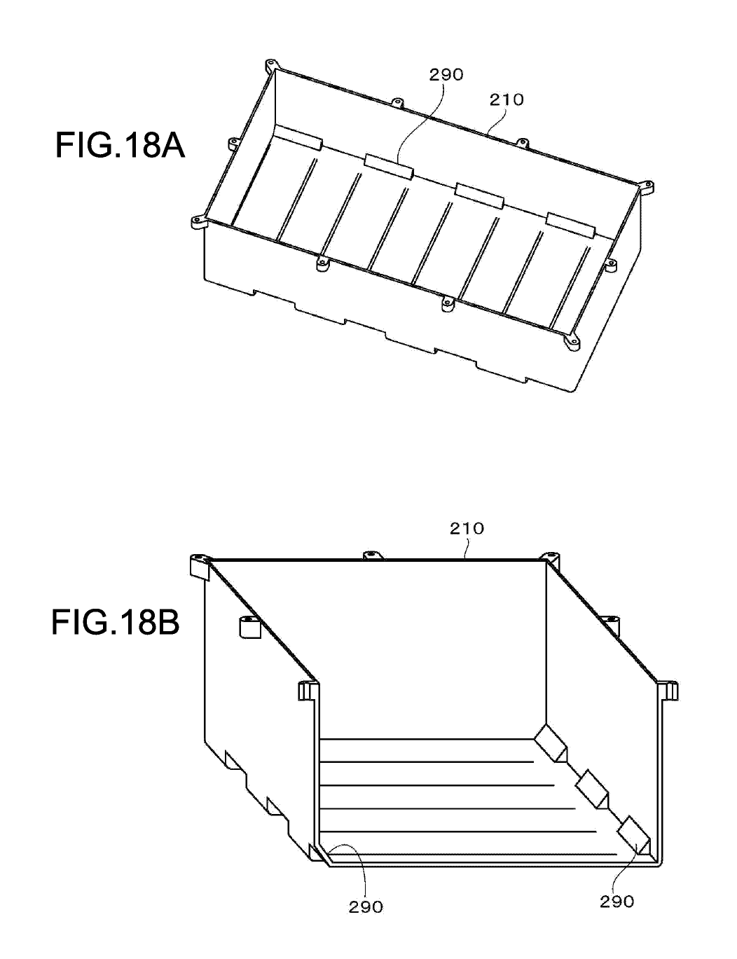

FIGS. 18A and 18B shows a configuration example of a module case. As shown in FIGS. 18A and 18B, the module case 210 has inclined portions 290 corresponding to an inclination of the chamfered region 280. These inclined portions 290, each of which has a length corresponding to a total thickness of three non-aqueous electrolyte batteries, are alternately disposed. With the chamfered region 280 of the parallel block 231-1 and the inclined portions 290 of the module case 210, if the parallel block 231-1 is to be housed in the module case 210 in a wrong direction, a lower side corner of the parallel block 231-1 comes into contact with one of the inclined portions 290 of the module case 210. In this case, the parallel block 231-1 is in a state of floating from an inner bottom surface module case 210, such that the parallel block 231-1 is not completely housed in the module case 210. Also, with the chamfered region 280 of the parallel block 231-2 and the inclined portions 290 of the module case 210, if the parallel block 231-2 is to be housed in the module case 210 in a wrong direction, a lower side corner of the parallel block 231-2 comes into contact with one of the inclined portions 290 of the module case 210. In this case, the parallel block 231-2 is in a state of floating from an inner bottom surface module case 210, such that the parallel block 231-2 is not completely housed in the module case 210. Therefore, in the battery module 200, it is possible to avoid a circumstance where homopolar terminals in adjacent parallel blocks be placed next to each other.

Thus, as described in the above, the battery unit and the battery module using the non-aqueous electrolyte battery of an embodiment of the present application are configured.

### 6. Sixth Embodiment

### Example of Battery Pack

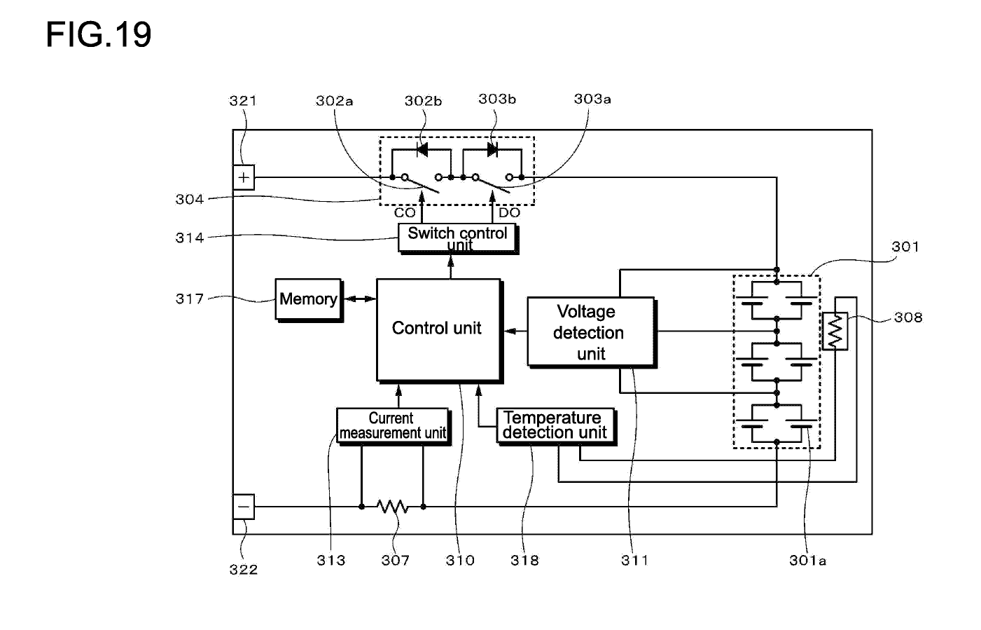

FIG. 19 is a block diagram showing a circuit configuration example of a case where a non-aqueous electrolyte battery (hereinafter, arbitrarily referred to as secondary battery) of an embodiment of the present application is applied to a battery pack. The battery pack includes an assembled battery 301, an exterior, a switch unit 304 having a charge control switch 302a and a discharge control switch 303a, a current sensing resistor 307, a temperature sensing device 308, and a control unit 310.

Further, the battery pack includes a positive terminal 321 and a negative terminal 322. In charging, the positive terminal 321 and the negative terminal 322 are connected to a positive terminal and a negative terminal of a charger, respectively, and the charging is carried out. On the other hand, when using an electronic apparatus, the positive terminal 321 and the negative terminal 322 are connected to a positive terminal and a negative terminal of the apparatus, respectively, and the discharge is carried out.

The assembled battery 301 is configured with a plurality of the secondary batteries 301a connected to one another in series and/or in parallel. The secondary battery 301a is a secondary battery of an embodiment of the present application. It should be noted that although there is shown in FIG. 19 a case where the six secondary batteries 301a are connected in two batteries in parallel and three in series (2P3S configuration) as an example, also others, such as n in parallel and m in series (where n and m are integers), and any way of connections may be adopted.

The switch unit 304 includes a charge control switch 302a and a diode 302b, and a discharge control switch 303a and a diode 303b and is controlled by a control unit 310. The diode 302b has the polarity in opposite direction with respect to charge current flowing from the positive terminal 321 to the assembled battery 301 and in forward direction with respect to discharge current flowing from the negative terminal 322 to the assembled battery 301. The diode 303b has the polarity in forward direction with respect to the charge current and in opposite direction with respect to the discharge current. It should be noted that although in this example the switch unit is provided on the positive terminal side, it may otherwise be provided on the negative terminal side.

The charge control switch 302a is configured to be turned off in the case where a battery voltage reaches an overcharge detection voltage, and it is controlled by the control unit 310 such that the charge current does not flow in a current path of the assembled battery 301. After the charge control switch 302a is turned off, only discharge can be performed via the diode 302b. Further, in the case where a large amount of current flows at a time of charge, the charge control switch 302a is turned off and is controlled by the control unit 310 such that the charge current flowing in the current path of the assembled battery 301 is shut off.

The discharge control switch 303a is configured to be turned off in the case where a battery voltage reaches an overdischarge detection voltage, and it is controlled by the control unit 310 such that the discharge current does not flow in a current path of the assembled battery 301. After the discharge control switch 303a is turned off, only charge can be performed via the diode 303b. Further, in the case where a large amount of current flows at a time of discharge, the discharge control switch 303a is turned off and is controlled by the control unit 310 such that the discharge current flowing in the current path of the assembled battery 301 is shut off.

A temperature sensing device 308 is a thermistor, for example, provided in the vicinity of the assembled battery 301. The temperature sensing device 308 is configured to measure a temperature of the assembled battery 301 and supply the measured temperature to the control unit 310. A voltage detection unit 311 is configured to measure voltages of the assembled battery 301 and each of the secondary batteries 301a included in the assembled battery 301, then A/D-convert the measured voltages, and supply them to the control unit 310. A current measurement unit 313 is configured to measure a current using a current detection resistor 307 and supply the measured current to the control unit 310.

The switch control unit 314 is configured to control the charge control switch 302a and the discharge control switch 303a of the switch unit 304 based on the voltage and the current that are input from the voltage detection unit 311 and the current measurement unit 313. The switch control unit 314 transmits a control signal of the switch unit 304 when a voltage of any one of secondary batteries 301a reaches the overcharge detection voltage or less or the overdischarge detection voltage or less, or, a large amount of current flows rapidly, to thereby prevent overcharge, overdischarge, and over-current charge and discharge.

Here, in the case where the secondary battery is a lithium-ion secondary battery, an overcharge detection voltage is defined to be 4.20 V±0.05 V, for example, and an overdischarge detection voltage is defined to be 2.4 V±0.1 V, for example.

For a charge and discharge control switch, a semiconductor switch such as a MOSFET (metal-oxide semiconductor field-effect transistor) can be used. In this case, parasitic diodes of the MOSFET function as the diodes 302b and 303b. In the case where p-channel FETs (field-effect transistors) are used as the charge and discharge control switch, the switch control unit 314 supplies a control signal DO and a control signal CO to a gate of the charge control switch 302a and that of the discharge control switch 303a, respectively. In the case where the charge control switch 302a and the discharge control switch 303a are of p-channel type, the charge control switch 302a and the discharge control switch 303a are turned on by a gate potential lower than a source potential by a predetermined value or more. In other words, in normal charge and discharge operations, the control signals CO and DO are determined to be a low level and the charge control switch 302a and the discharge control switch 303a are turned on.

Further, for example, when overcharged or overdischarged, the control signals CO and DO are determined to be a high level and the charge control switch 302a and the discharge control switch 303a are turned off.

A memory 317 includes a RAM (random access memory), a ROM (read only memory), an EPROM (erasable programmable read only memory) serving as a nonvolatile memory, or the like. In the memory 317, numerical values computed by the control unit 310, an internal resistance value of a battery in an initial state of each secondary battery 301a, which has been measured in a stage of a manufacturing process, and the like are stored in advance, and can be rewritten as appropriate. Further, when a full charge capacity of the secondary battery 301a is stored, for example, a remaining capacity can be calculated together with the control unit 310.

A temperature detection unit 318 is provided, to measure the temperature using the temperature sensing device 308 and control charging or discharging when abnormal heat generation has occurred, or perform correction in calculation of the remaining capacity.

### 7. Seventh Embodiment

The above-mentioned non-aqueous electrolyte battery and the battery pack using the same, the battery unit, and the battery module can be installed or be used in providing electricity to apparatus such as electronic apparatus, electric vehicle and electrical storage apparatus, for example.

Examples of electronic apparatus are laptops, PDA (Personal Digital Assistant), cellular phones, cordless telephone handset, video movies, digital still cameras, electronic books, electronic dictionaries, music players, radio, headphones, game machine, navigation system, memory cards, pacemakers, hearing aids, electric tools, electric shavers, refrigerator, air-conditioner, televisions, stereos, water heater, microwave oven, dishwasher, washing machine, dryer, lighting equipments, toys, medical equipments, robots, load conditioners, traffic lights, and the like.

Examples of electric vehicles are railway vehicles, golf carts, electric carts, electric motorcars (including hybrid motorcars), and the like. The above-mentioned embodiments would be used as their driving power source or auxiliary power source.

Examples of electrical storage apparatus include power sources for electrical storage to be used by power generation facilities or buildings such as houses.

Among examples of application mentioned in the above, a specific example of power storage system which has adopted a non-aqueous electrolyte battery in embodiments of the present application will be described below.

The power storage system may employ the following configurations, for example. A first power storage system is a power storage system having an electrical storage apparatus configured to be charged by a power generating device that generates electricity from renewable energy. A second power storage system has an electrical storage apparatus, and is configured to provide electricity to an electronic apparatus connected to the electrical storage apparatus. A third power storage system is a configuration of an electronic apparatus in such a way as to receive electricity supply from an electrical storage apparatus. These power storage systems are realized as a system in order to supply electricity efficiently in cooperation with an external power supply network.

Furthermore, a fourth power storage system is a configuration of an electric vehicle, including a converter configured to receive electricity supply from an electrical storage apparatus and convert the electricity into driving force for vehicle, and further including a controller configured to process information on vehicle control on the basis of information on the electrical storage apparatus. A fifth power storage system is an electricity system including an electricity information transmitting-receiving unit configured to transmit and receive signals via a network to and from other apparatuses, in order to control the charge and discharge of the above-mentioned electrical storage apparatus on the basis of information received by the transmitting-receiving unit. The sixth power storage system is an electricity system configured to receive electricity supply from the above-mentioned electrical storage apparatus or provide the electrical storage apparatus with electricity from at least one of a power generating device and a power network. The power storage system is described below.

[7-1. Power Storage System for Houses as Application Example]

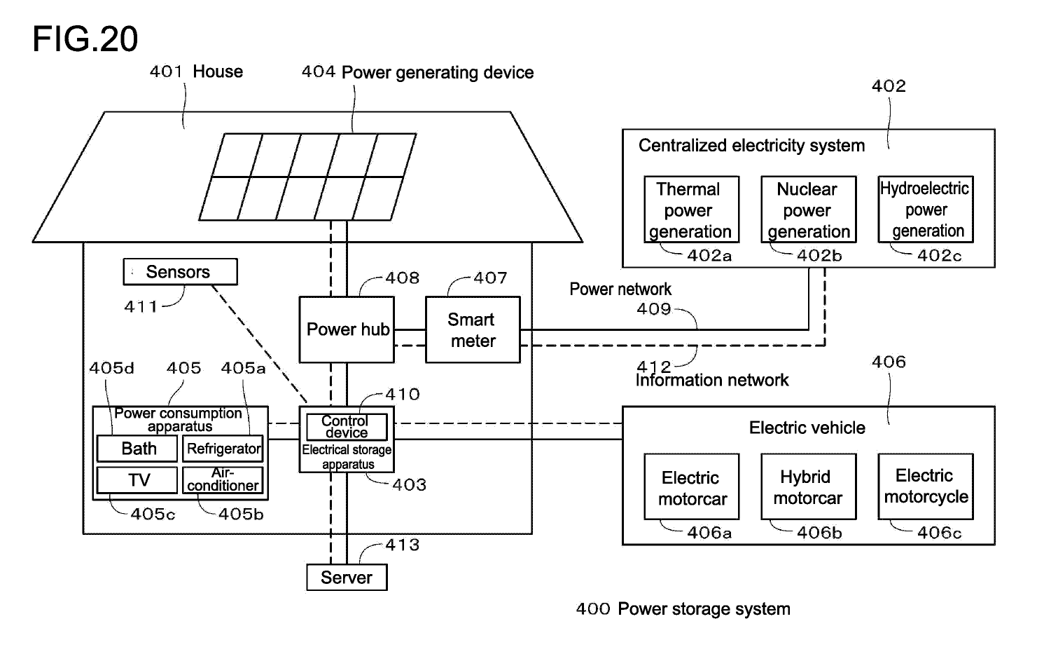

An example of a case where electrical storage apparatus using the non-aqueous electrolyte battery of an embodiment of the present application is applied to power storage system for houses will be described with reference to FIG. 20. For example, in power storage system 400 for a house 401, electricity is provided to an electrical storage apparatus 403 from a centralized electricity system 402 including thermal power generation 402a, nuclear power generation 402b, hydroelectric power generation 402c and the like via power network 409, information network 412, smart meter 407, power hub 408 and the like. Along with this, from independent power source such as in-house power generating device 404, electricity is also provided to the electrical storage apparatus 403. Therefore, electricity given to the electrical storage apparatus 403 is stored. By using the electrical storage apparatus 403, electricity to be used in the house 401 can be supplied. Not only for a house 401, but also with respect to other buildings, similar power storage system can be applied.

The house 401 is provided with the power generating device 404, a power consumption apparatus 405, an electrical storage apparatus 403, a control device 410 that controls each device or apparatus, a smart meter 407, and sensors 411 that obtain various kinds of information. The devices or apparatus are connected to one another through the power network 409 and the information network 412. For the power generating device 404, a solar battery, a fuel battery, or the like is used, and the generated electricity is supplied to the power consumption apparatus 405 and/or the electrical storage apparatus 403. Examples of the power consumption apparatus 405 include a refrigerator 405a, an air-conditioner 405b, a television receiver 405c, and a bath 405d. In addition, the power consumption apparatus 405 includes an electric vehicle 406. Examples of the electric vehicle 406 include an electric motorcar 406a, a hybrid motorcar 406b, and an electric motorcycle 406c.

The above-mentioned non-aqueous electrolyte battery of an embodiment of the present application is applied to the electrical storage apparatus 403. The non-aqueous electrolyte battery of an embodiment of the present application may be, for example, configured by a lithium-ion secondary battery. The smart meter 407 has functions of measuring the used amount of commercial electricity and transmitting the measured used amount to an electricity company. The power network 409 may be any one of DC power feeding, AC power feeding, and noncontact supply of electricity, or may be such that two or more of them are combined.

Examples of various sensors 411 include a human detection sensor, an illumination sensor, an object detection sensor, a power consumption sensor, a vibration sensor, a contact sensor, a temperature sensor and an infrared sensor. The information obtained by the various sensors 411 is transmitted to the control device 410. The state of the weather conditions, the state of a person, and the like are understood on the basis of the information from the sensors 411, and the power consumption apparatus 405 can be automatically controlled to minimize energy consumption. In addition, it is possible for the control device 410 to transmit information on the house 401 to an external electricity company and the like through the Internet.

Processing, such as branching of electricity lines and DC/AC conversion, is performed by using a power hub 408. Examples of a communication scheme for an information network 412 that is connected with the control device 410 include a method of using a communication interface, such as UART (Universal Asynchronous Receiver-Transceiver: transmission and reception circuit for asynchronous serial communication), and a method of using a sensor network based on a wireless communication standard, such as Bluetooth, ZigBee, and WiFi. The Bluetooth method can be applied to multimedia communication, so that one-to-many connection communication can be performed. ZigBee uses the physical layer of IEEE (Institute of Electrical and Electronics Engineers) 802.15.4. IEEE 802.15.4 is the title of the short-distance wireless network standard called personal area network (PAN) or wireless (W) PAN.

The control device 410 is connected to an external server 413. The server 413 may be managed by one of the house 401, an electricity company, and a service provider. The information that is transmitted and received by the server 413 is, for example, information on power consumption information, life pattern information, an electricity fee, weather information, natural disaster information, and electricity transaction. These pieces of information may be transmitted and received from a power consumption apparatus (for example, television receiver) inside a household. Alternatively, the pieces of information may be transmitted and received from an out-of-home device (for example, a mobile phone, etc.). These pieces of information may be displayed on a device having a display function, for example, a television receiver, a mobile phone, or a personal digital assistant (PDA).

The control device 410 that controls each unit includes central processing unit (CPU), a random access memory (RAM), a read only memory (ROM), and the like. In this example, the control device 410 is stored in the electrical storage apparatus 403. The control device 410 is connected to the electrical storage apparatus 403, the in-house power generating device 404, the power consumption apparatus 405, the various sensors 411, and the server 413 through the information network 412, and has functions of adjusting the use amount of the commercial electricity, and the amount of power generation. In addition, the control device 410 may have a function of performing electricity transaction in the electricity market.

As described above, not only the centralized electricity system 402 in which electricity comes from thermal power generation 402a, nuclear power generation 402b, hydroelectric power generation 402c, or the like, but also the generated electricity from the in-house power generating device 404 (solar power generation, wind power generation) can be stored in the electrical storage apparatus 403. Therefore, even if the generated electricity of the in-house power generating device 404 varies, it is possible to perform control such that the amount of electricity to be sent to the outside is made constant or electric discharge is performed by only a necessary amount. For example, usage is possible in which electricity obtained by the solar power generation is stored in the electrical storage apparatus 403, late night power whose fee is low during nighttime is stored in the electrical storage apparatus 403, and the electricity stored by the electrical storage apparatus 403 is discharged and used in a time zone in which the fee during daytime is high.

In this example, an example has been described in which the control device 410 is stored in the electrical storage apparatus 403. Alternatively, the control device 410 may be stored in the smart meter 407 or may be configured singly. In addition, the power storage system 400 may be used by targeting a plurality of households in a block of apartments or may be used by targeting a plurality of single-family detached houses.

[7-2. Power Storage System for Vehicles as Application Example]

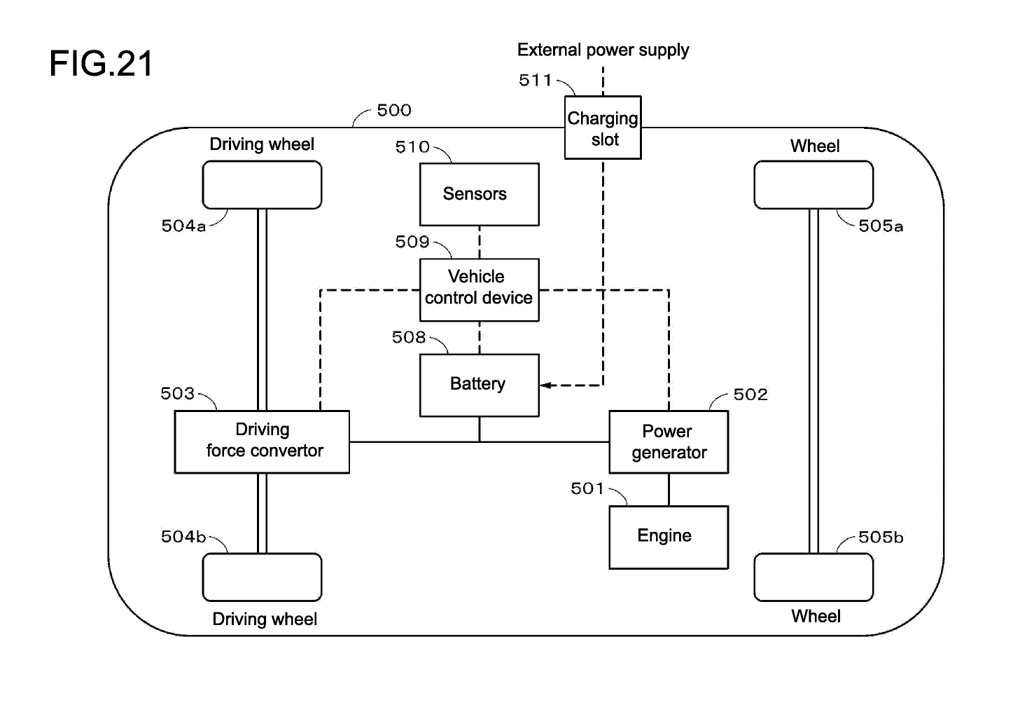

An example of a case where an embodiment of the present application is applied to a power storage system for vehicles will be described with reference to FIG. 21. FIG. 21 schematically shows an example of configuration of a hybrid vehicle employing series-hybrid system, in which an embodiment of the present application is applied. A series-hybrid system is a car that runs using electricity driving force converter by using electricity generated by a power generator that is driven by an engine or by using electricity that is temporarily stored in a battery.

A hybrid vehicle 500 is equipped with an engine 501, a power generator 502, an electricity driving force converter 503, a driving wheel 504a, a driving wheel 504b, a wheel 505a, a wheel 505b, a battery 508, a vehicle control device 509, various sensors 510, and a charging slot 511. The above-mentioned non-aqueous electrolyte battery of an embodiment of the present application is applied to the battery 508.

The hybrid vehicle 500 runs by using the electricity driving force converter 503 as a power source. An example of the electricity driving force converter 503 is a motor. The electricity driving force converter 503 operates using the electricity of the battery 508, and the rotational force of the electricity driving force converter 503 is transferred to the driving wheels 504a and 504b. By using direct current-alternating current (DC-AC) or inverse conversion (AC-DC conversion) at a necessary place, the electricity driving force converter 503 can use any of an AC motor and a DC motor. The various sensors 510 are configured to control the engine revolution speed through the vehicle control device 509 or control the opening (throttle opening) of a throttle valve, although not shown in the drawing. The various sensors 510 include a speed sensor, an acceleration sensor, an engine revolution speed sensor, and the like.

The rotational force of the engine 501 is transferred to the power generator 502, and the electricity generated by the power generator 502 by using the rotational force can be stored in the battery 508.

When a hybrid vehicle 500 decelerates by a braking mechanism, although not shown in the drawing, the resistance force at the time of the deceleration is added as a rotational force to the electricity driving force converter 503. The regenerative electricity generated by the electricity driving force converter 503 by using the rotational force can be stored in the battery 508.

The battery 508, as a result of being connected to an external power supply of the hybrid vehicle 500, receives supply of electricity by using a charging slot 511 as an input slot from the external power supply, and can store the received electricity.

Although not shown in the drawing, the embodiment of the present application may include an information processing device that performs information processing for vehicle control on the basis of information on a secondary battery. Examples of such information processing devices include an information processing device that performs display of the remaining amount of a battery on the basis of the information on the remaining amount of the battery.

In the foregoing, a description has been made referring to an example of a series-hybrid car that runs using a motor by using electricity generated by a power generator that is driven by an engine or by using electricity that had once been stored in a battery. However, the embodiment according to the present application can be effectively applied to a parallel hybrid car in which the outputs of both the engine and the motor are used as a driving source and in which switching between three methods, that is, running using only an engine, running using only a motor, and running using an engine and a motor, is performed as appropriate. In addition, the embodiment according to the present application can be effectively applied to a so-called motor-driven vehicle that runs by driving using only a driving motor without using an engine.

### EXAMPLES

Specific Examples of the embodiments of the present application will be described in detail, but it should not be construed that the present invention is limited only to these Examples.

Compounds A to V used in Examples and Comparative Examples are shown below:

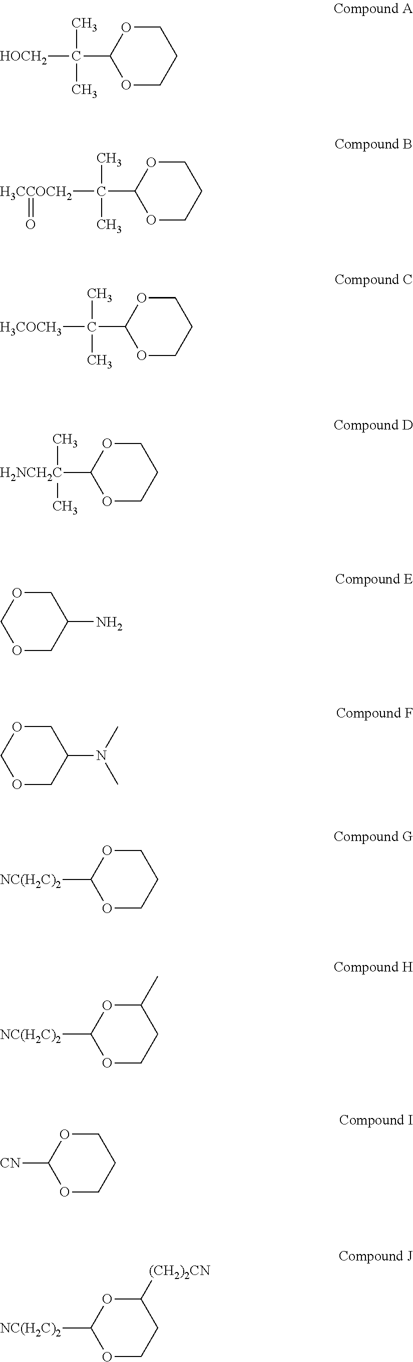

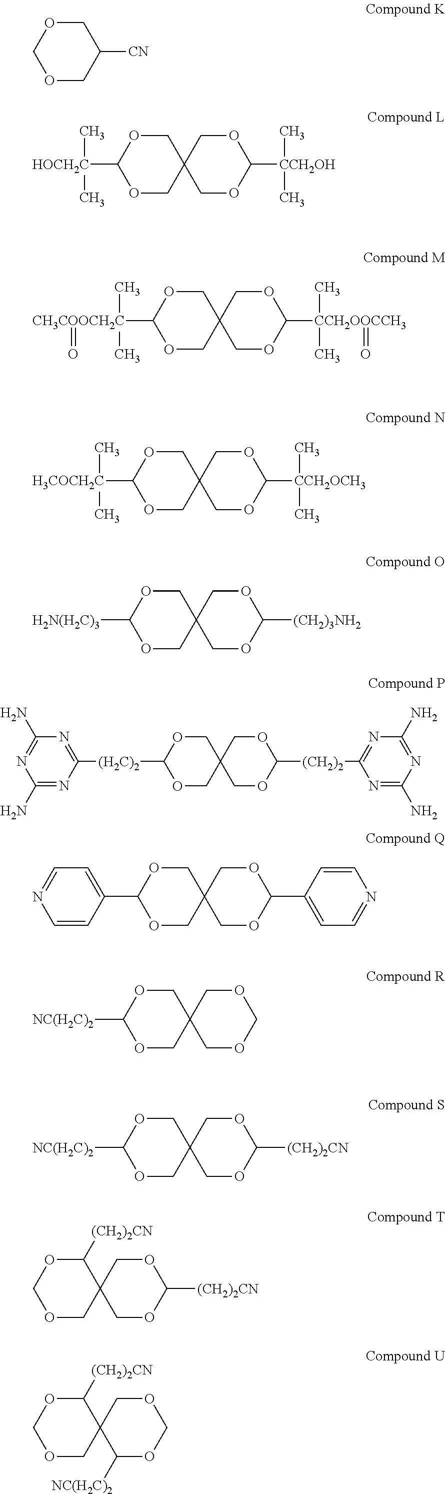

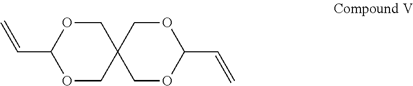

Here, some compounds will be denoted by the following abbreviations: VC for vinylene carbonate; FEC for 4-fluoro-1,3-dioxolan-2-one; SN for succinonitrile; and PSAH for propanedisulfonic anhydride.

### Example 1-1

(Fabrication of Cathode)

The cylindrical secondary battery illustrated in FIGS. 1 and 2. was fabricated. First, the cathode 21 was produced. A lithium cobalt composite oxide (LiCoO₂) was obtained by mixing lithium carbonate (Li₂CO₃) and cobalt carbonate (CoCO₃) in a molar ratio of Li₂CO₃:CoCO₃=0.5:1 and calcining in air for 5 hours at 900° C. Next, 91 parts by mass of lithium cobalt composite oxide as the cathode active material, 3 parts by mass of polyvinylidene fluoride as the binding agent and 6 parts by mass of graphite as the conducting agent were mixed to form the cathode mixture, and the mixture was dispersed in N-methyl-2-pyrrolidone as the solvent, to form the paste-like cathode mixture slurry. Finally, the cathode mixture slurry was coated on both surfaces of the cathode current collector 21A made of strip-like aluminum foil (in thickness of 12 μm), dried, and then was subjected to compression molding by a roll press, thereby the cathode active material layer 21B was formed. After this, on one end of the cathode current collector 21A, the cathode lead 25 made of aluminum was attached by welding.

(Fabrication of Anode)

Next, the anode 22 was fabricated. As the anode active material, 96% by mass of granular graphite powder having an average particle diameter of 20 μm, 1.5% by mass of acrylic acid-modified styrene-butadiene copolymer, 1.5% by mass of carboxymethyl cellulose and an appropriate amount of water were stirred to be prepared in the anode slurry. Subsequently, this anode mixture slurry was uniformly coated on both surfaces of the anode current collector 22A made of strip-like copper foil in thickness of 15 μm, dried, and then was subjected to compression molding, thereby the anode active material layer 22B was formed.

In fabrication of the cathode and the anode, amounts of the cathode active material and the anode active material were adjusted to be designed to have the open-circuit voltage on a full charge (that is, the battery voltage) of 4.3V. After this, on one end of the anode current collector 22A, the anode lead 26 made of aluminum was attached.

(Preparation of Electrolyte Solution)

The electrolyte solution was prepared in the following manner. This was prepared by dissolving LiPF₆ as the electrolytic salt at a concentration of 1.2 mol/L in the solvent to the mixed solvent of ethylene carbonate (EC) and dimethyl carbonate (DMC) mixed in a proportion of (EC:DMC)=25:75 by volume ratio, and adding compound A as an additive, in amount of 0.1% by mass of the total mass of the electrolyte solution.

(Assembly of Battery)

Next, by cauking the battery can 11 via the gasket 17 to which surface asphalt had been applied, the safety valve mechanism 15, the PTC device 16 and the battery cover 14 were secured to the battery can 11. Thereby, the inside of the battery can 11 was ensured to be kept airtight, and the cylindrical secondary battery was thus completed.

### Example 1-2

A cylindrical secondary battery was fabricated in a similar way to Example 1-1, except that an adding amount of compound A was 1% by mass of the total mass of the electrolyte solution, in the preparation of the electrolyte solution.

### Example 1-3

A cylindrical secondary battery was fabricated in a similar way to Example 1-1, except that an adding amount of compound A was 5% by mass of the total mass of the electrolyte solution, in the preparation of the electrolyte solution.

### Examples 1-4 to 1-6

A cylindrical secondary battery was fabricated in a similar way to each of Examples 1-1 to 1-3 respectively, except the addition of compound B in place of the addition of compound A, in the preparation of the electrolyte solution.

### Examples 1-7 to 1-9

A cylindrical secondary battery was fabricated in a similar way to each of Examples 1-1 to 1-3 respectively, except the addition of compound C in place of the addition of compound A, in the preparation of the electrolyte solution.

### Examples 1-10 to 1-12

A cylindrical secondary battery was fabricated in a similar way to each of Examples 1-1 to 1-3 respectively, except the addition of compound D in place of the addition of compound A, in the preparation of the electrolyte solution.

### Examples 1-13 to 1-15

A cylindrical secondary battery was fabricated in a similar way to each of Examples 1-1 to 1-3 respectively, except the addition of compound E in place of the addition of compound A, in the preparation of the electrolyte solution.

### Examples 1-16 to 1-18

A cylindrical secondary battery was fabricated in a similar way to each of Examples 1-1 to 1-3 respectively, except the addition of compound F in place of the addition of compound A, in the preparation of the electrolyte solution.

### Examples 1-19 to 1-21

A cylindrical secondary battery was fabricated in a similar way to each of Examples 1-1 to 1-3 respectively, except the addition of compound G in place of the addition of compound A, in the preparation of the electrolyte solution.

### Examples 1-22 to 1-24

A cylindrical secondary battery was fabricated in a similar way to each of Examples 1-1 to 1-3 respectively, except the addition of compound H in place of the addition of compound A, in the preparation of the electrolyte solution.

### Examples 1-25 to 1-27

A cylindrical secondary battery was fabricated in a similar way to each of Examples 1-1 to 1-3 respectively, except the addition of compound I in place of the addition of compound A, in the preparation of the electrolyte solution.

### Examples 1-28 to 1-30

A cylindrical secondary battery was fabricated in a similar way to each of Examples 1-1 to 1-3 respectively, except the addition of compound J in place of the addition of compound A, in the preparation of the electrolyte solution.

### Examples 1-31 to 1-33

A cylindrical secondary battery was fabricated in a similar way to each of Examples 1-1 to 1-3 respectively, except the addition of compound K in place of the addition of compound A, in the preparation of the electrolyte solution.

### Examples 1-34 to 1-36

A cylindrical secondary battery was fabricated in a similar way to each of Examples 1-1 to 1-3 respectively, except the addition of compound L in place of the addition of compound A, in the preparation of the electrolyte solution.

### Examples 1-37 to 1-39

A cylindrical secondary battery was fabricated in a similar way to each of Examples 1-1 to 1-3 respectively, except the addition of compound M in place of the addition of compound A, in the preparation of the electrolyte solution.

### Examples 1-40 to 1-42

A cylindrical secondary battery was fabricated in a similar way to each of Examples 1-1 to 1-3 respectively, except the addition of compound N in place of the addition of compound A, in the preparation of the electrolyte solution.

### Examples 1-43 to 1-45

A cylindrical secondary battery was fabricated in a similar way to each of Examples 1-1 to 1-3 respectively, except the addition of compound O in place of the addition of compound A, in the preparation of the electrolyte solution.

### Examples 1-46 to 1-48

A cylindrical secondary battery was fabricated in a similar way to each of Examples 1-1 to 1-3 respectively, except the addition of compound P in place of the addition of compound A, in the preparation of the electrolyte solution.

### Examples 1-49 to 1-51

A cylindrical secondary battery was fabricated in a similar way to each of Examples 1-1 to 1-3 respectively, except the addition of compound Q in place of the addition of compound A, in the preparation of the electrolyte solution.

### Examples 1-52 to 1-54

A cylindrical secondary battery was fabricated in a similar way to each of Examples 1-1 to 1-3 respectively, except the addition of compound R in place of the addition of compound A, in the preparation of the electrolyte solution.

### Examples 1-55 to 1-62

A cylindrical secondary battery of Example 1-55 was fabricated in a similar way to Example 1-1, except that compound S was added in amount of 0.01% by mass of the total mass of the electrolyte solution, in place of the addition of compound A, in the preparation of the electrolyte solution. A cylindrical secondary battery of each of Examples 1-56 to 1-62 was fabricated in a similar way to Example 1-55, except that adding amount of compound S was 0.1%, 0.5%, 1%, 5%, 10%, 20% and 30% by mass respectively, of the total mass of the electrolyte solution, in the preparation of the electrolyte solution.

### Examples 1-63 to 1-65

A cylindrical secondary battery was fabricated in a similar way to each of Examples 1-1 to 1-3 respectively, except the addition of compound T in place of the addition of compound A, in the preparation of the electrolyte solution.

### Examples 1-66 to 1-68

A cylindrical secondary battery was fabricated in a similar way to each of Examples 1-1 to 1-3 respectively, except the addition of compound U in place of the addition of compound A, in the preparation of the electrolyte solution.

### Examples 1-69 to 1-94

Amounts of the cathode active material and the anode active material were adjusted to produce a cathode and an anode to be designed to have the open-circuit voltage on a full charge (that is, the battery voltage) of 4.45V, in the fabrication of the cathode and the anode. Otherwise a cylindrical secondary battery was fabricated in a similar way to each of Examples 1-1 to 1-3, 1-4 to 1-6, 1-19 to 1-21, 1-31 to 1-33, 1-37 to 1-39, 1-43 to 1-45, 1-55 to 1-62, respectively.

### Comparative Example 1-1

A cylindrical secondary battery was fabricated in a similar way to Example 1-1, except that compound A was not added in the preparation of the electrolyte solution.

### Comparative Example 1-2

A cylindrical secondary battery was fabricated in a similar way to Example 1-2, except the addition of compound V in place of the addition of compound A, in the preparation of the electrolyte solution.

### Comparative Example 1-3

A cylindrical secondary battery was fabricated in a similar way to Example 1-69, except that compound A was not added in the preparation of the electrolyte solution.

### Comparative Example 1-4

A cylindrical secondary battery was fabricated in a similar way to Example 1-70, except the addition of compound V in place of the addition of compound A, in the preparation of the electrolyte solution.

(Evaluation)

For the secondary batteries fabricated, the following features were measured.

(Measurement of Safety Valve Operation Time)

The safety valve operation time was measured in the following manner. A secondary battery fabricated was charged-and-discharged two cycles in an atmosphere of 23° C.; then charged at a constant current density of 1 mA/cm² in the same atmosphere until the battery voltage reaches a predetermined voltage; and then charged at a constant voltage of the predetermined voltage until the current density reaches 0.02 mA/cm². After this, the charged secondary battery was stored at 70° C. and the operation time for the safety valve to operate was measured.

The predetermined voltages were the following:

Secondary batteries of Examples 1-1 to 1-68 and Comparative Examples 1-1 and 1-2: 4.3V

Secondary batteries of Examples 1-69 to 1-94 and Comparative Examples 1-3 and 1-4: 4.45V

(Measurement of Low-Temperature Cycle Characteristics)

The low-temperature cycle characteristics were measured in the following manner. First, the secondary battery fabricated was charged-and-discharged in an atmosphere of 23° C. for the first cycle; then charged-and-discharged for the second cycle at 0° C. to be confirmed the discharge capacity. Then at −5° C., the charge-and-discharge for the third to fiftieth cycle was conducted, and the discharging capacity retention rate (%) at the fiftieth cycle, in relation to the discharging capacity in the second cycle defined as 100 for reference, was measured. As the charging and discharging conditions for one cycle, the battery was charged by a constant current density of 5 mA/cm² until the battery voltage reaches a predetermined charging-voltage, then discharged at a constant voltage of the predetermined charging-voltage and a constant current density of 0.02 mA/cm² until the battery voltage reaches a predetermined voltage.

The predetermined charging-voltages were the following:

Secondary batteries of Examples 1-1 to 1-68 and Comparative Examples 1-1 and 1-2: 4.3V

Secondary batteries of Examples 1-69 to 1-94 and Comparative Examples 1-3 and 1-4: 4.45V

The result of measurement is shown in Table 1. In Table 1, on the field of evaluation, the effectiveness rank of Compounds A to U according to the result of measurement of safety valve operation time is indicated (where the rank order is A⁺⁺⁺⁺, A⁺⁺⁺, A⁺⁺, A⁺, A, A⁻, B⁺, B, and C).

TABLE 1

| | | | | Safety valve | | |
|---|---|---|---|---|---|---|
| | | Additive | Content | operation time | | Low-temperature cycle |
| | Cathode | Compound | (Mass %) | (h) | Evaluation | characteristics (%) |
| Ex. 1-1 | LiCoO₂ | A | 0.1 | 420 | C | — |
| Ex. 1-2 | | | 1 | 463 | | 46 |
| Ex. 1-3 | | | 5 | 396 | | — |
| Ex. 1-4 | | B | 0.1 | 425 | B | — |
| Ex. 1-5 | | | 1 | 466 | | 46 |
| Ex. 1-6 | | | 5 | 400 | | — |
| Ex. 1-7 | | C | 0.1 | 420 | C | — |
| Ex. 1-8 | | | 1 | 463 | | 46 |
| Ex. 1-9 | | | 5 | 397 | | — |
| Ex. 1-10 | | D | 0.1 | 423 | B | — |
| Ex. 1-11 | | | 1 | 466 | | 46 |
| Ex. 1-12 | | | 5 | 397 | | — |
| Ex. 1-13 | | E | 0.1 | 421 | B | — |
| Ex. 1-14 | | | 1 | 465 | | 46 |
| Ex. 1-15 | | | 5 | 397 | | — |
| Ex. 1-16 | | F | 0.1 | 426 | B+ | — |
| Ex. 1-17 | | | 1 | 468 | | 47 |
| Ex. 1-18 | | | 5 | 402 | | — |
| Ex. 1-19 | | G | 0.1 | 455 | A | — |
| Ex. 1-20 | | | 1 | 488 | | 47 |
| Ex. 1-21 | | | 5 | 418 | | — |
| Ex. 1-22 | | H | 0.1 | 454 | A | — |
| Ex. 1-23 | | | 1 | 487 | | 47 |
| Ex. 1-24 | | | 5 | 418 | | — |
| Ex. 1-25 | | I | 0.1 | 456 | A | — |
| Ex. 1-26 | | | 1 | 490 | | 47 |
| Ex. 1-27 | | | 5 | 421 | | — |
| Ex. 1-28 | | J | 0.1 | 462 | A+ | — |
| Ex. 1-29 | | | 1 | 498 | | 47 |
| Ex. 1-30 | | | 5 | 423 | | — |
| Ex. 1-31 | | K | 0.1 | 451 | A− | — |
| Ex. 1-32 | | | 1 | 485 | | 47 |
| Ex. 1-33 | | | 5 | 416 | | — |
| Ex. 1-34 | | L | 0.1 | 455 | A | — |
| Ex. 1-35 | | | 1 | 490 | | 48 |
| Ex. 1-36 | | | 5 | 420 | | — |
| Ex. 1-37 | | M | 0.1 | 463 | A+ | — |
| Ex. 1-38 | | | 1 | 499 | | 48 |
| Ex. 1-39 | | | 5 | 424 | | — |
| Ex. 1-40 | | N | 0.1 | 454 | A | — |
| Ex. 1-41 | | | 1 | 489 | | 47 |
| Ex. 1-42 | | | 5 | 420 | | — |
| Ex. 1-43 | | O | 0.1 | 463 | A+ | — |
| Ex. 1-44 | | | 1 | 501 | | 48 |
| Ex. 1-45 | | | 5 | 427 | | — |
| Ex. 1-46 | | P | 0.1 | 458 | A+ | — |
| Ex. 1-47 | | | 1 | 503 | | 48 |
| Ex. 1-48 | | | 5 | 436 | | — |
| Ex. 1-49 | | Q | 0.1 | 458 | A+ | — |
| Ex. 1-50 | | | 1 | 500 | | 47 |
| Ex. 1-51 | | | 5 | 426 | | — |
| Ex. 1-52 | | R | 0.1 | 480 | A++ | — |
| Ex. 1-53 | | | 1 | 516 | | 48 |
| Ex. 1-54 | | | 5 | 453 | | — |
| Ex. 1-55 | | S | 0.01 | 430 | A++++ | — |
| Ex. 1-56 | | | 0.1 | 490 | | — |
| Ex. 1-57 | | | 0.5 | 520 | | — |
| Ex. 1-58 | | | 1 | 529 | | 49 |
| Ex. 1-59 | | | 5 | 475 | | — |
| Ex. 1-60 | | | 10 | 431 | | — |
| Ex. 1-61 | | | 20 | 385 | | — |
| Ex. 1-62 | | | 30 | 358 | | — |
| Ex. 1-63 | | T | 0.1 | 485 | A+++ | — |
| Ex. 1-64 | | | 1 | 521 | | 49 |
| Ex. 1-65 | | | 5 | 461 | | — |
| Ex. 1-66 | | U | 0.1 | 479 | A++ | — |
| Ex. 1-67 | | | 1 | 515 | | 48 |
| Ex. 1-68 | | | 5 | 454 | | — |
| Ex. 1-69 | LiCoO₂ | A | 0.1 | 318 | C | — |
| Ex. 1-70 | | | 1 | 327 | | 45 |
| Ex. 1-71 | | | 5 | 298 | | — |
| Ex. 1-72 | | B | 0.1 | 322 | B | — |
| Ex. 1-73 | | | 1 | 331 | | 45 |
| Ex. 1-74 | | | 5 | 302 | | — |
| Ex. 1-75 | | G | 0.1 | 333 | A | — |
| Ex. 1-76 | | | 1 | 342 | | 46 |
| Ex. 1-77 | | | 5 | 310 | | — |
| Ex. 1-78 | | K | 0.1 | 328 | A− | — |
| Ex. 1-79 | | | 1 | 339 | | 46 |
| Ex. 1-80 | | | 5 | 307 | | — |
| Ex. 1-81 | | M | 0.1 | 354 | A+ | — |
| Ex. 1-82 | | | 1 | 367 | | 47 |
| Ex. 1-83 | | | 5 | 340 | | — |
| Ex. 1-84 | | O | 0.1 | 353 | A+ | — |
| Ex. 1-85 | | | 1 | 365 | | 48 |
| Ex. 1-86 | | | 5 | 338 | | — |
| Ex. 1-87 | | S | 0.01 | 298 | | — |
| Ex. 1-88 | | | 0.1 | 368 | A++++ | — |
| Ex. 1-89 | | | 0.5 | 387 | | — |
| Ex. 1-90 | | | 1 | 392 | | 48 |
| Ex. 1-91 | | | 5 | 353 | | — |
| Ex. 1-92 | | | 10 | 321 | | — |
| Ex. 1-93 | | | 20 | 302 | | — |
| Ex. 1-94 | | | 30 | 285 | | — |
| Comp. Ex. 1-1 | LiCoO₂ | — | — | 325 | — | 46 |
| Comp. Ex. 1-2 | | V | 1 | 348 | | 25 |
| Comp. Ex. 1-3 | | — | — | 253 | | 43 |
| Comp. Ex. 1-4 | | V | 1 | 266 | | 21 |

The followings were confirmed according to Table 1. In Examples 1-1 to 1-94, with an addition of 1,3-dioxane derivative such as Compounds A to U in the electrolyte solution, the safety valve operation time was longer than that of the case without additions of such compounds in the electrolyte solution. Therefore, it was confirmed in Examples 1-1 to 1-94 that by adding 1,3-dioxane derivative such as Compounds A to U in the electrolyte solution, the gas generation could be inhibited. Further, since the gas generation could be inhibited, it can also be confirmed that the deterioration of battery characteristics such as cycle characteristics, due to the occurrence of gas generation, was able to be inhibited.

In addition, in such compounds represented by formula (1), one having a substituent group containing nitrogen or oxygen at the position 2 tended to show better effects. Also, in such compounds represented by formula (2) having a spiro structure, one having a substituent group containing nitrogen or oxygen at at least one of the positions 3 and 9 tended to show better effects, and one having substituent group containing nitrogen or oxygen at both the positions 3 and 9 tended to show particularly good effects. One which had a substituent group containing nitrogen tended to show better effects than one which had a substituent group containing oxygen.

Further, in Examples 1-1 to 1-94, even when the 1,3-dioxane derivative such as Compounds A to U was added to the electrolyte solution, its low-temperature cycle characteristics was not likely to be negatively influenced by this. This is assumed to be because the coating that derives from the 1,3-dioxane derivative such as Compounds A to U would not significantly lower its lithium-ion permeability. On the other hand, in the case where the additive compound was such as Compound V, in which all the substituent groups at the positions 1, 3, 5, 7, 9 and 11 of spiro ring in formula (2) were only hydrogen groups and hydrocarbon groups, the low-temperature cycle characteristics was lowered. This is assumed to be because the coating that derives from the compounds of formula (2) such as Compound V in which all the substituent groups at the positions 1, 3, 5, 7, 9 and 11 of the spiro ring are hydrogen groups and hydrocarbon groups is poor in lithium-ion permeability.

Further, according to Examples 1-55 to 1-62 and Examples 1-87 to 1-94, in the case where the content of the 1,3-dioxane derivative was 0.1% by mass or more and 10% by mass or less of the total mass of the non-aqueous electrolyte solution, it tended to show a better effect.

### Examples 2-1 to 2-4

A cylindrical secondary battery was fabricated in a similar way to Example 1-20, except the addition of VC, FEC, SN or PSAH in amount of 1% by mass of the total mass of the electrolyte solution, in the preparation of the electrolyte solution.

### Examples 2-5 to 2-8

A cylindrical secondary battery was fabricated in a similar way to Example 1-35, except the addition of VC, FEC, SN or PSAH in amount of 1% by mass of the total mass of the electrolyte solution, in the preparation of the electrolyte solution.

### Examples 2-9 to 2-13

### Examples 2-9, 2-10, 2-12 and 2-13

A cylindrical secondary battery was fabricated in a similar way to Example 1-58, except the addition of VC, FEC, SN or PSAH in amount of 1% by mass of the total mass of the electrolyte solution, in the preparation of the electrolyte solution.

### Examples 2-11

A cylindrical secondary battery was fabricated in a similar way to Example 1-58, except the addition of FEC in amount of 10% by mass of the total mass of the electrolyte solution, in the preparation of the electrolyte solution.

### Comparative Examples 2-1 to 2-4

A cylindrical secondary battery was fabricated in a similar way to Examples 2-1 to 2-4, except that compound G was not added in the preparation of the electrolyte solution.

(Evaluation)

(Measurement of Safety Valve Operation Time), (Measurement of Low-Temperature Cycle Characteristics)

For the secondary batteries fabricated, in a similar manner to the above, “the measurement of safety valve operation time” and “the measurement of low-temperature cycle characteristics” were performed.

The predetermined charing voltages were the following:

Secondary batteries of Examples 2-1 to 2-13 and Comparative Examples 2-1 to 2-4: 4.3V

The result of measurement is shown in Table 2. For comparison, the measurement results of Examples 1-20, 1-35, 1-58 and Comparative Example 1-1 are shown in Table 2.

TABLE 2

| | | | | | | Safety valve | |
|---|---|---|---|---|---|---|---|
| | | Additive | Content | Other | Content | operation time | Low-temperature cycle |
| | Cathode | Compound | (Mass %) | Additives | (Mass %) | (h) | characteristics (%) |
| Ex. 2-1 | LiCoO₂ | G | 1 | VC | 1 | 572 | 44 |
| Ex. 2-2 | | | | FEC | 1 | 563 | 49 |
| Ex. 2-3 | | | | SN | 1 | 658 | 47 |
| Ex. 2-4 | | | | PSAH | 1 | 681 | 49 |
| Ex. 2-5 | | L | 1 | VC | 1 | 573 | 44 |
| Ex. 2-6 | | | | FEC | 1 | 565 | 49 |
| Ex. 2-7 | | | | SN | 1 | 676 | 48 |
| Ex. 2-8 | | | | PSAH | 1 | 701 | 50 |
| Ex. 2-9 | | S | 1 | VC | 1 | 601 | 45 |
| Ex. 2-10 | | | | FEC | 1 | 598 | 49 |
| Ex. 2-11 | | | | FEC | 10 | 595 | 53 |
| Ex. 2-12 | | | | SN | 1 | 716 | 49 |
| Ex. 2-13 | | | | PSAH | 1 | 730 | 51 |
| Ex. 1-20 | | G | 1 | — | — | 488 | 47 |
| Ex. 1-35 | | L | 1 | — | — | 490 | 48 |
| Ex. 1-58 | | S | 1 | — | — | 529 | 49 |
| Comp. Ex. 1-1 | LiCoO₂ | — | — | — | — | 325 | 46 |
| Comp. Ex. 2-1 | | — | — | VC | 1 | 323 | 43 |
| Comp. Ex. 2-2 | | — | — | FEC | 1 | 318 | 49 |
| Comp. Ex. 2-3 | | — | — | SN | 1 | 390 | 47 |
| Comp. Ex. 2-4 | | — | — | PSAH | 1 | 401 | 49 |

The followings were confirmed according to Table 2. In Examples 2-1 to 2-13, when the other additive such as VC, FEC, SN and PSAH was also added to the electrolyte solution, with 1,3-dioxane derivative such as Compounds G, L and S, the safety valve operation time was longer than that of the case without additions of the both of these compounds in the electrolyte solution. Further, in Examples 2-1 to 2-13, even when the other additive such as VC, FEC, SN and PSAH was added with 1,3-dioxane derivative such as Compounds G, L and S to the electrolyte solution, its low-temperature cycle characteristics was not likely to be negatively influenced by this.

### Examples 3-1 to 3-68, Comparative Examples 3-1 and 3-2

In the fabrication of the cathode, LiNi_{0.82}Co_{0.15}Al_{0.03}O₂ was used in place of LiCoO₂. Amounts of the cathode active material and the anode active material were adjusted to be designed to have the open-circuit voltage on a full charge (that is, the battery voltage) of 4.2V. Otherwise a cylindrical secondary battery was fabricated in a similar way to each of Examples 1-1 to 1-68 and Comparative Examples 1-1 and 1-2, respectively.

(Evaluation)

(Measurement of Safety Valve Operation Time), (Measurement of Low-Temperature Cycle Characteristics)

For the secondary batteries fabricated, in a similar manner to the above, “the measurement of safety valve operation time” and “the measurement of low-temperature cycle characteristics” were performed.

The predetermined charging voltages were the following:

Secondary batteries of Examples 3-1 to 3-68 and Comparative Examples 3-1 and 3-2: 4.2V

The result of measurement is shown in Table 3. In Table 3, on the field of evaluation, the effectiveness rank of Compounds A to U according to the result of measurement of safety valve operation time is indicated (where the rank order is A⁺⁺⁺⁺, A⁺⁺⁺, A⁺⁺, A⁺, A, A⁻, B⁺, B, and C).

TABLE 3

| | | | | Safety valve | | |
|---|---|---|---|---|---|---|
| | | Additive | Content | operation time | | Low-temperature cycle |
| | Cathode | Compound | (Mass %) | (h) | Evaluation | characteristics (%) |
| Ex. 3-1 | LiNi_{0.82}Co_{0.15}Al_{0.03}O₂ | A | 0.1 | 362 | C | — |
| Ex. 3-2 | | | 1 | 400 | | 43 |
| Ex. 3-3 | | | 5 | 315 | | — |
| Ex. 3-4 | | B | 0.1 | 368 | B | — |
| Ex. 3-5 | | | 1 | 404 | | 44 |
| Ex. 3-6 | | | 5 | 321 | | — |
| Ex. 3-7 | | C | 0.1 | 363 | C | — |
| Ex. 3-8 | | | 1 | 400 | | 44 |
| Ex. 3-9 | | | 5 | 315 | | — |
| Ex. 3-10 | | D | 0.1 | 367 | B | — |
| Ex. 3-11 | | | 1 | 404 | | 44 |
| Ex. 3-12 | | | 5 | 321 | | — |
| Ex. 3-13 | | E | 0.1 | 367 | B | — |
| Ex. 3-14 | | | 1 | 405 | | 44 |
| Ex. 3-15 | | | 5 | 321 | | — |
| Ex. 3-16 | | F | 0.1 | 371 | B+ | — |
| Ex. 3-17 | | | 1 | 409 | | 44 |
| Ex. 3-18 | | | 5 | 325 | | — |
| Ex. 3-19 | | G | 0.1 | 384 | A | — |
| Ex. 3-20 | | | 1 | 425 | | 45 |
| Ex. 3-21 | | | 5 | 342 | | — |
| Ex. 3-22 | | H | 0.1 | 383 | A | — |
| Ex. 3-23 | | | 1 | 424 | | 45 |
| Ex. 3-24 | | | 5 | 341 | | — |
| Ex. 3-25 | | I | 0.1 | 384 | A | — |
| Ex. 3-26 | | | 1 | 425 | | 45 |
| Ex. 3-27 | | | 5 | 342 | | — |
| Ex. 3-28 | | J | 0.1 | 390 | A+ | — |
| Ex. 3-29 | | | 1 | 434 | | 46 |
| Ex. 3-30 | | | 5 | 350 | | — |
| Ex. 3-31 | | K | 0.1 | 378 | A− | — |
| Ex. 3-32 | | | 1 | 422 | | 45 |
| Ex. 3-33 | | | 5 | 338 | | — |
| Ex. 3-34 | | L | 0.1 | 384 | A | — |
| Ex. 3-35 | | | 1 | 424 | | 45 |
| Ex. 3-36 | | | 5 | 342 | | — |
| Ex. 3-37 | | M | 0.1 | 391 | A+ | — |
| Ex. 3-38 | | | 1 | 435 | | 45 |
| Ex. 3-39 | | | 5 | 350 | | — |
| Ex. 3-40 | | N | 0.1 | 384 | A | — |
| Ex. 3-41 | | | 1 | 424 | | 45 |
| Ex. 3-42 | | | 5 | 341 | | — |
| Ex. 3-43 | | O | 0.1 | 392 | A+ | — |
| Ex. 3-44 | | | 1 | 436 | | 46 |
| Ex. 3-45 | | | 5 | 349 | | — |
| Ex. 3-46 | | P | 0.1 | 391 | A+ | — |
| Ex. 3-47 | | | 1 | 436 | | 47 |
| Ex. 3-48 | | | 5 | 350 | | — |
| Ex. 3-49 | | Q | 0.1 | 390 | A+ | — |
| Ex. 3-50 | | | 1 | 436 | | 47 |
| Ex. 3-51 | | | 5 | 350 | | — |
| Ex. 3-52 | | R | 0.1 | 405 | A++ | — |
| Ex. 3-53 | | | 1 | 461 | | 47 |
| Ex. 3-54 | | | 5 | 377 | | — |
| Ex. 3-55 | | S | 0.01 | 354 | A++++ | — |
| Ex. 3-56 | | | 0.1 | 419 | | — |
| Ex. 3-57 | | | 0.5 | 468 | | — |
| Ex. 3-58 | | | 1 | 481 | | 48 |
| Ex. 3-59 | | | 5 | 395 | | — |
| Ex. 3-60 | | | 10 | 355 | | — |
| Ex. 3-61 | | | 20 | 330 | | — |
| Ex. 3-62 | | | 30 | 310 | | — |
| Ex. 3-63 | | T | 0.1 | 411 | A+++ | — |
| Ex. 3-64 | | | 1 | 472 | | 47 |
| Ex. 3-65 | | | 5 | 385 | | — |
| Ex. 3-66 | | U | 0.1 | 404 | A++ | — |
| Ex. 3-67 | | | 1 | 462 | | 47 |
| Ex. 3-68 | | | 5 | 378 | | — |
| Comp. Ex. 3-1 | LiNi_{0.82}CO_{0.15}Al_{0.03}O₂ | — | — | 275 | — | 42 |
| Comp. Ex. 3-2 | | V | 1 | 294 | | 19 |

The followings were confirmed according to Table 3. In Example 3-1 to 3-68, in the case where LiNi_{0.82}CO_{0.15}Al_{0.03}O₂ was used as the cathode active material, with an addition of 1,3-dioxane derivative such as Compounds A to U in the electrolyte solution, the safety valve operation time was longer than that of the case without additions of such compounds in the electrolyte solution. Therefore, it was confirmed in Examples 3-1 to 3-68 that in the case where LiNi_{0.82}Co_{0.15}Al_{0.03}O₂ was used as the cathode active material, by adding 1,3-dioxane derivative such as Compounds A to U in the electrolyte solution, the gas generation could be inhibited. Further, since the gas generation could be inhibited, it can also be confirmed that the deterioration of battery characteristics such as cycle characteristics, due to the occurrence of gas generation, was able to be inhibited.

In addition, in such compounds represented by formula (1), one having a substituent group containing nitrogen or oxygen at the position 2 tended to show better effects. Also, in such compounds represented by formula (2) having a spiro structure, one having a substituent group containing nitrogen or oxygen at at least one of the positions 3 and 9 tended to show better effects, and one having substituent group containing nitrogen or oxygen at both the positions 3 and 9 tended to show particularly good effects. One which had a substituent group containing nitrogen tended to show better effects than one which had a substituent group containing oxygen.

Further, in Examples 3-1 to 3-68, even when the 1,3-dioxane derivative such as Compounds A to U was added to the electrolyte solution, its low-temperature cycle characteristics was not likely to be negatively influenced by this. On the other hand, in the case where the additive compound was such as Compound V, in which all the substituent groups at the positions 1, 3, 5, 7, 9 and 11 of spiro ring in formula (2) were only hydrogen groups and hydrocarbon groups, the low-temperature cycle characteristics was lowered.

### Examples 4-1 to 4-68, Comparative Examples 4-1 and 4-2

In the fabrication of the anode, SnCoC-containing material was used in the anode active material. Amounts of the cathode active material and the anode active material were adjusted to be designed to have the open-circuit voltage on a full charge (that is, the battery voltage) of 4.2V.

(Fabrication of Anode)

Tin-cobalt-indium-titanium alloy powder and carbon powder were mixed up, and then by using a mechanochemical reaction, SnCoC-containing material was synthesized. When the composition of this SnCoC-containing material was analyzed, the content of tin was 48% by mass, the content of cobalt was 23% by mass and the content of carbon was 20% by mass, and the proportion of cobalt of the sum of tin and cobalt (Co/(Sn+Co)) was 32% by mass.

Next, 80 parts by mass of the above-mentioned SnCoC-containing material as the anode active material, 12 parts by mass of graphite as the conducting agent and 8 parts by mass of polyvinylidene fluoride as the binding agent were mixed, and then dispersed in N-methyl-2-pyrrolidone as the solvent. Finally, by being coated on the anode current collector made of copper foil (in thickness of 15 nm), dried, and then subjected to compression molding, the material was formed into the anode active material layer.

Otherwise a cylindrical secondary battery was fabricated in a similar way to each of Examples 1-1 to 1-68 and Comparative Examples 1-1 and 1-2, respectively.

(Evaluation)

(Measurement of Safety Valve Operation Time), (Measurement of Low-Temperature Cycle Characteristics)

For the secondary batteries fabricated, in a similar manner to the above, “the measurement of safety valve operation time” and “the measurement of low-temperature cycle characteristics” were performed.

The predetermined charging voltages were the following:

Secondary batteries of Examples 4-1 to 4-68 and Comparative Examples 4-1 and 4-2: 4.2V

The result of measurement is shown in Table 4. In Table 4, on the field of evaluation, the effectiveness rank of Compounds A to U according to the result of measurement of safety valve operation time is indicated (where the rank order is A⁺⁺⁺⁺, A⁺⁺⁺, A⁺⁺, A⁺, A, A⁻, B⁺, B, and C).

TABLE 4

| | | | | Safety valve | | |
|---|---|---|---|---|---|---|
| | | Additive | Content | operation time | | Low-temperature cycle |
| | Anode | Compound | (Mass %) | (h) | Evaluation | characteristics (%) |
| Ex. 4-1 | SnCoC | A | 0.1 | 402 | C | — |
| Ex. 4-2 | | | 1 | 448 | | 50 |
| Ex. 4-3 | | | 5 | 381 | | — |
| Ex. 4-4 | | B | 0.1 | 406 | B | — |
| Ex. 4-5 | | | 1 | 453 | | 50 |
| Ex. 4-6 | | | 5 | 386 | | — |
| Ex. 4-7 | | C | 0.1 | 401 | C | — |
| Ex. 4-8 | | | 1 | 448 | | 50 |
| Ex. 4-9 | | | 5 | 381 | | — |
| Ex. 4-10 | | D | 0.1 | 406 | B | — |
| Ex. 4-11 | | | 1 | 454 | | 50 |
| Ex. 4-12 | | | 5 | 387 | | — |
| Ex. 4-13 | | E | 0.1 | 405 | B | — |
| Ex. 4-14 | | | 1 | 454 | | 50 |
| Ex. 4-15 | | | 5 | 387 | | — |
| Ex. 4-16 | | F | 0.1 | 409 | B+ | — |
| Ex. 4-17 | | | 1 | 460 | | 51 |
| Ex. 4-18 | | | 5 | 391 | | — |
| Ex. 4-19 | | G | 0.1 | 432 | A | — |
| Ex. 4-20 | | | 1 | 479 | | 51 |
| Ex. 4-21 | | | 5 | 399 | | — |
| Ex. 4-22 | | H | 0.1 | 431 | A | — |
| Ex. 4-23 | | | 1 | 478 | | 51 |
| Ex. 4-24 | | | 5 | 398 | | — |
| Ex. 4-25 | | I | 0.1 | 432 | A | — |
| Ex. 4-26 | | | 1 | 478 | | 52 |
| Ex. 4-27 | | | 5 | 399 | | — |
| Ex. 4-28 | | J | 0.1 | 437 | A+ | — |
| Ex. 4-29 | | | 1 | 484 | | 53 |
| Ex. 4-30 | | | 5 | 405 | | — |
| Ex. 4-31 | | K | 0.1 | 425 | A− | — |
| Ex. 4-32 | | | 1 | 470 | | 51 |
| Ex. 4-33 | | | 5 | 396 | | — |
| Ex. 4-34 | | L | 0.1 | 432 | A | — |
| Ex. 4-35 | | | 1 | 479 | | 52 |
| Ex. 4-36 | | | 5 | 400 | | — |
| Ex. 4-37 | | M | 0.1 | 437 | A+ | — |
| Ex. 4-38 | | | 1 | 485 | | 52 |
| Ex. 4-39 | | | 5 | 406 | | — |
| Ex. 4-40 | | N | 0.1 | 433 | A | — |
| Ex. 4-41 | | | 1 | 479 | | 52 |
| Ex. 4-42 | | | 5 | 400 | | — |
| Ex. 4-43 | | O | 0.1 | 436 | A+ | — |
| Ex. 4-44 | | | 1 | 486 | | 52 |
| Ex. 4-45 | | | 5 | 405 | | — |
| Ex. 4-46 | | P | 0.1 | 436 | A+ | — |
| Ex. 4-47 | | | 1 | 487 | | 52 |
| Ex. 4-48 | | | 5 | 405 | | — |
| Ex. 4-49 | | Q | 0.1 | 436 | A+ | — |
| Ex. 4-50 | | | 1 | 486 | | 53 |
| Ex. 4-51 | | | 5 | 406 | | — |
| Ex. 4-52 | | R | 0.1 | 456 | A++ | — |
| Ex. 4-53 | | | 1 | 505 | | 53 |
| Ex. 4-54 | | | 5 | 430 | | — |
| Ex. 4-55 | | S | 0.01 | 401 | A++++ | — |
| Ex. 4-56 | | | 0.1 | 467 | | — |
| Ex. 4-57 | | | 0.5 | 510 | | — |
| Ex. 4-58 | | | 1 | 519 | | 54 |
| Ex. 4-59 | | | 5 | 449 | | — |
| Ex. 4-60 | | | 10 | 402 | | — |
| Ex. 4-61 | | | 20 | 378 | | — |
| Ex. 4-62 | | | 30 | 335 | | — |
| Ex. 4-63 | | T | 0.1 | 450 | A+++ | — |
| Ex. 4-64 | | | 1 | 515 | | 53 |
| Ex. 4-65 | | | 5 | 441 | | — |
| Ex. 4-66 | | U | 0.1 | 456 | A++ | — |
| Ex. 4-67 | | | 1 | 505 | | 53 |
| Ex. 4-68 | | | 5 | 431 | | — |
| Comp. Ex. 4-1 | SnCoC | — | — | 305 | — | 48 |
| Comp. Ex. 4-2 | | V | 1 | 321 | | 22 |

The followings were confirmed according to Table 4. In Example 4-1 to 4-68, in the case where SnCoC-containing material was used as the anode active material, with an addition of 1,3-dioxane derivative such as Compounds A to U in the electrolyte solution, the safety valve operation time was longer than that of the case without additions of such compounds in the electrolyte solution. Therefore, it was confirmed in Examples 4-1 to 4-68 that in the case where SnCoC-containing material was used as the anode active material, by adding 1,3-dioxane derivative such as Compounds A to U in the electrolyte solution, the gas generation could be inhibited. Further, since the gas generation could be inhibited, it can also be confirmed that the deterioration of battery characteristics such as cycle characteristics, due to the occurrence of gas generation, was able to be inhibited.

In addition, in such compounds represented by formula (1), one having a substituent group containing nitrogen or oxygen at the position 2 tended to show better effects. Also, in such compounds represented by formula (2) having a spiro structure, one having a substituent group containing nitrogen or oxygen at at least one of the positions 3 and 9 tended to show better effects, and one having substituent group containing nitrogen or oxygen at both the positions 3 and 9 tended to show particularly good effects. One which had a substituent group containing nitrogen tended to show better effects than one which had a substituent group containing oxygen.

Further, in Examples 4-1 to 4-68, even when the 1,3-dioxane derivative such as Compounds A to U was added to the electrolyte solution, its low-temperature cycle characteristics was not likely to be negatively influenced by this. On the other hand, in the case where the additive compound was such as Compound V, in which all the substituent groups at the positions 1, 3, 5, 7, 9 and 11 of spiro ring in formula (2) were only hydrogen groups and hydrocarbon groups, the low-temperature cycle characteristics was lowered.

### Examples 5-1 to 5-68, Comparative Examples 5-1 and 5-2

In the fabrication of the anode, silicon was used in the anode active material. Amounts of the cathode active material and the anode active material were adjusted to be designed to have the open-circuit voltage on a full charge (that is, the battery voltage) of 4.2V.

(Fabrication of Anode)

As the anode active material, silicon powder having an average particle diameter of 10 μm was used. 90 parts by mass of this silicon powder, 5 parts by mass of graphite powder and 5 parts by mass of polyimide precursor as the binding agent were mixed, and then by adding N-methyl-2-pyrrolidone, the slurry was prepared. Subsequently, this slurry as anode mixture slurry was uniformly coated on both surfaces of the anode current collector 22A made of strip-like copper foil in thickness of 15 μm, dried, and then was subjected to compression molding. After this, by a heating in the vacuum atmosphere for 12 hours at 400° C., the anode active material layer 22B was formed.

Otherwise a cylindrical secondary battery was fabricated in a similar way to each of Examples 1-1 to 1-68 and Comparative Examples 1-1 and 1-2, respectively.

(Evaluation)

(Measurement of Safety Valve Operation Time), (Measurement of Low-Temperature Cycle Characteristics)

For the secondary batteries fabricated, in a similar manner to the above, “the measurement of safety valve operation time” and “the measurement of low-temperature cycle characteristics” were performed.

The predetermined charging voltages were the following:

Secondary batteries of Examples 5-1 to 5-68 and Comparative Examples 5-1 and 5-2: 4.2V

The result of measurement is shown in Table 5. In Table 5, on the field of evaluation, the effectiveness rank of Compounds A to U according to the result of measurement of safety valve operation time is indicated (where the rank order is A⁺⁺⁺⁺, A⁺⁺⁺, A⁺⁺, A⁺, A, A⁻, B⁺, B, and C).

TABLE 5

| | | | | Safety valve | | |
|---|---|---|---|---|---|---|
| | | Additive | Content | operation time | | Low-temperature cycle |
| | Anode | Compound | (Mass %) | (h) | Evaluation | characteristics (%) |
| Ex. 5-1 | Si | A | 0.1 | 353 | C | — |
| Ex. 5-2 | | | 1 | 390 | | 48 |
| Ex. 5-3 | | | 5 | 305 | | — |
| Ex. 5-4 | | B | 0.1 | 359 | B | — |
| Ex. 5-5 | | | 1 | 392 | | 50 |
| Ex. 5-6 | | | 5 | 308 | | — |
| Ex. 5-7 | | C | 0.1 | 353 | C | — |
| Ex. 5-8 | | | 1 | 390 | | 49 |
| Ex. 5-9 | | | 5 | 305 | | — |
| Ex. 5-10 | | D | 0.1 | 358 | B | — |
| Ex. 5-11 | | | 1 | 392 | | 49 |
| Ex. 5-12 | | | 5 | 307 | | — |
| Ex. 5-13 | | E | 0.1 | 359 | B | — |
| Ex. 5-14 | | | 1 | 392 | | 50 |
| Ex. 5-15 | | | 5 | 308 | | — |
| Ex. 5-16 | | F | 0.1 | 364 | B+ | — |
| Ex. 5-17 | | | 1 | 398 | | 50 |
| Ex. 5-18 | | | 5 | 314 | | — |
| Ex. 5-19 | | G | 0.1 | 375 | A | — |
| Ex. 5-20 | | | 1 | 410 | | 51 |
| Ex. 5-21 | | | 5 | 330 | | — |
| Ex. 5-22 | | H | 0.1 | 374 | A | — |
| Ex. 5-23 | | | 1 | 409 | | 51 |
| Ex. 5-24 | | | 5 | 330 | | — |
| Ex. 5-25 | | I | 0.1 | 375 | A | — |
| Ex. 5-26 | | | 1 | 411 | | 50 |
| Ex. 5-27 | | | 5 | 331 | | — |
| Ex. 5-28 | | J | 0.1 | 381 | A+ | — |
| Ex. 5-29 | | | 1 | 417 | | 51 |
| Ex. 5-30 | | | 5 | 342 | | — |
| Ex. 5-31 | | K | 0.1 | 369 | A− | — |
| Ex. 5-32 | | | 1 | 404 | | 50 |
| Ex. 5-33 | | | 5 | 325 | | — |
| Ex. 5-34 | | L | 0.1 | 376 | A | — |
| Ex. 5-35 | | | 1 | 411 | | 50 |
| Ex. 5-36 | | | 5 | 331 | | — |
| Ex. 5-37 | | M | 0.1 | 381 | A+ | — |
| Ex. 5-38 | | | 1 | 417 | | 51 |
| Ex. 5-39 | | | 5 | 342 | | — |
| Ex. 5-40 | | N | 0.1 | 376 | A | — |
| Ex. 5-41 | | | 1 | 411 | | 51 |
| Ex. 5-42 | | | 5 | 331 | | — |
| Ex. 5-43 | | O | 0.1 | 382 | A+ | — |
| Ex. 5-44 | | | 1 | 416 | | 50 |
| Ex. 5-45 | | | 5 | 342 | | — |
| Ex. 5-46 | | P | 0.1 | 382 | A+ | — |
| Ex. 5-47 | | | 1 | 417 | | 51 |
| Ex. 5-48 | | | 5 | 342 | | — |
| Ex. 5-49 | | Q | 0.1 | 381 | A+ | — |
| Ex. 5-50 | | | 1 | 418 | | 50 |
| Ex. 5-51 | | | 5 | 343 | | — |
| Ex. 5-52 | | R | 0.1 | 394 | A++ | — |
| Ex. 5-53 | | | 1 | 432 | | 51 |
| Ex. 5-54 | | | 5 | 353 | | — |
| Ex. 5-55 | | S | 0.01 | 350 | A++++ | — |
| Ex. 5-56 | | | 0.1 | 415 | | — |
| Ex. 5-57 | | | 0.5 | 461 | | — |
| Ex. 5-58 | | | 1 | 472 | | 51 |
| Ex. 5-59 | | | 5 | 380 | | — |
| Ex. 5-60 | | | 10 | 350 | | — |
| Ex. 5-61 | | | 20 | 318 | | — |
| Ex. 5-62 | | | 30 | 293 | | — |
| Ex. 5-63 | | T | 0.1 | 403 | A+++ | — |
| Ex. 5-64 | | | 1 | 442 | | 51 |
| Ex. 5-65 | | | 5 | 364 | | — |
| Ex. 5-66 | | U | 0.1 | 395 | A++ | — |
| Ex. 5-67 | | | 1 | 433 | | 51 |
| Ex. 5-68 | | | 5 | 354 | | — |
| Comp. Ex. 5-1 | Si | — | — | 235 | — | 45 |
| Comp. Ex. 5-2 | | V | 1 | 273 | | 19 |

The followings were confirmed according to Table 5. In Example 5-1 to 5-68, in the case where silicon (Si) was used as the cathode active material, with an addition of 1,3-dioxane derivative such as Compounds A to U in the electrolyte solution, the safety valve operation time was longer than that of the case without additions of such compounds in the electrolyte solution. Therefore, it was confirmed in Examples 5-1 to 5-68 that in the case where silicon (Si) was used as the cathode active material, by adding 1,3-dioxane derivative such as Compounds A to U in the electrolyte solution, the gas generation could be inhibited. Further, since the gas generation could be inhibited, it can also be confirmed that the deterioration of battery characteristics such as cycle characteristics, due to the occurrence of gas generation, was able to be inhibited.

In addition, in such compounds represented by formula (1), one having a substituent group containing nitrogen or oxygen at the position 2 tended to show better effects. Also, in such compounds represented by formula (2) having a spiro structure, one having a substituent group containing nitrogen or oxygen at at least one of the positions 3 and 9 tended to show better effects, and one having substituent group containing nitrogen or oxygen at both the positions 3 and 9 tended to show particularly good effects. One which had a substituent group containing nitrogen tended to show better effects than one which had a substituent group containing oxygen.

Further, in Examples 5-1 to 5-68, even when the 1,3-dioxane derivative such as Compounds A to U was added to the electrolyte solution, its low-temperature cycle characteristics was not likely to be negatively influenced by this. On the other hand, in the case where the additive compound was such as Compound V, in which all the substituent groups at the positions 1, 3, 5, 7, 9 and 11 of spiro ring in formula (2) were only hydrogen groups and hydrocarbon groups, the low-temperature cycle characteristics was lowered.

### Examples 6-1 to 6-68, Comparative Examples 6-1 and 6-2

In the fabrication of the cathode, LiNi_{0.5}Co_{0.2}Mn_{0.3}O₂ was used in place of LiCoO₂, as the cathode active material. In the fabrication of the anode, Li₄Ti₅O₁₂ was used in place of granular graphite powder, as the anode active material. Amounts of the cathode active material and the anode active material were adjusted to be designed to have the open-circuit voltage on a full charge (that is, the battery voltage) of 2.8V. Otherwise a cylindrical secondary battery was fabricated in a similar way to each of Examples 1-1 to 1-68 and Comparative Examples 1-1 and 1-2, respectively.

(Evaluation)

(Measurement of Safety Valve Operation Time), (Measurement of Low-Temperature Cycle Characteristics)

For the secondary batteries fabricated, in a similar manner to the above, “the measurement of safety valve operation time” and “the measurement of low-temperature cycle characteristics” were performed.

The predetermined charging voltages were the following:

Secondary batteries of Examples 6-1 to 6-68 and Comparative Examples 6-1 and 6-2: 2.8V

The result of measurement is shown in Table 6. In Table 6, on the field of evaluation, the effectiveness rank of Compounds A to U according to the result of measurement of safety valve operation time is indicated (where the rank order is A⁺⁺⁺⁺, A⁺⁺⁺, A⁺⁺, A⁺, A, A⁻, B⁺, B, and C).

TABLE 6

| | | | | Safety valve | | |
|---|---|---|---|---|---|---|
| | | Additive | Content | operation time | | Low-temperature cycle |
| | Anode | Compound | (Mass %) | (h) | Evaluation | characteristics (%) |
| Ex. 6-1 | Li₄Ti₅O₁₂ | A | 0.1 | 433 | C | — |
| Ex. 6-2 | | | 1 | 482 | | 80 |
| Ex. 6-3 | | | 5 | 408 | | — |
| Ex. 6-4 | | B | 0.1 | 438 | B | — |
| Ex. 6-5 | | | 1 | 487 | | 80 |
| Ex. 6-6 | | | 5 | 413 | | — |
| Ex. 6-7 | | C | 0.1 | 433 | C | — |
| Ex. 6-8 | | | 1 | 483 | | 80 |
| Ex. 6-9 | | | 5 | 408 | | — |
| Ex. 6-10 | | D | 0.1 | 438 | B | — |
| Ex. 6-11 | | | 1 | 487 | | 81 |
| Ex. 6-12 | | | 5 | 412 | | — |
| Ex. 6-13 | | E | 0.1 | 437 | B | — |
| Ex. 6-14 | | | 1 | 487 | | 81 |
| Ex. 6-15 | | | 5 | 412 | | — |
| Ex. 6-16 | | F | 0.1 | 444 | B+ | — |
| Ex. 6-17 | | | 1 | 494 | | 81 |
| Ex. 6-18 | | | 5 | 417 | | — |
| Ex. 6-19 | | G | 0.1 | 466 | A | — |
| Ex. 6-20 | | | 1 | 507 | | 82 |
| Ex. 6-21 | | | 5 | 435 | | — |
| Ex. 6-22 | | H | 0.1 | 465 | A | — |
| Ex. 6-23 | | | 1 | 507 | | 82 |
| Ex. 6-24 | | | 5 | 435 | | — |
| Ex. 6-25 | | I | 0.1 | 466 | A | — |
| Ex. 6-26 | | | 1 | 507 | | 82 |
| Ex. 6-27 | | | 5 | 436 | | — |
| Ex. 6-28 | | J | 0.1 | 474 | A+ | — |
| Ex. 6-29 | | | 1 | 514 | | 82 |
| Ex. 6-30 | | | 5 | 443 | | — |
| Ex. 6-31 | | K | 0.1 | 461 | A− | — |
| Ex. 6-32 | | | 1 | 500 | | 82 |
| Ex. 6-33 | | | 5 | 428 | | — |
| Ex. 6-34 | | L | 0.1 | 466 | A | — |
| Ex. 6-35 | | | 1 | 506 | | 82 |
| Ex. 6-36 | | | 5 | 436 | | — |
| Ex. 6-37 | | M | 0.1 | 475 | A+ | — |
| Ex. 6-38 | | | 1 | 515 | | 82 |
| Ex. 6-39 | | | 5 | 443 | | — |
| Ex. 6-40 | | N | 0.1 | 465 | A | — |
| Ex. 6-41 | | | 1 | 507 | | 82 |
| Ex. 6-42 | | | 5 | 436 | | — |
| Ex. 6-43 | | O | 0.1 | 475 | A+ | — |
| Ex. 6-44 | | | 1 | 515 | | 82 |
| Ex. 6-45 | | | 5 | 444 | | — |
| Ex. 6-46 | | P | 0.1 | 474 | A+ | — |
| Ex. 6-47 | | | 1 | 515 | | 82 |
| Ex. 6-48 | | | 5 | 443 | | — |
| Ex. 6-49 | | Q | 0.1 | 475 | A+ | — |
| Ex. 6-50 | | | 1 | 514 | | 82 |
| Ex. 6-51 | | | 5 | 443 | | — |
| Ex. 6-52 | | R | 0.1 | 489 | A++ | — |
| Ex. 6-53 | | | 1 | 528 | | 83 |
| Ex. 6-54 | | | 5 | 463 | | — |
| Ex. 6-55 | | S | 0.01 | 437 | A+++ + | — |
| Ex. 6-56 | | | 0.1 | 503 | | — |
| Ex. 6-57 | | | 0.5 | 536 | | — |
| Ex. 6-58 | | | 1 | 544 | | 83 |
| Ex. 6-59 | | | 5 | 480 | | — |
| Ex. 6-60 | | | 10 | 437 | | — |
| Ex. 6-61 | | | 20 | 401 | | — |
| Ex. 6-62 | | | 30 | 373 | | — |
| Ex. 6-63 | | T | 0.1 | 497 | A++ + | — |
| Ex. 6-64 | | | 1 | 536 | | 83 |
| Ex. 6-65 | | | 5 | 470 | | — |
| Ex. 6-66 | | U | 0.1 | 490 | A++ | — |
| Ex. 6-67 | | | 1 | 529 | | 82 |
| Ex. 6-68 | | | 5 | 463 | | — |
| Comp. Ex. 6-1 | Li₄Ti₅O₁₂ | — | — | 343 | — | 80 |
| Comp. Ex. 6-2 | | V | 1 | 369 | | 65 |

The followings were confirmed according to Table 6. In Example 6-1 to 6-68, in the case where Li₄Ti₅O₁₂ was used as the anode active material, with an addition of 1,3-dioxane derivative such as Compounds A to U in the electrolyte solution, the safety valve operation time was longer than that of the case without additions of such compounds in the electrolyte solution. Therefore, it was confirmed in Examples 6-1 to 6-68 that in the case where Li₄Ti₅O₁₂ was used as the anode active material, by adding 1,3-dioxane derivative such as Compounds A to U in the electrolyte solution, the gas generation could be inhibited. Further, since the gas generation could be inhibited, it can also be confirmed that the deterioration of battery characteristics such as cycle characteristics, due to the occurrence of gas generation, was able to be inhibited.

In addition, in such compounds represented by formula (1), one having a substituent group containing nitrogen or oxygen at the position 2 tended to show better effects. Also, in such compounds represented by formula (2) having a spiro structure, one having a substituent group containing nitrogen or oxygen at at least one of the positions 3 and 9 tended to show better effects, and one having substituent group containing nitrogen or oxygen at both the positions 3 and 9 tended to show particularly good effects. One which had a substituent group containing nitrogen tended to show better effects than one which had a substituent group containing oxygen.

Further, in Examples 6-1 to 6-68, even when the 1,3-dioxane derivative such as Compounds A to U was added to the electrolyte solution, its low-temperature cycle characteristics was not likely to be negatively influenced by this. On the other hand, in the case where the additive compound was such as Compound V, in which all the substituent groups at the positions 1, 3, 5, 7, 9 and 11 of spiro ring in formula (2) were only hydrogen groups and hydrocarbon groups, the low-temperature cycle characteristics was lowered.

### Examples 7-1 to 7-68, Comparative Examples 7-1 and 7-2

On the cathode and the anode prepared in a similar way to Example 1-1, a gelatinous electrolyte layer was formed. In order to obtain the gelatinous electrolyte layer, first, polyvinylidene fluoride copolymerized with hexafluoropropylene in an amount of 6.9%, an electrolyte solution and dimethyl carbonate were mixed with one another, stirred, and dissolved. Therefore, a sol electrolyte solution was obtained.

The electrolyte solution was prepared in the following manner. This was prepared by dissolving LiPF₆ as the electrolytic salt at a concentration of 0.6 mol/L in the solvent to the mixed solvent of ethylene carbonate (EC) and propylene carbonate (PC) mixed in a proportion of (EC:PC)=1:1 by mass ratio, and adding compound A as an additive, in amount of 0.1% by mass of the total mass of the electrolyte solution.

Next, the obtained sol electrolyte solution was uniformly coated on both surfaces of the cathode and the anode. After this, the solvent was removed by drying. In such a way, the gelatinous electrolyte layer was formed on both surfaces of the cathode and the anode. Next, the strip-like cathode provided with the gelatinous electrolyte layer on both surfaces thereof; and the strip-like anode provided with the gelatinous electrolyte layer on both surfaces thereof; were laminated to be formed into a laminated body. Then, this laminated body was spirally wound in a longitudinal direction, and thereby a spirally wound electrode body was obtained. Finally, this spirally wound electrode body was interposed between exterior films which is made of aluminum foil sandwiched by a pair of pieces of resin films, then the outer edges of the exterior films were sealed with each other by fusion in the vacuum condition, thereby encasing the spirally wound electrode body between the exterior films. In addition, at this time, each portion of a cathode terminal and an anode terminal, where a piece of resin was provided respectively, was inserted between the sealing portions of the exterior films. Thus, the gelatinous electrolyte battery of Example 7-1 was obtained.

### Example 7-2

A gelatinous electrolyte battery was fabricated in a similar way to Example 7-1, except that an adding amount of compound A was 1% by mass of the total mass of the electrolyte solution, in the preparation of the electrolyte solution.

### Example 7-3

A gelatinous electrolyte battery was fabricated in a similar way to Example 7-1, except that an adding amount of compound A was 5% by mass of the total mass of the electrolyte solution, in the preparation of the electrolyte solution.

### Examples 7-4 to 7-6

A gelatinous electrolyte battery was fabricated in a similar way to each of Examples 7-1 to 7-3 respectively, except the addition of compound B in place of the addition of compound A, in the preparation of the electrolyte solution.

### Examples 7-7 to 7-9

A gelatinous electrolyte battery was fabricated in a similar way to each of Examples 7-1 to 7-3 respectively, except the addition of compound C in place of the addition of compound A, in the preparation of the electrolyte solution.

### Examples 7-10 to 7-12

A gelatinous electrolyte battery was fabricated in a similar way to each of Examples 7-1 to 7-3 respectively, except the addition of compound D in place of the addition of compound A, in the preparation of the electrolyte solution.

### Examples 7-13 to 7-15

A gelatinous electrolyte battery was fabricated in a similar way to each of Examples 7-1 to 7-3 respectively, except the addition of compound E in place of the addition of compound A, in the preparation of the electrolyte solution.

### Examples 7-16 to 7-18

A gelatinous electrolyte battery was fabricated in a similar way to each of Examples 7-1 to 7-3 respectively, except the addition of compound F in place of the addition of compound A, in the preparation of the electrolyte solution.

### Examples 7-19 to 7-21

A gelatinous electrolyte battery was fabricated in a similar way to each of Examples 7-1 to 7-3 respectively, except the addition of compound G in place of the addition of compound A, in the preparation of the electrolyte solution.

### Examples 7-22 to 7-24

A gelatinous electrolyte battery was fabricated in a similar way to each of Examples 7-1 to 7-3 respectively, except the addition of compound H in place of the addition of compound A, in the preparation of the electrolyte solution.

### Examples 7-25 to 7-27

A gelatinous electrolyte battery was fabricated in a similar way to each of Examples 7-1 to 7-3 respectively, except the addition of compound I in place of the addition of compound A, in the preparation of the electrolyte solution.

### Examples 7-28 to 7-30

A gelatinous electrolyte battery was fabricated in a similar way to each of Examples 7-1 to 7-3 respectively, except the addition of compound J in place of the addition of compound A, in the preparation of the electrolyte solution.

### Examples 7-31 to 7-33

A gelatinous electrolyte battery was fabricated in a similar way to each of Examples 7-1 to 7-3 respectively, except the addition of compound K in place of the addition of compound A, in the preparation of the electrolyte solution.

### Examples 7-34 to 7-36

A gelatinous electrolyte battery was fabricated in a similar way to each of Examples 7-1 to 7-3 respectively, except the addition of compound L in place of the addition of compound A, in the preparation of the electrolyte solution.

### Examples 7-37 to 7-39

A gelatinous electrolyte battery was fabricated in a similar way to each of Examples 7-1 to 7-3 respectively, except the addition of compound M in place of the addition of compound A, in the preparation of the electrolyte solution.

### Examples 7-40 to 7-42

A gelatinous electrolyte battery was fabricated in a similar way to each of Examples 7-1 to 7-3 respectively, except the addition of compound N in place of the addition of compound A, in the preparation of the electrolyte solution.

### Examples 7-43 to 7-45

A gelatinous electrolyte battery was fabricated in a similar way to each of Examples 7-1 to 7-3 respectively, except the addition of compound O in place of the addition of compound A, in the preparation of the electrolyte solution.

### Examples 7-46 to 7-48

A gelatinous electrolyte battery was fabricated in a similar way to each of Examples 7-1 to 7-3 respectively, except the addition of compound P in place of the addition of compound A, in the preparation of the electrolyte solution.

### Examples 7-49 to 7-51

A gelatinous electrolyte battery was fabricated in a similar way to each of Examples 7-1 to 7-3 respectively, except the addition of compound Q in place of the addition of compound A, in the preparation of the electrolyte solution.

### Examples 7-52 to 7-54

A gelatinous electrolyte battery was fabricated in a similar way to each of Examples 7-1 to 7-3 respectively, except the addition of compound R in place of the addition of compound A, in the preparation of the electrolyte solution.

### Examples 7-55 to 7-62

A gelatinous electrolyte battery of Example 7-55 was fabricated in a similar way to Example 7-1, except that compound S was added in amount of 0.01% by mass of the total mass of the electrolyte solution, in place of the addition of compound A, in the preparation of the electrolyte solution. A gelatinous electrolyte battery of each of Examples 7-56 to 7-62 was fabricated in a similar way to Example 7-55, except that adding amount of compound S was 0.1%, 0.5%, 1%, 5%, 10%, 20% and 30% by mass respectively, of the total mass of the electrolyte solution, in the preparation of the electrolyte solution.

### Examples 7-63 to 7-65

A gelatinous electrolyte battery was fabricated in a similar way to each of Examples 7-1 to 7-3 respectively, except the addition of compound T in place of the addition of compound A, in the preparation of the electrolyte solution.

### Examples 7-66 to 7-68

A gelatinous electrolyte battery was fabricated in a similar way to each of Examples 7-1 to 7-3 respectively, except the addition of compound U in place of the addition of compound A, in the preparation of the electrolyte solution.

### Comparative Example 7-1

A gelatinous electrolyte battery was fabricated in a similar way to Example 7-1, except that compound A was not added in the preparation of the electrolyte solution.

### Comparative Example 7-2

A gelatinous electrolyte battery was fabricated in a similar way to Example 7-2, except the addition of compound V in place of the addition of compound A, in the preparation of the electrolyte solution.

(Evaluation)

For the gelatinous electrolyte batteries fabricated, the following “measurement of swell” and “measurement of low-temperature cycle characteristics” were performed.

(Measurement of Swell)

In the measurement of swell, first, the gelatinous electrolyte battery was charged-and-discharged two cycles in an atmosphere of 23° C.; then charged at a constant current density of 1 mA/cm² in the same atmosphere until the battery voltage reaches a predetermined voltage; and then charged at a constant voltage of the predetermined voltage until the current density reaches 0.02 mA/cm². After this, the cell thickness was measured. The charged battery was stored at 70° C. for 200 hours, and the cell thickness thereof was measured. With this, the amount of swell (%) was determined by 100×(thickness after storage)/(thickness before storage).

The predetermined charging voltages were the following:

Secondary batteries of Examples 7-1 to 7-68 and Comparative Examples 7-1 and 7-2: 4.3V

(Measurement of Low-Temperature Cycle Characteristics)

The low-temperature cycle characteristics were measured in the following manner. First, the secondary battery fabricated was charged-and-discharged in an atmosphere of 23° C. for the first cycle; then charged-and-discharged for the second cycle at 0° C. to be confirmed the discharge capacity. Then at −5° C., the charge-and-discharge for the third to fiftieth cycle was conducted, and the discharging capacity retention rate (%) at the fiftieth cycle, in relation to the discharging capacity in the second cycle defined as 100 for reference, was measured. As the charging and discharging conditions for one cycle, the battery was charged by a constant current density of 5 mA/cm² until the battery voltage reaches a predetermined charging-voltage, then discharged at a constant voltage of the predetermined charging-voltage and a constant current density of 0.02 mA/cm² until the battery voltage reaches a predetermined voltage.

The predetermined charging-voltages were the following:

Secondary batteries of Examples 7-1 to 7-68 and Comparative Examples 7-1 and 7-2: 4.3V

The result of measurement is shown in Table 1. In Table 1, on the field of evaluation, the effectiveness rank of Compounds A to U according to the result of measurement of swell is indicated (where the rank order is A⁺⁺⁺⁺, A⁺⁺⁺, A⁺⁺, A⁺, A, A⁻, B⁺, B, and C).

TABLE 7

| | | Additive | Content | | | Low-temperature cycle |
|---|---|---|---|---|---|---|
| | Cathode | Compound | (Mass %) | Swell (%) | Evaluation | characteristics (%) |
| Ex. 7-1 | LiCoO₂ | A | 0.1 | 129 | C | — |
| Ex. 7-2 | | | 1 | 126 | | 38 |
| Ex. 7-3 | | | 5 | 138 | | — |
| Ex. 7-4 | | B | 0.1 | 127 | B | — |
| Ex. 7-5 | | | 1 | 124 | | 40 |
| Ex. 7-6 | | | 5 | 136 | | — |
| Ex. 7-7 | | C | 0.1 | 129 | C | — |
| Ex. 7-8 | | | 1 | 126 | | 39 |
| Ex. 7-9 | | | 5 | 137 | | — |
| Ex. 7-10 | | D | 0.1 | 127 | B | — |
| Ex. 7-11 | | | 1 | 124 | | 40 |
| Ex. 7-12 | | | 5 | 136 | | — |
| Ex. 7-13 | | E | 0.1 | 127 | B | — |
| Ex. 7-14 | | | 1 | 125 | | 39 |
| Ex. 7-15 | | | 5 | 136 | | — |
| Ex. 7-16 | | F | 0.1 | 125 | B+ | — |
| Ex. 7-17 | | | 1 | 122 | | 40 |
| Ex. 7-18 | | | 5 | 134 | | — |
| Ex. 7-19 | | G | 0.1 | 121 | A | — |
| Ex. 7-20 | | | 1 | 118 | | 40 |
| Ex. 7-21 | | | 5 | 130 | | — |
| Ex. 7-22 | | H | 0.1 | 121 | A | — |
| Ex. 7-23 | | | 1 | 117 | | 41 |
| Ex. 7-24 | | | 5 | 130 | | — |
| Ex. 7-25 | | I | 0.1 | 121 | A | — |
| Ex. 7-26 | | | 1 | 117 | | 41 |
| Ex. 7-27 | | | 5 | 130 | | — |
| Ex. 7-28 | | J | 0.1 | 119 | A+ | — |
| Ex. 7-29 | | | 1 | 115 | | 42 |
| Ex. 7-30 | | | 5 | 128 | | — |
| Ex. 7-31 | | K | 0.1 | 123 | A− | — |
| Ex. 7-32 | | | 1 | 120 | | 40 |
| Ex. 7-33 | | | 5 | 132 | | — |
| Ex. 7-34 | | L | 0.1 | 121 | A | — |
| Ex. 7-35 | | | 1 | 118 | | 41 |
| Ex. 7-36 | | | 5 | 130 | | — |
| Ex. 7-37 | | M | 0.1 | 119 | A+ | — |
| Ex. 7-38 | | | 1 | 114 | | 41 |
| Ex. 7-39 | | | 5 | 128 | | — |
| Ex. 7-40 | | N | 0.1 | 121 | A | — |
| Ex. 7-41 | | | 1 | 117 | | 41 |
| Ex. 7-42 | | | 5 | 130 | | — |
| Ex. 7-43 | | O | 0.1 | 118 | A+ | — |
| Ex. 7-44 | | | 1 | 115 | | 42 |
| Ex. 7-45 | | | 5 | 128 | | — |
| Ex. 7-46 | | P | 0.1 | 117 | A+ | — |
| Ex. 7-47 | | | 1 | 114 | | 41 |
| Ex. 7-48 | | | 5 | 128 | | — |
| Ex. 7-49 | | Q | 0.1 | 118 | A+ | — |
| Ex. 7-50 | | | 1 | 114 | | 42 |
| Ex. 7-51 | | | 5 | 128 | | — |
| Ex. 7-52 | | R | 0.1 | 115 | A++ | — |
| Ex. 7-53 | | | 1 | 110 | | 42 |
| Ex. 7-54 | | | 5 | 125 | | — |
| Ex. 7-55 | | S | 0.01 | 119 | A++++ | — |
| Ex. 7-56 | | | 0.1 | 110 | | — |
| Ex. 7-57 | | | 0.5 | 106 | | — |
| Ex. 7-58 | | | 1 | 105 | | 43 |
| Ex. 7-59 | | | 5 | 118 | | — |
| Ex. 7-60 | | | 10 | 120 | | — |
| Ex. 7-61 | | | 20 | 130 | | — |
| Ex. 7-62 | | | 30 | 139 | | — |
| Ex. 7-63 | | T | 0.1 | 113 | A+++ | — |
| Ex. 7-64 | | | 1 | 107 | | 43 |
| Ex. 7-65 | | | 5 | 122 | | — |
| Ex. 7-66 | | U | 0.1 | 115 | A++ | — |
| Ex. 7-67 | | | 1 | 109 | | 42 |
| Ex. 7-68 | | | 5 | 124 | | — |
| Comp. Ex. 7-1 | LiCoO₂ | — | — | 158 | — | 38 |
| Comp. Ex. 7-2 | | V | 1 | 142 | | 6 |

The followings were confirmed according to Table 7. In Examples 7-1 to 7-68, for batteries in which aluminum laminated film was used as an exterior, with an addition of 1,3-dioxane derivative such as Compounds A to U in the electrolyte solution, the amount of swell was smaller than that of the case without additions of such compounds in the electrolyte solution. Therefore, it was confirmed in Examples 7-1 to 7-68 that by adding 1,3-dioxane derivative such as Compounds A to U in the electrolyte solution of the batteries in which aluminum laminated film was used as an exterior, the gas generation could be inhibited, and thereby the battery swell could be inhibited.

In addition, in such compounds represented by formula (1), one having a substituent group containing nitrogen or oxygen at the position 2 tended to show better effects. Also, in such compounds represented by formula (2) having a spiro structure, one having a substituent group containing nitrogen or oxygen at at least one of the positions 3 and 9 tended to show better effects, and one having substituent group containing nitrogen or oxygen at both the positions 3 and 9 tended to show particularly good effects. One which had a substituent group containing nitrogen tended to show better effects than one which had a substituent group containing oxygen.

Further, in Examples 7-1 to 7-68, even when the 1,3-dioxane derivative such as Compounds A to U was added to the electrolyte solution, its low-temperature cycle characteristics was not likely to be negatively influenced by this. On the other hand, in the case where the additive compound was such as Compound V, in which all the substituent groups at the positions 1, 3, 5, 7, 9 and 11 of spiro ring in formula (2) were only hydrogen groups and hydrocarbon groups, the low-temperature cycle characteristics was lowered.

### 8. Other Embodiments

The present application is not limited to the above-described embodiments, but various modifications and alternatives of the embodiments may be made within the scope not departing from the gist of the present application. For example, in the above-described embodiments and examples, numerical values, structures, shapes, materials, raw materials, manufacturing methods and the like are illustrative only, and numerical values, structures, shapes, materials, raw materials, manufacturing methods and the like, which are different from that described above, may be used as appropriate.

In a secondary battery according to an embodiment of the present application, the electrochemical equivalent of an anode material capable of intercalating and deintercalating lithium may be larger than the electrochemical equivalent of a cathode, such that unintentional deposition of lithium metal on the anode during charging can be prevented.

Further, in a secondary battery according to an embodiment of the present application, although the amount of open-circuit voltage on a full charge per pair of the cathode and the anode (that is, the battery voltage) may be 4.20V or less, in some design such voltage may be more than 4.20V, and desirably within a range of 4.25V or more and 4.50V or less. By setting the battery voltage to higher than 4.20V, the deintercalation amount of lithium per units of mass will be greater than that of a battery whose open-circuit voltage on a full charge is 4.20V, even with the same cathode active material, and depending on this, the amount of the cathode active material and the anode active material is regulated. Thus, it is made possible to obtain high energy density.

In the fourth embodiment, any of the first to third manufacturing methods in the second embodiment may also be applied in forming electrolyte 66. Further, the electrolyte 66 may be omitted, and an electrolyte solution as an electrolyte in the form of a liquid may be used instead. The non-aqueous electrolyte battery according to any of the second to fourth embodiments may have a configuration in which the cathode lead 53 and the anode lead 54 are both led out from the same side. In the fourth embodiment, laminated electrode body (battery device) 60 was configured in such a way that the outermost layer of the laminated electrode body 60 be the separator 63, it may be configured in other way such that the outermost layer is the cathode 61 or the anode 62. Further, the laminated electrode body (battery device) 60 may be configured in such a way that the outermost layer on one side is separator 63 while the outermost layer on the other side is the cathode 61 or the anode 62.

The present application may have the following configurations.

[1] A non-aqueous electrolyte battery, including:

a cathode;

an anode; and

a non-aqueous electrolyte having a non-aqueous electrolyte solution which includes at least one kind of 1,3-dioxane derivative represented by at least one of the following formulae (1) and (2);

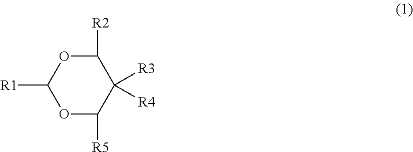

where each of R1 to R5 independently represents a hydrogen group, a hydrocarbon group optionally having a substituent (excluding substituents containing nitrogen or oxygen), or a substituent group containing nitrogen or oxygen, provided that two or more groups selected from R1 to R5 may be bonded together and at least one of R1 to R5 represents a substituent group containing nitrogen or oxygen, and

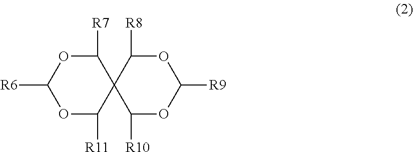

where each of R6 to R11 independently represents a hydrogen group, a hydrocarbon group optionally having a substituent (excluding substituents containing nitrogen or oxygen), or a substituent group containing nitrogen or oxygen, and at least one of R6 to R11 represents a substituent group containing nitrogen or oxygen.
[2] The non-aqueous electrolyte battery according to [1], in which the R1 as defined in the formula (1) represents the substituent group containing nitrogen or oxygen.
[3] The non-aqueous electrolyte battery according to [1] or [2], in which at least one of the R6 and R9 as defined in the formula (2) represents the substituent group containing nitrogen or oxygen.
[4] The non-aqueous electrolyte battery according to [1], in which the 1,3-dioxane derivative include at least one kind of 1,3-dioxane derivative represented by the following formula (2-1);

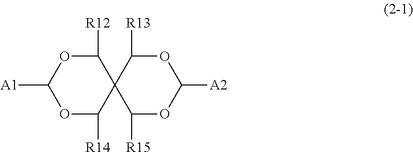

where each of A1 and A2 independently represents a substituent group containing nitrogen or oxygen, and each of R12 to R15 independently represents a hydrogen group, a hydrocarbon group which may have a substituent (excluding substituents containing nitrogen or oxygen), or a substituent group containing nitrogen or oxygen.
[5] The non-aqueous electrolyte battery according to any one of [1] to [4], in which the substituent group containing nitrogen is selected from the group consisting of: an amino group, an amide group, an imide group, a cyano group, an isonitrile group, an isoimide group, an isocyanate group, an imino group, a nitro group, a nitroso group, a pyridine group, a triazine group, a guanidine group, and an azo group, or a substituent group having at least one of these groups.
[6] The non-aqueous electrolyte battery according to any one of [1] to [5], in which

the substituent group containing oxygen is selected from the group consisting of: a hydroxyl group, an ether group, an ester group, an aldehyde group, a peroxy group, and a carbonate group, or a substituent group having at least one of these groups.

[7] The non-aqueous electrolyte battery according to any one of [1] to [6], in which the content of the 1,3-dioxane derivative represented by at least one of the formulae (1) and (2) is 0.01% by mass or more and 10% by mass or less of the total mass of the non-aqueous electrolyte solution.
[8] The non-aqueous electrolyte battery according to any one of [1] to [7], in which

the non-aqueous electrolyte solution further includes at least one kind of compounds represented by at least one of the following formulae (3) to (6);

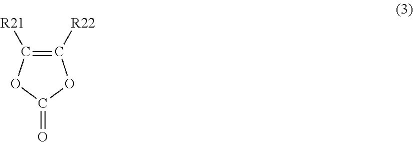

where each of R21 and R22 independently represents a hydrogen group or an alkyl group,

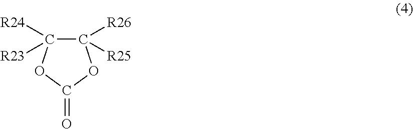

where each of R23 to R26 independently represents a hydrogen group, a halogen group, an alkyl group or a halogenated alkyl group, and at least one of R23 to R26 represents a halogen group or a halogenated alkyl group,

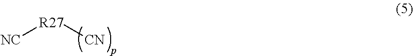

where R27 represents an alkylene group of 1 to 18 carbon atoms optionally having a substituent, an alkenylene group of 2 to 18 carbon atoms optionally having a substituent, an alkynylene group of 2 to 18 carbon atoms optionally having a substituent, or a bridged-ring optionally having a substituent, and where p represents an integer from 0 to an upper limit as determined depending on R27, and

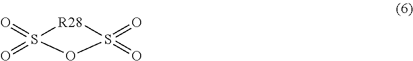

where R28 represents CₘH₂ₘ₋ₙXₙ provided that X is a halogen atom), m represents an integer from 2 to 4, and n represents an integer from 0 to 2m.
[9] The non-aqueous electrolyte battery according to any one of [1] to [8], in which

the non-aqueous electrolyte further includes a polymer compound capable of holding the non-aqueous electrolyte solution.

[10] The non-aqueous electrolyte battery according to any one of [1] to [9], further including:

an exterior member being film-shaped, configured to encase an electrode body including the cathode and the anode.

[11] The non-aqueous electrolyte battery according to any one of [1] to [10], in which

the amount of open-circuit voltage on a full charge per pair of the cathode and the anode is 4.25V or more and 4.50V or less.

[12] A non-aqueous electrolyte including:

a non-aqueous electrolyte solution which includes at least one kind of 1,3-dioxane derivative represented by at least one of the following formulae (1) and (2);

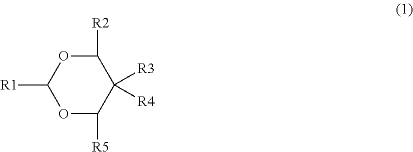

where each of R1 to R5 independently represents a hydrogen group, a hydrocarbon group optionally having a substituent (excluding substituents containing nitrogen or oxygen), or a substituent group containing nitrogen or oxygen, provided that two or more groups selected from R1 to R5 may be bonded together and at least one of R1 to R5 represents a substituent group containing nitrogen or oxygen, and

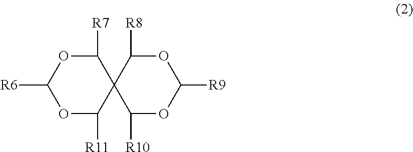

where each of R6 to R11 independently represents a hydrogen group, a hydrocarbon group optionally having a substituent (excluding substituents containing nitrogen or oxygen), or a substituent group containing nitrogen or oxygen, and at least one of R6 to R11 represents a substituent group containing nitrogen or oxygen.
[13] A battery pack including:

the non-aqueous electrolyte battery according to any one of [1] to [11];

a control unit configured to control the non-aqueous electrolyte battery; and

an exterior configured to contain the non-aqueous electrolyte battery.

[14] An electric vehicle including:

the non-aqueous electrolyte battery according to any one of [1] to [11];

a converter configured to receive electricity supply from the non-aqueous electrolyte battery and convert the electricity into driving force for vehicle; and

a controller configured to process information on vehicle control on the basis of information on the non-aqueous electrolyte battery.

[15] An electronical apparatus including:

the non-aqueous electrolyte battery according to any one of [1] to [11],

the electronic apparatus being configured to receive electricity supply from the non-aqueous electrolyte battery.

[16] An electrical storage apparatus including:

the non-aqueous electrolyte battery according to any one of [1] to [11],

the electrical storage apparatus being configured to provide electricity to an electronic apparatus connected to the non-aqueous electrolyte battery.

[17] The electrical storage apparatus according to [16], further including:

an electricity information controlling device configured to transmit and receive signals via a network to and from other apparatuses,

the electrical storage apparatus being configured to control charge and discharge of the non-aqueous electrolyte battery on the basis of information that the electricity information controlling device receives.

[18] An electricity system, configured to

receive electricity supply from the non-aqueous electrolyte battery according to any one of [1] to [11]; or

provide electricity from at least one of a power generating device and a power network to the non-aqueous electrolyte battery.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A non-aqueous electrolyte battery, comprising:
a cathode;
an anode; and
a non-aqueous electrolyte having a non-aqueous electrolyte solution which includes at least one kind of 1,3-dioxane derivative represented by at least one of the following formulae (1) and (2); 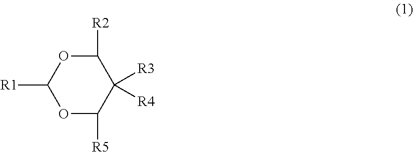
where each of R1 to R5 independently represents a hydrogen group, a hydrocarbon group optionally having a substituent (excluding substituents containing nitrogen or oxygen), or a substituent group containing nitrogen or oxygen, provided that two or more groups selected from R1 to R5 may be bonded together and at least one of R1 to R5 represents a substituent group containing nitrogen or oxygen, and 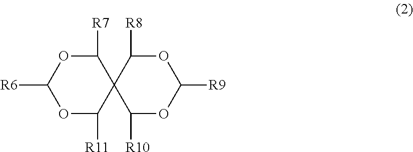
where each of R6 to R11 independently represents a hydrogen group, a hydrocarbon group optionally having a substituent (excluding substituents containing nitrogen or oxygen), or a substituent group containing nitrogen or oxygen, and at least one of R6 to R11 represents a substituent group containing nitrogen or oxygen.

2. The non-aqueous electrolyte battery according to claim 1, wherein
the R1 as defined in the formula (1) represents the substituent group containing nitrogen or oxygen.

3. The non-aqueous electrolyte battery according to claim 1, wherein
at least one of the R6 and R9 as defined in the formula (2) represents the substituent group containing nitrogen or oxygen.

4. The non-aqueous electrolyte battery according to claim 1, wherein
the 1,3-dioxane derivative include at least one kind of 1,3-dioxane derivative represented by the following formula (2-1); 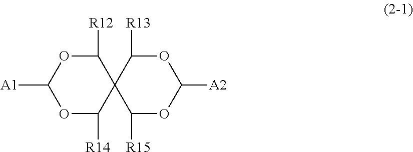
where each of A1 and A2 independently represents a substituent group containing nitrogen or oxygen, and each of R12 to R15 independently represents a hydrogen group, a hydrocarbon group which may have a substituent (excluding substituents containing nitrogen or oxygen), or a substituent group containing nitrogen or oxygen.

5. The non-aqueous electrolyte battery according to claim 1, wherein
the substituent group containing nitrogen is selected from the group consisting of: an amino group, an amide group, an imide group, a cyano group, an isonitrile group, an isoimide group, an isocyanate group, an imino group, a nitro group, a nitroso group, a pyridine group, a triazine group, a guanidine group, and an azo group, or a substituent group having at least one of these groups.

6. The non-aqueous electrolyte battery according to claim 1, wherein
the substituent group containing oxygen is selected from the group consisting of: a hydroxyl group, an ether group, an ester group, an aldehyde group, a peroxy group, and a carbonate group, or a substituent group having at least one of these groups.

7. The non-aqueous electrolyte battery according to claim 1, wherein
the content of the 1,3-dioxane derivative represented by at least one of the formulae (1) and (2) is 0.01% by mass or more and 10% by mass or less of the total mass of the non-aqueous electrolyte solution.

8. The non-aqueous electrolyte battery according to claim 1, wherein
the non-aqueous electrolyte solution further includes at least one kind of compounds represented by at least one of the following formulae (3) to (6); 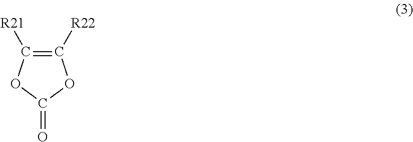
where each of R21 and R22 independently represents a hydrogen group or an alkyl group, 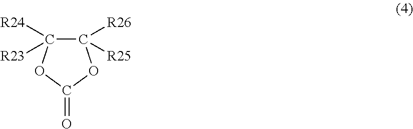
where each of R23 to R26 independently represents a hydrogen group, a halogen group, an alkyl group or a halogenated alkyl group, and at least one of R23 to R26 represents a halogen group or a halogenated alkyl group, 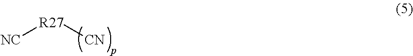
where R27 represents an alkylene group of 1 to 18 carbon atoms optionally having a substituent, an alkenylene group of 2 to 18 carbon atoms optionally having a substituent, an alkynylene group of 2 to 18 carbon atoms optionally having a substituent, or a bridged-ring optionally having a substituent, and where p represents an integer from 0 to an upper limit as determined depending on R27, and 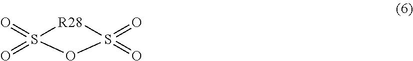
where R28 represents CₘH₂ₘ₋ₙXₙ (provided that X is a halogen atom), m represents an integer from 2 to 4, and n represents an integer from 0 to 2m.

9. The non-aqueous electrolyte battery according to claim 1, wherein
the non-aqueous electrolyte further includes a polymer compound capable of holding the non-aqueous electrolyte solution.

10. The non-aqueous electrolyte battery according to claim 1, further comprising:
an exterior member being film-shaped, configured to encase an electrode body including the cathode and the anode.

11. The non-aqueous electrolyte battery according to claim 1, wherein
the amount of open-circuit voltage on a full charge per pair of the cathode and the anode is 4.25V or more and 4.50V or less.

12. A non-aqueous electrolyte comprising:
a non-aqueous electrolyte solution which includes at least one kind of 1,3-dioxane derivative represented by at least one of the following formulae (1) and (2); 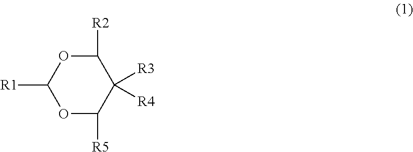
where each of R1 to R5 independently represents a hydrogen group, a hydrocarbon group optionally having a substituent (excluding substituents containing nitrogen or oxygen), or a substituent group containing nitrogen or oxygen, provided that two or more groups selected from R1 to R5 may be bonded together and at least one of R1 to R5 represents a substituent group containing nitrogen or oxygen, and 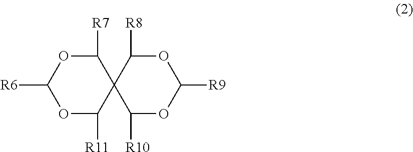
where each of R6 to R11 independently represents a hydrogen group, a hydrocarbon group optionally having a substituent (excluding substituents containing nitrogen or oxygen), or a substituent group containing nitrogen or oxygen, and at least one of R6 to R11 represents a substituent group containing nitrogen or oxygen.

13. A battery pack comprising:
the non-aqueous electrolyte battery according to claim 1;
a control unit configured to control the non-aqueous electrolyte battery; and
an exterior configured to contain the non-aqueous electrolyte battery.

14. An electronic apparatus comprising:
the non-aqueous electrolyte battery according to claim 1,
the electronic apparatus being configured to receive electricity supply from the non-aqueous electrolyte battery.

15. An electric vehicle comprising:
the non-aqueous electrolyte battery according to claim 1;
a converter configured to receive electricity supply from the non-aqueous electrolyte battery and convert the electricity into driving force for vehicle; and
a controller configured to process information on vehicle control on the basis of information on the non-aqueous electrolyte battery.

16. An electrical storage apparatus comprising:
the non-aqueous electrolyte battery according to claim 1,
the electrical storage apparatus being configured to provide electricity to an electronic apparatus connected to the non-aqueous electrolyte battery.

17. The electrical storage apparatus according to claim 16, further comprising:
an electricity information controlling device configured to transmit and receive signals via a network to and from other apparatuses,
the electrical storage apparatus being configured to control charge and discharge of the non-aqueous electrolyte battery on the basis of information that the electricity information controlling device receives.

18. An electricity system, configured to
receive electricity supply from the non-aqueous electrolyte battery according to claim 1; or
provide electricity from at least one of a power generating device and a power network to the non-aqueous electrolyte battery.
